(19) United States
(12) Patent Application Publication
(10) Pub. No.: US 2019/0259546 A1
(43) Pub. Date: Aug. 22, 2019

(54) METHODS FOR PREPARING CARBON MATERIALS

(71) Applicants: EnerG2 Technologies, Inc., Seattle, WA (US); BASF SE, Ludwigshafen (DE)

(72) Inventors: Benjamin Kron, Seattle, WA (US); Aaron Feaver, Seattle, WA (US); William O'Neill, Seattle, WA (US); Robert Herrick, Seattle, WA (US); Heather Widgren, Seattle, WA (US); Thomas Arandt, Dois Irmaos (BR)

(21) Appl. No.: 16/256,847

(22) Filed: Jan. 24, 2019

Related U.S. Application Data
(60) Provisional application No. 62/621,467, filed on Jan. 24, 2018.

(51) Int. Cl. H01G 11/42; C08G 8/22; C01B 32/318; C01B 32/336; H01G 11/38; H01G 11/26; H01G 11/86; H01G 11/34; H01M 4/587; H01M 12/08

(52) U.S. Cl. CPC H01G 11/42; H01M 2004/027; C01B 32/318; C01B 32/336; H01G 11/38; H01G 11/26; H01G 11/86; H01G 11/34; H01M 4/587; H01M 12/08; C01P 2006/40; C01P 2006/14; C01P 2006/12; C01P 2006/17; C01P 2006/80; C08G 8/22

(57) ABSTRACT

The present application is directed to compositions and methods of preparing carbon materials. The carbon materials prepared according to compositions and methods described herein comprise enhanced electrochemical properties and find utility in any number of electrical devices, for example, as electrode material in ultracapacitors.

### BACKGROUND

### Technical Field

The present invention generally relates to a composition and methods for preparing carbon materials, as well as methods for making devices containing the same. The carbon materials prepared according to compositions and methods described herein have enhanced electrochemical properties and find utility in any number of electrical devices.

### Description of the Related Art

Carbon materials are commonly employed in electrical storage and distribution devices. The high surface area, conductivity and porosity of activated carbon allows for the design of electrical devices having higher energy density than devices employing other materials. Electric double-layer capacitors (EDLCs or “ultracapacitors”) are an example of such devices. EDLCs often have electrodes prepared from an activated carbon material and a suitable electrolyte, and have an extremely high energy density compared to more common capacitors. Typical uses for EDLCs include energy storage and distribution in devices requiring short bursts of power for data transmissions, or peak-power functions such as wireless modems, mobile phones, digital cameras and other hand-held electronic devices. EDLCs are also commonly use in electric vehicles such as electric cars, trains, buses and the like.

Batteries are another common energy storage and distribution device which often contain an activated carbon material (e.g., as anode material, current collector, or conductivity enhancer). For example, lithium/carbon batteries having a carbonaceous anode intercalated with lithium represent a promising energy storage device. Other types of carbon-containing batteries include lithium air batteries, which use porous carbon as the current collector for the air electrode, and lead acid batteries which often include carbon additives in either the anode or cathode. Batteries are employed in any number of electronic devices requiring low current density electrical power (as compared to an EDLC's high current density).

One known limitation of EDLCs and carbon-based batteries is decreased performance at high-temperature, high voltage operation, repeated charge/discharge cycles and/or upon aging. This decreased performance has been attributed, at least in part, to electrolyte impurity or impurities in the carbon electrode itself, causing breakdown of the electrode at the electrolyte/electrode interface. Thus, it has been suggested that EDLCs and/or batteries comprising electrodes prepared from higher purity carbon materials could be operated at higher voltages and for longer periods of time at higher temperatures than existing devices.

Although the need for improved high purity carbon materials comprising a pore structure optimized for high pulse power electrochemical applications has been recognized, such carbon materials are not commercially available and no reported preparation method is capable of yielding the same. One common method for producing high surface area activated carbon materials is to pyrolyze an existing carbon-containing material (e.g., coconut fibers or tire rubber). This results in a char with relatively low surface area which can subsequently be over-activated to produce a material with the surface area and porosity necessary for the desired application. Such an approach is inherently limited by the existing structure of the precursor material, and typically results in a carbon material having an un-optimized pore structure and an ash content (e.g., metal impurities) of 1% or higher.

Activated carbon materials can also be prepared by chemical activation. For example, treatment of a carbon-containing material with an acid, base or salt (e.g., phosphoric acid, potassium hydroxide, sodium hydroxide, zinc chloride, etc.) followed by heating results in an activated carbon material. However, such chemical activation also produces an activated carbon material not suitable for use in high performance electrical devices.

Another approach for producing high surface area activated carbon materials is to prepare a synthetic polymer from carbon-containing organic building blocks (e.g., a polymer gel). As with the existing organic materials, the synthetically prepared polymers are dried (e.g., by evaporation or freeze drying) pyrolyzed and activated to produce an activated carbon material (e.g., an aerogel or xerogel). In contrast to the traditional approach described above, the intrinsic porosity of the synthetically prepared polymer results in higher process yields because less material is lost during the activation step. However, known methods for preparing carbon materials from synthetic polymers produce carbon materials having un-optimized pore structures and unsuitable levels of impurities. Accordingly, electrodes prepared from these materials demonstrate unsuitable electrochemical properties.

Generally, polymer compositions and methods for producing carbon-containing synthetic polymers include an initial reaction to form a polymer, a drying step to remove residual liquid reaction components, followed by a curing or carbonization step prior to pyrolysis. Methods known in the art include freeze drying, supercritical drying and evaporation. Each method of drying suffers drawbacks in terms of added cost, time and/or effort imparted onto the overall manufacturing process.

While significant advances have been made in the field, there continues to be a need in the art for an improved method for producing high purity carbon materials for use in electrical energy storage devices. The present invention fulfills these needs and provides further related advantages.

### BRIEF SUMMARY

In general terms, the current invention is directed to novel compounds and methods of preparing carbon materials comprising an optimized pore structure. The optimized pore structure comprises a mesopore volume, pore volume distribution and surface area which increases the power density and provides for high ion mobility in electrodes comprising the carbon materials prepared using the disclosed methods. In addition, electrodes including carbon materials prepared according to the present method comprise low ionic resistance and high frequency response. The electrodes thus comprise a higher power density and increased volumetric capacitance compared to certain electrodes with other carbon materials prepared using previously known methods. The high purity of the carbon materials prepared according to the present method also contributes to improving the operation, life span and performance of any number of electrical storage and/or distribution devices while minimizing manufacturing costs in terms of materials, time and/or effort.

Accordingly, the carbon materials prepared according to the present method find utility in any number of electrical energy storage devices, for example as electrode material in ultracapacitors. Such devices containing the carbon materials prepared according to the present method are useful in any number of applications, including applications requiring high pulse power. Because of the unique properties of the carbon materials prepared according to the present method, the devices are also expected to have higher durability, and thus an increased life span. All of these advantages of are realized while reducing the overall cost of manufacture.

Accordingly, one embodiment of the present disclosure is directed to a method comprising:

a) combining a solvent, a catalyst, a first monomer and a second monomer to yield a reaction mixture;

b) holding the reaction mixture at a holding temperature sufficient to co-polymerize the first and second monomer to yield a resin mixture;

c) heating the resin mixture at a curing temperature, thereby forming a polymer composition comprising the solvent and a polymer formed from co-polymerizing the first and second monomer, wherein the solvent concentration in the polymer composition is at least 5 wt %, based on total weight of the polymer composition; and

d) pyrolyzing the polymer composition at a pyrolysis temperature thereby substantially removing the solvent and pyrolyzing the polymer to yield a carbon material.

Another embodiment provides a method comprising:

a) combining a solvent, a catalyst, a first monomer and a second monomer to yield a reaction mixture;

b) increasing the temperature of the reaction mixture at a holding ramp rate and holding the reaction mixture at a holding temperature sufficient to co-polymerize the first and second monomer to yield a polymer composition; and

c) optionally heating the polymer composition at a curing temperature, thereby forming a cured polymer composition comprising the solvent and a polymer formed from co-polymerizing the first and second monomer, wherein the solvent concentration in the cured polymer composition is at least 5 wt %, based on total weight of the cured polymer composition.

Another embodiment provides a method comprising:

a) combining a solvent, a catalyst, a first monomer and a second monomer to yield a reaction mixture, and maintaining the reaction mixture at a reaction temperature for a reaction time;

b) holding the reaction mixture at a holding temperature sufficient to co-polymerize the first and second monomer to yield a resin mixture;

c) heating the resin mixture up to a curing temperature, thereby forming a polymer composition comprising the solvent and a polymer formed from co-polymerizing the first and second monomer; and

d) pyrolyzing the polymer composition at a pyrolysis temperature, thereby substantially removing the solvent and pyrolyzing the polymer to yield a carbon material.

One embodiment provides a method comprising:

a) combining a solvent, a catalyst, a first monomer and a second monomer to yield a reaction mixture, and maintaining the reaction mixture at a reaction temperature for a reaction time;

b) increasing the temperature of the reaction mixture at a holding ramp rate and holding the reaction mixture at a holding temperature sufficient to co-polymerize the first and second monomer to yield a polymer composition; and

c) optionally heating the polymer composition up to a curing temperature, thereby forming a cured polymer composition comprising the solvent and a polymer formed from co-polymerizing the first and second monomer.

Still another embodiment provides a method comprising:

a) combining a solvent, a catalyst, a first monomer and a second monomer to yield a reaction mixture;

b) holding the reaction mixture for a holding time at a holding temperature sufficient to co-polymerize the first and second monomer to yield a resin mixture;

c) heating the resin mixture at a curing temperature, thereby forming a polymer composition comprising the solvent and a polymer formed from co-polymerizing the first and second monomer; and

d) pyrolyzing the polymer composition at a pyrolysis temperature thereby substantially removing the solvent and pyrolyzing the polymer to yield a carbon material.

Another embodiment provides a method comprising:

a) combining a solvent, a catalyst, a first monomer and a second monomer to yield a reaction mixture;

b) increasing the temperature of the reaction mixture at a holding ramp rate and holding the reaction mixture for a holding time at a holding temperature sufficient to co-polymerize the first and second monomer to yield a polymer composition;

c) optionally heating the polymer composition at a curing temperature, thereby forming a cured polymer composition comprising the solvent and a polymer formed from co-polymerizing the first and second monomer.

One other embodiment provides a method comprising:

a) combining a solvent, a catalyst, a first monomer and a second monomer to yield a reaction mixture;

b) holding the reaction mixture at a holding temperature sufficient to co-polymerize the first and second monomer to yield a resin mixture;

c) heating the resin mixture by increasing an initial temperature at a curing ramp rate of at least 0.5° C./hour up to a curing temperature, thereby forming a polymer composition comprising the solvent and a polymer formed from co-polymerizing the first and second monomer; and

d) pyrolyzing the polymer composition at a pyrolysis temperature thereby substantially removing the solvent and pyrolyzing the polymer to yield a carbon material.

Another embodiment provides a method comprising:

a) combining a solvent, a catalyst, a first monomer and a second monomer to yield a reaction mixture;

b) optionally holding the reaction mixture at a holding temperature sufficient to co-polymerize the first and second monomer to yield a polymer composition;

c) heating the polymer composition by increasing an initial temperature at a curing ramp rate of at least 0.5° C./hour up to a curing temperature, thereby forming a cured polymer composition comprising the solvent and a polymer formed from co-polymerizing the first and second monomer. one embodiment provides a method comprising:

a) combining a solvent, a catalyst, a first monomer and a second monomer to yield a reaction mixture;

b) transferring the reaction mixture to a reaction vessel having a volume greater than 10 L and a surface area to volume aspect ratio greater than about 3 m²/m³;

c) increasing the temperature of the reaction mixture at a holding ramp rate and holding the reaction mixture for a holding time at a holding temperature sufficient to co-polymerize the first and second monomer to yield a polymer composition; and

d) optionally heating the polymer composition at a curing temperature, thereby forming a cured polymer composition comprising the solvent and a polymer formed from co-polymerizing the first and second monomer.

Another embodiment provides a polymer composition or cured polymer composition comprising a solvent concentration greater than about 10 wt. % of the polymer composition, and a polymer having a relative pore integrity greater than 0.5.

These and other aspects of the invention will be apparent upon reference to the following detailed description.

### BRIEF DESCRIPTION OF THE DRAWINGS

In the figures, identical reference numbers identify similar elements. The sizes and relative positions of elements in the figures are not necessarily drawn to scale and some of these elements are enlarged and positioned to improve figure legibility. Further, the particular shapes of the elements as drawn are not intended to convey any information regarding the actual shape of the particular elements, and have been solely selected for ease of recognition in the figures.

FIG. 1 shows the pore volume for exemplary carbon materials for holding times ranging from 0 to 12 hours.

FIG. 2 depicts the pore volume distribution for exemplary carbon materials for holding times ranging from 0 to 12 hours.

FIG. 3 is a graphical representation of pore volume plotted against holding times of 0, 1.7, 3 and 5 days for exemplary carbon materials.

FIG. 4 illustrates the pore volume distribution for exemplary carbon materials prepared with holding times ranging from 0 to 5 days.

FIG. 5 shows pore volume for carbon material samples prepared using curing ramp rates of 1, 3, 10 and 110° C./hour.

FIG. 6 depicts the pore volume distribution of carbon material samples prepared using curing ramp rates ranging from 1-110° C./hour.

FIG. 7 illustrates the pore volume distribution of an exemplary carbon material processed both with freeze drying (Sample 5A) and without freeze drying (Sample 5B) prior to pyrolysis.

FIG. 8 shows the pore volume distribution of an exemplary carbon material processed both with freeze drying (Sample 8A) and without freeze drying (Sample 8B) prior to pyrolysis.

FIG. 9 shows a distribution of relative pore integrity values for carbon materials plotted relative to the maximum holding temperature.

FIG. 10 shows the mesoporous carbon pore size distribution for the material prepared according to Example 11.

FIG. 11 shows the mesoporous carbon pore size distribution for the material prepared according to Example 12 (unactivated).

FIG. 12 shows the mesoporous carbon pore size distribution for the material prepared according to Example 12 (activated).

FIG. 13 shows pore volume distributions for pyrolyzed carbon material (sample 13a) and un-pyrolyzed carbon material (sample 13b).

FIG. 14 shows nitrogen sorption data for polymer compositions with a relatively high pore volume (sample 14a) and a relatively low pore volume (sample 14b).

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### Definitions

As used herein, and unless the context dictates otherwise, the following terms have the meanings as specified below.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried carbon, pyrolyzed polymer compositions and the like.

“Amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

“Crystalline” refers to a material whose constituent atoms, molecules, or ions are arranged in an orderly repeating pattern. Examples of crystalline carbon materials include, but are not limited to, diamond and graphene.

“Synthetic” refers to a substance which has been prepared by chemical means rather than from a natural source. For example, a synthetic carbon material is one which is synthesized from monomers and is not isolated from natural sources.

“Impurity” or “impurity element” refers to an undesired foreign substance (e.g., a chemical element) within a material which differs from the chemical composition of the base material. For example, an impurity in a carbon material refers to any element or combination of elements, other than carbon, which is present in the carbon material. Impurity levels are typically expressed in parts per million (ppm).

“PIXE impurity” or “PIXE element” is any impurity element having an atomic number ranging from 11 to 92 (i.e., from sodium to uranium). The phrases “total PIXE impurity content” and “total PIXE impurity level” both refer to the sum of all PIXE impurities present in a sample, for example, a polymer composition, cured polymer composition, or a carbon material. PIXE impurity concentrations and identities may be determined by proton induced x-ray emission (PIXE).

“TXRF impurity” or “TXRF element” may be any impurity element having an atomic number ranging from 11 to 92 (i.e., from beryllium to uranium). The phrases “total TXRF impurity content” and “total TXRF impurity level” both refer to the sum of all TXFR impurities present in a sample, for example, a polymer composition, a cured polymer composition, or a carbon material. TXRF impurity concentrations and identities may be determined by total reflection x-ray fluorescence (TXRF).

“Ultrapure” refers to a substance having a total PIXE or TXRF impurity content of less than 0.050%. For example, an “ultrapure carbon material” is a carbon material having a total PIXE or TXRF impurity content of less than 0.050% (i.e., 500 ppm).

“Ash content” refers to the nonvolatile inorganic matter which remains after subjecting a substance to a high decomposition temperature. Herein, the ash content of a carbon material is calculated from the total PIXE or TXRF impurity content as measured by proton induced x-ray emission or total reflection x-ray fluorescence, assuming that nonvolatile elements are completely converted to expected combustion products (i.e., oxides).

“Polymer” refers to a macromolecule comprised of two or more structural repeating units.

Reference to “polymer composition” and “resin mixture” are used interchangeably throughout the present disclosure. The “polymer composition” and “resin mixture” can be a solid, gel, emulsion, suspension, liquid, or any combination thereof. In some embodiments, the polymer composition or resin mixture is a solid. In some embodiments, the polymer composition or resin mixture is a gel. In some embodiments, the polymer composition or resin mixture is a solid comprising a liquid (e.g., solvent and/or catalyst).

“Monomer” or “polymer precursor” refers to compounds used in the preparation of a synthetic polymer. Examples of monomers that can be used in certain embodiments of the preparations disclosed herein include, but are not limited to, aldehydes (i.e., HC(═O)R, where R is an organic group), such as for example, methanal (formaldehyde); ethanal (acetaldehyde); propanal (propionaldehyde); butanal (butyraldehyde); glucose; benzaldehyde and cinnamaldehyde. Other exemplary monomers include, but are not limited to, phenolic compounds such as phenol and polyhydroxy benzenes, such as dihydroxy or trihydroxy benzenes, for example, resorcinol (i.e., 1,3-dihydroxy benzene), catechol, hydroquinone, and phloroglucinol. Mixtures of two or more polyhydroxy benzenes are also contemplated within the meaning of monomer.

“Relative pore integrity” refers to a value describing the degree that a polymer composition or cured polymer composition maintains a pore structure when solvent is removed during pyrolysis at a temperature greater than about 0° C. and at a pressure at or near atmospheric pressure (e.g., in a kiln or pyrolysis oven) relative to the total pore volume or mesopore structure maintained when solvent is removed from the same polymer composition or cured polymer composition using a drying technique such as freeze drying, super critical CO₂ drying, a solvent exchange process, or similar prior to pyrolysis. “Relative pore integrity” is expressed as the ratio of the total pore volume or mesopore volume that is maintained by the product (i.e., carbon material) obtained using only pyrolysis compared to the product obtained using a drying process such as freeze drying, super critical CO₂ drying, a solvent exchange process, or the like (i.e., a relative pore integrity value of 1.00 means the carbon material from both processes have the same total pore volume or mesopore volume). For example, in some embodiments, the relative pore integrity ranges from greater than 0.00 to 1.00, for example 0.022. In some embodiments, the relative pore integrity is greater than 0.4, for example 0.96. In some embodiments, the relative pore integrity ranges from greater than 0.05 to 1.00, from greater than 0.10 to 1.00, from greater than 0.15 to 1.00, from greater than 0.20 to 1.00, from greater than 0.25 to 1.00, from greater than 0.30 to 1.00, from greater than 0.35 to 1.00, from greater than 0.40 to 1.00, from greater than 0.45 to 1.00, from greater than 0.50 to 1.00, from greater than 0.50 to 1.00, from greater than 0.60 to 1.00, from greater than 0.70 to 1.00, from greater than 0.75 to 1.00, from greater than 0.80 to 1.00, from greater than 0.85 to 1.00, from greater than 0.90 to 1.00, or from greater than 0.95 to 1.00.

“Monolithic” refers to a solid, three-dimensional structure that is not particulate in nature.

“Sol” refers to a colloidal suspension of precursor particles (e.g., monomers), and the term “gel” refers to a wet three-dimensional porous network obtained by condensation or reaction of the monomers.

“Polymer gel” refers to a gel in which the network component is a polymer; generally a polymer gel is a wet (aqueous or non-aqueous based) three-dimensional structure comprising a polymer formed from monomers.

“Sol gel” refers to a sub-class of polymer gel where the polymer is a colloidal suspension that forms a wet three-dimensional porous network obtained by reaction of the monomers.

“Polymer hydrogel” or “hydrogel” refers to a subclass of polymer gel or gel wherein the solvent for the synthetic precursors or monomers is water or mixtures of water and one or more water-miscible solvent.

“RF polymer hydrogel” refers to a sub-class of polymer gel wherein the polymer was formed from the catalyzed reaction of resorcinol and formaldehyde in water or mixtures of water and one or more water-miscible solvent.

“RF polymer” refers to a sub-class of polymer wherein the polymer was formed from the catalyzed reaction of resorcinol and formaldehyde in water or mixtures of water and one or more water-miscible solvent.

“Acid” refers to any substance that is capable of lowering the pH of a solution. Acids include Arrhenius, Brønsted and Lewis acids. A “solid acid” refers to a dried or granular compound that yields an acidic solution when dissolved in a solvent. The term “acidic” means having the properties of an acid.

“Base” refers to any substance that is capable of raising the pH of a solution. Bases include Arrhenius, Brønsted and Lewis bases. A “solid base” refers to a dried or granular compound that yields basic solution when dissolved in a solvent. The term “basic” means having the properties of a base.

“Mixed solvent system” refers to a solvent system comprised of two or more solvents, for example, two or more miscible solvents. Examples of binary solvent systems (i.e., containing two solvents) include, but are not limited to: water and acetic acid; water and formic acid; water and propionic acid; water and butyric acid and the like. Examples of ternary solvent systems (i.e., containing three solvents) include, but are not limited to: water, acetic acid, and ethanol; water, acetic acid and acetone; water, acetic acid, and formic acid; water, acetic acid, and propionic acid; and the like. Embodiments of the present invention contemplate all mixed solvent systems comprising two or more solvents.

“Miscible” refers to the property of a mixture wherein the mixture forms a single phase over certain ranges of temperature, pressure, and composition.

“Catalyst” is a substance which alters the rate of a chemical reaction. Catalysts participate in a reaction in a cyclic fashion such that the catalyst is cyclically regenerated. The present disclosure contemplates catalysts which are sodium free. The catalyst used in the preparation of a polymer composition (e.g., an ultrapure polymer composition) as described herein can be any compound that facilitates the co-polymerization of the monomers. A “volatile catalyst” is a catalyst which has a tendency to vaporize at or below atmospheric pressure. Exemplary volatile catalysts include, but are not limited to, ammoniums salts, such as ammonium bicarbonate, ammonium acetate, ammonium carbonate, ammonium hydroxide, and combinations thereof.

“Solvent” refers to a substance which dissolves or suspends reactants (e.g., the first and second monomer) and provides a medium in which a reaction may occur. Examples of solvents useful in the preparation of the resin mixtures, polymer compositions, cured polymer compositions, ultrapure polymer compositions, carbon materials, ultrapure carbon materials and ultrapure synthetic amorphous carbon materials disclosed herein include, but are not limited to, water, alcohols and mixtures thereof. Exemplary alcohols include ethanol, t-butanol, methanol and mixtures thereof. Such solvents are useful for dissolution of the monomers, for example dissolution of a phenolic or aldehyde compound. In addition, in some processes such solvents are employed for solvent exchange in a polymer composition, wherein the solvent from the co-polymerization of the monomers, for example, resorcinol and formaldehyde, is exchanged for a pure alcohol. In one embodiment of the present application, a carbon material is prepared by a process that does not include solvent exchange.

“Dried gel” or “dried polymer gel” refers to a gel or polymer gel, respectively, from which the solvent, generally water, or mixture of water and one or more water-miscible solvents, has been substantially removed.

“Pyrolyzed dried polymer gel” refers to a dried polymer gel which has been pyrolyzed but not yet activated, while an “activated dried polymer gel” refers to a dried polymer gel which has been activated.

“Pyrolyzed cryogel” is a cryogel that has been pyrolyzed but not yet activated. “Activated cryogel” is a cryogel which has been activated to obtain activated carbon material.

“Xerogel” refers to a dried gel that has been dried by air drying, for example, at or below atmospheric pressure.

“Pyrolyzed xerogel” is a xerogel that has been pyrolyzed but not yet activated. “Activated xerogel” is a xerogel which has been activated to obtain activated carbon material.

“Aerogel” refers to a dried gel that has been dried by supercritical drying, for example, using supercritical carbon dioxide.

“Pyrolyzed aerogel” is an aerogel that has been pyrolyzed but not yet activated. “Activated aerogel” is an aerogel which has been activated to obtain activated carbon material.

“Organic extraction solvent” refers to an organic solvent added to a polymer composition after polymerization (e.g., co-polymerization) of the monomers has begun, generally after polymerization of the polymer composition is complete.

“Rapid multi-directional freezing” refers to the process of freezing a polymer gel by creating polymer gel particles from a monolithic polymer gel, and subjecting said polymer gel particles to a suitably cold medium. The cold medium can be, for example, liquid nitrogen, nitrogen gas, or solid carbon dioxide. During rapid multi-directional freezing nucleation of ice dominates over ice crystal growth. The suitably cold medium can be, for example, a gas, liquid, or solid with a temperature below about −10° C. Alternatively, the suitably cold medium can be a gas, liquid, or solid with a temperature below about −20° C. Alternatively, the suitably cold medium can be a gas, liquid, or solid with a temperature below about −30° C.

“Activate” and “activation” each refer to the process of heating a raw material or carbonized/pyrolyzed substance at an activation dwell temperature during exposure to oxidizing atmospheres (e.g., carbon dioxide, oxygen, steam or combinations thereof) to produce an “activated” substance (e.g., activated carbon material). The activation process generally results in a stripping away of the surface of the particles, resulting in an increased surface area. Alternatively, activation can be accomplished by chemical means, for example, by impregnation of carbon-containing precursor materials with chemicals such as acids like phosphoric acid or bases like potassium hydroxide, sodium hydroxide or salts like zinc chloride, followed by carbonization. “Activated” refers to a material or substance, for example a carbon material, which has undergone the process of activation.

“Carbonizing”, “pyrolyzing”, “carbonization” and “pyrolysis” each refer to the process of heating a carbon-containing substance at a temperature, optionally under an inert atmosphere (e.g., argon, nitrogen or combinations thereof) or in a vacuum such that the targeted material collected at the end of the process comprises primarily carbon. “Pyrolyzed” refers to a material or substance, for example a carbon material, which has undergone the process of pyrolysis.

“Dwell temperature” refers to the temperature of the furnace, oven or other heating chamber during the portion of a process which is reserved for maintaining a relatively constant temperature (i.e., neither increasing nor decreasing the temperature). For example, the pyrolysis dwell temperature refers to the relatively constant temperature of the furnace, oven or heating chamber during pyrolysis, and the carbonization dwell temperature refers to the relatively constant temperature of the furnace, oven or heating chamber during curing.

“Ramp rate” refers to a rate of temperature change during various steps of the process, including the holding ramp rate and/or a curing ramp rate. As used herein, a range or threshold value (e.g., ranging from about 3° C./hour to about 100° C./hour and above about 3° C./hour, respectively) means that the ramp rate is within or above the specified range or value for some period of time greater than 0 seconds. For example, a ramp rate as used herein may include, for example a linear rate, an exponential rate, and may be dynamic in that it may plateau or increase.

“Pore” refers to an opening or depression in the surface, or a tunnel in a carbon material, such as for example pyrolyzed carbon material, pyrolyzed polymer compositions, activated carbon material, activated polymer compositions and the like. A pore can be a single tunnel or connected to other tunnels in a continuous network throughout the structure.

“Pore structure” refers to the layout of the surface of the internal pores within a carbon material, such as an activated carbon material. Components of the pore structure include pore size, mesopore volume, surface area, density, pore size distribution and pore length. Generally the pore structure of an activated carbon material comprises micropores and mesopores. For example, in certain embodiments the ratio of micropores to mesopores is optimized for enhanced electrochemical performance.

“Mesopore” generally refers to a pore having a diameter ranging from 2 nanometers to 50 nanometers while the term “micropore” refers to a pore having a diameter less than 2 nanometers.

“Surface area” refers to the total specific surface area of a substance measurable by the BET technique. Surface area is typically expressed in units of m²/g. The BET (Brunauer/Emmett/Teller) technique employs an inert gas, for example nitrogen, to measure the amount of gas adsorbed on a material and is commonly used in the art to determine the accessible surface area of materials.

“Connected” when used in reference to mesopores and micropores refers to the spatial orientation of such pores.

“Effective length” refers to the portion of the length of the pore that is of sufficient diameter such that it is available to accept salt ions from the electrolyte.

“Electrode” refers to the positive or negative component of a cell (e.g., capacitor, battery, etc.) including the active material. Electrodes generally comprise one or more metal leads through which electricity enters or leaves the electrode.

“Binder” refers to a material capable of holding individual particles of a substance (e.g., a carbon material) together such that after mixing a binder and the particles together the resulting mixture can be formed into sheets, pellets, disks or other shapes. In certain embodiments, an electrode may comprise carbon materials prepared according to an embodiment of the methods described herein and a binder. Non-exclusive examples of binders include fluoro polymers, such as, for example, PTFE (polytetrafluoroethylene, Teflon), PFA (perfluoroalkoxy polymer resin, also known as Teflon), FEP (fluorinated ethylene propylene, also known as Teflon), ETFE (polyethylenetetrafluoroethylene, sold as Tefzel and Fluon), PVF (polyvinyl fluoride, sold as Tedlar), ECTFE (polyethylenechlorotrifluoroethylene, sold as Halar), PVDF (polyvinylidene fluoride, sold as Kynar), PCTFE (polychlorotrifluoroethylene, sold as Kel-F and CTFE), trifluoroethanol and combinations thereof.

“Inert” refers to a material that is not active in the electrolyte of an electrical energy storage device, that is it does not absorb a significant amount of ions or change chemically, e.g., degrade.

“Conductive” refers to the ability of a material to conduct electrons through transmission of loosely held valence electrons.

“Current collector” refers to a part of an electrical energy storage and/or distribution device which provides an electrical connection to facilitate the flow of electricity in to, or out of, the device. Current collectors often comprise metal and/or other conductive materials and may be used as a backing for electrodes to facilitate the flow of electricity to and from the electrode.

“Electrolyte” means a substance containing free ions such that the substance is electrically conductive. Electrolytes are commonly employed in electrical energy storage devices. Examples of electrolytes include, but are not limited to, solvents such as propylene carbonate, ethylene carbonate, butylene carbonate, dimethyl carbonate, methyl ethyl carbonate, diethyl carbonate, sulfolane, methylsulfolane, acetonitrile or mixtures thereof in combination with solutes such as tetralkylammonium salts such as TEA TFB (tetraethylammonium tetrafluoroborate), MTEATFB (methyltriethylammonium tetrafluoroborate), EMITFB (1-ethyl-3-methylimidazolium tetrafluoroborate), tetraethylammonium, triethylammonium based salts or mixtures thereof. In some embodiments, the electrolyte can be a water-based acid or water-based base electrolyte such as mild aqueous sulfuric acid or aqueous potassium hydroxide.

### A. Preparation of Carbon Materials

Embodiments of methods for preparing carbon materials which comprise electrochemical modifiers and which comprise high surface area, high porosity and low levels of undesirable impurities without using some sort of drying process (e.g., freeze drying, supercritical drying or air drying) are not known in the art. Current methods for preparing carbon materials of high surface area and high porosity result in carbon materials having high levels of undesirable impurities and/or include a costly drying procedure. Electrodes prepared by incorporating an electrochemical modifier into these carbon materials cost substantially more to manufacture and/or have poor electrical performance as a result of residual impurities.

Accordingly, in one embodiment the present disclosure provides a method comprising:

a) combining a solvent, a catalyst, a first monomer and a second monomer to yield a reaction mixture;

b) holding the reaction mixture at a holding temperature sufficient to co-polymerize the first and second monomer to yield a resin mixture;

c) heating the resin mixture at a curing temperature, thereby forming a polymer composition comprising the solvent and a polymer formed from co-polymerizing the first and second monomer, wherein the solvent concentration in the polymer composition is at least 5 wt %, based on total weight of the polymer composition; and

d) pyrolyzing the polymer composition at a pyrolysis temperature thereby substantially removing the solvent and pyrolyzing the polymer to yield a carbon material.

In some more specific embodiments, a method comprising:

a) combining a solvent, a catalyst, a first monomer and a second monomer to yield a reaction mixture;

b) increasing the temperature of the reaction mixture at a holding ramp rate and holding the reaction mixture at a holding temperature sufficient to co-polymerize the first and second monomer to yield a polymer composition; and

c) optionally heating the polymer composition at a curing temperature, thereby forming a cured polymer composition comprising the solvent and a polymer formed from co-polymerizing the first and second monomer, wherein the solvent concentration in the cured polymer composition is at least 5 wt %, based on total weight of the cured polymer composition is provided.

In some embodiments, the method further comprises pyrolyzing the cured polymer composition to a pyrolysis temperature thereby substantially removing the solvent and pyrolyzing the polymer to yield a carbon material. In another embodiment the method further comprises heating the polymer composition at a curing temperature, thereby forming a cured polymer composition comprising the solvent and a polymer formed from co-polymerizing the first and second monomer, wherein the solvent concentration in the cured polymer composition is at least 5 wt %, based on total weight of the cured polymer composition.

In some specific embodiments, the concentration of the solvent in the cured polymer composition is greater than 10 wt. % of the cured polymer composition. In some embodiments, the concentration of the solvent in the cured polymer composition is greater than 20 wt. % of the polymer composition. In some embodiments, the concentration of the solvent in the cured polymer composition ranges from about 45 wt. % to about 90 wt. % of the cured polymer composition. In more specific embodiments, the concentration of the solvent in the cured polymer composition ranges from about 50 wt. % to about 75 wt. %. In more specific embodiments, the concentration of the solvent in the cured polymer composition ranges from about 35 wt. % to about 80 wt. %, from about 35 wt. % to about 75 wt. %, from about 30 wt. % to about 90 wt. %, from about 30 wt. % to about 85 wt. %, from about 30 wt. % to about 70 wt. %, from about 60 wt. % to about 90 wt. %, or from about 65 wt. % to about 80 wt. %.

Accordingly, in some embodiments prior to pyrolysis, the aqueous content of the cured polymer composition ranges from about 50 wt. % to about 99 wt. % of the cured polymer composition. In some embodiments, the concentration of the solvent in the cured polymer composition ranges from greater than about 0 wt. % to 99 wt. %, greater than about 5 wt. % to 99 wt. %, greater than about 10 wt. % to 99 wt. %, greater than about 15 wt. % to 99 wt. %, greater than about 20 wt. % to 99 wt. %, greater than about 25 wt. % to 99 wt. %, greater than about 30 wt. % to 99 wt. %, greater than about 35 wt. % to 99 wt. %, greater than about 40 wt. % to 99 wt. %, greater than about 45 wt. % to 99 wt. %, greater than about 50 wt. % to 99 wt. %, greater than about 55 wt. % to 99 wt. %, greater than about 60 wt. % to 99 wt. %, greater than about 65 wt. % to 99 wt. %, greater than about 70 wt. % to 99 wt. %, greater than about 75 wt. % to 99 wt. %, greater than about 80 wt. % to 99 wt. %, greater than about 85 wt. % to 99 wt. %, greater than about 90 wt. % to 99 wt. %, greater than about 0 wt. % to 95 wt. %, greater than about 0 wt. % to 90 wt. %, greater than about 0 wt. % to 85 wt. %, greater than about 0 wt. % to 80 wt. %, greater than about 0 wt. % to 75 wt. %, greater than about 0 wt. % to 70 wt. %, greater than about 0 wt. % to 65 wt. %, greater than about 0 wt. % to 60 wt. %, greater than about 0 wt. % to 55 wt. %, greater than about 0 wt. % to 50 wt. %, greater than about 0 wt. % to 45 wt. %, greater than about 0 wt. % to 40 wt. %, greater than about 0 wt. % to 35 wt. %, greater than about 0 wt. % to 30 wt. %, greater than about 0 wt. % to 25 wt. %, greater than about 0 wt. % to 20 wt. %, greater than about 0 wt. % to 15 wt. %, greater than about 0 wt. % to 10 wt. %, greater than about 0 wt. % to 5 wt. %, greater than about 0 wt. % to 2.5 wt. % or greater than about 0 wt. % to 1 wt. %.

In certain specific embodiments, the concentration of the solvent in the cured polymer composition ranges from greater than about 0.0% to about 90% of the cured polymer composition as measured by weight/weight, volume/volume or weight/volume. In other embodiments, the concentration of the solvent in the cured polymer composition ranges from greater than about 0.0% to about 88%, greater than about 0.0% to about 85%, greater than about 0.0% to about 82.5%, greater than about 0.0% to about 80%, greater than about 0.0% to about 77.5%, greater than about 0.0% to about 75%, greater than about 0.0% to about 72.5%, greater than about 0.0% to about 70%, greater than about 0.0% to about 67.5%, greater than about 0.0% to about 65%, greater than about 0.0% to about 62.5%, greater than about 0.0% to about 60%, greater than about 0.0% to about 57.5%, greater than about 0.0% to about 55%, greater than about 0.0% to about 52.5%, greater than about 0.0% to about 50%, greater than about 0.0% to about 47.5%, greater than about 0.0% to about 45%, greater than about 0.0% to about 42.5%, greater than about 0.0% to about 40%, greater than about 0.0% to about 37.5%, greater than about 0.0% to about 35%, greater than about 0.0% to about 32.5%, greater than about 0.0% to about 30%, greater than about 0.0% to about 27.5%, greater than about 0.0% to about 25%, greater than about 0.0% to about 22.5%, greater than about 0.0% to about 20%, greater than about 0.0% to about 17.5%, greater than about 0.0% to about 15%, greater than about 0.0% to about 12.5%, greater than about 0.0% to about 10%, greater than about 0.0% to about 7.5%, greater than about 0.0% to about 5%, greater than about 0.0% to about 2.5%, greater than about 0.0% to about 1%, greater than about 1% to about 90%, greater than about 2.5% to about 90%, greater than about 5% to about 90%, greater than about 7.5% to about 90%, greater than about 10% to about 90%, greater than about 12.5% to about 90%, greater than about 15% to about 90%, greater than about 17.5% to about 90%, greater than about 20% to about 90%, greater than about 22.5% to about 90%, greater than about 25% to about 90%, greater than about 27.5% to about 90%, greater than about 30% to about 90%, greater than about 32.5% to about 90%, greater than about 35% to about 90%, greater than about 37.5% to about 90%, greater than about 40% to about 90%, greater than about 42.5% to about 90%, greater than about 45% to about 90%, greater than about 47.5% to about 90%, greater than about 50% to about 90%, greater than about 52.5% to about 90%, greater than about 55% to about 90%, greater than about 57.5% to about 90%, greater than about 60% to about 90%, greater than about 62.5% to about 90%, greater than about 65% to about 90%, greater than about 67.5% to about 90%, greater than about 70% to about 90%, greater than about 72.5% to about 90%, greater than about 75% to about 90%, greater than about 77.5% to about 90% or greater than about 80% to about 90% of the cured polymer composition as measured by weight/weight, volume/volume or weight/volume.

In certain embodiments, the concentration of the solvent in the cured polymer composition is greater than 0.5 wt. %, greater than 1 wt. %, greater than 2 wt. %, greater than 3 wt. %, greater than 4 wt. %, greater than 5 wt. %, greater than 6 wt. %, greater than 7 wt. %, greater than 8 wt. %, greater than 9 wt. %, greater than 10 wt. %, greater than 15 wt. %, greater than 20 wt. %, greater than 22.5 wt. %, greater than 25 wt. %, greater than 27.5 wt. %, greater than 30 wt. %, greater than 35 wt. %, greater than 37.5 wt. %, greater than 40 wt. %, greater than 45 wt. %, greater than 50 wt. %, greater than 55 wt. %, greater than 60 wt. %, greater than 65 wt. %, greater than 70 wt. %, greater than 75 wt. %, greater than 80 wt. %, greater than 85 wt. %, greater than 90 wt. %, greater than 95 wt. % or greater than 99 wt. % of the cured polymer composition.

In some embodiments, the cured polymer composition further comprises from about 0.25 wt. % to about 0.95 wt. % of the catalyst. In some embodiments, the cured polymer composition further comprises from about 0.30 wt. % to about 0.90 wt. % of the catalyst. In some embodiments, the cured polymer composition further comprises from about 0.01 wt. % to about 0.95 wt. % of the catalyst. In some embodiments, the cured polymer composition further comprises from about 0.10 wt. % to about 0.90 wt. % of the catalyst. In other embodiments, the cured polymer composition further comprises from about 0.35 wt. % to about 0.85 wt. % of the catalyst. In other embodiments, the cured polymer composition further comprises from about 0.25 wt. % to about 0.85 wt. % of the catalyst.

In some embodiments of the methods described herein, the molar ratio of first monomer to catalyst is from about 5:1 to about 2000:1 or the molar ratio of first monomer to catalyst is from about 20:1 to about 200:1. In further embodiments, the molar ratio of first monomer to catalyst is from about 25:1 to about 100:1. In further embodiments, the molar ratio of first monomer to catalyst is from about 25:1 to about 50:1. In further embodiments, the molar ratio of first monomer to catalyst is from about 100:1 to about 5:1.

In the specific embodiment wherein the first monomer is resorcinol and the second monomer is formaldehyde, the resorcinol to catalyst ratio can be varied to obtain the desired properties of the resultant cured polymer composition and carbon materials. In some embodiments of the methods described herein, the molar ratio of resorcinol to catalyst is from about 10:1 to about 2000:1 or the molar ratio of resorcinol to catalyst is from about 20:1 to about 200:1. In further embodiments, the molar ratio of resorcinol to catalyst is from about 25:1 to about 100:1. In further embodiments, the molar ratio of resorcinol to catalyst is from about 25:1 to about 50:1. In further embodiments, the molar ratio of resorcinol to catalyst is from about 100:1 to about 5:1.

In some specific embodiments, the reaction mixture comprises a concentration of the catalyst greater than about 0.01% of the reaction mixture measured as weight/weight, volume/volume or weight/volume. In other embodiments, the reaction mixture comprises a concentration of the catalyst greater than about 0.02%, greater than about 0.03%, greater than about 0.04%, greater than about 0.05%, greater than about 0.10%, greater than about 0.15%, greater than about 0.20%, greater than about 0.25%, greater than about 0.30%, greater than about 0.35%, greater than about 0.37%, greater than about 0.40%, greater than about 0.42%, greater than about 0.45%, greater than about 0.47%, greater than about 0.50%, greater than about 0.52%, greater than about 0.55%, greater than about 0.57%, greater than about 0.60%, greater than about 0.62%, greater than about 0.65%, greater than about 0.67%, greater than about 0.70%, greater than about 0.72%, greater than about 0.75%, greater than about 0.77%, greater than about 0.80%, greater than about 0.82%, greater than about 0.85%, greater than about 0.90%, greater than about 0.95%, greater than about 1.0%, greater than about 2.5%, greater than about 5% or greater than about 10% of the reaction mixture measured as weight/weight, volume/volume or weight/volume.

In some more specific embodiments, the reaction mixture comprises a concentration of catalyst from greater than about 0.01% to about 10%, from greater than about 0.05% to about 8%, from greater than about 0.10% to about 6%, from greater than about 0.20% to about 5%, from greater than about 0.20% to about 1%, from greater than about 0.20% to about 0.95%, from greater than about 0.20% to about 0.90%, from greater than about 0.20% to about 0.85%, from greater than about 0.25% to about 1%, from greater than about 0.25% to about 0.95%, from greater than about 0.25% to about 0.90%, from greater than about 0.25% to about 0.90%, from greater than about 0.30% to about 1%, from greater than about 0.30% to about 0.95%, from greater than about 0.30% to about 0.90%, from greater than about 0.30% to about 0.85%, from greater than about 0.35% to about 1%, from greater than about 0.35% to about 0.95%, from greater than about 0.35% to about 0.90%, from greater than about 0.35% to about 0.85% or from greater than about 0.20% to about 0.35% of the reaction mixture measured as weight/weight, volume/volume or weight/volume.

In certain embodiments, the cured polymer composition further comprises a concentration of the solvent greater than 20 wt. % and a concentration of the catalyst ranges from 0.20 wt. % to about 1 wt. % of the cured polymer composition. In other embodiments, the cured polymer composition further comprises a concentration of the solvent greater than 20 wt. % and a concentration of the catalyst ranges from 0.20 wt. % to about 0.85 wt. % of the cured polymer composition. In certain embodiments, the cured polymer composition further comprises a concentration of the solvent greater than 15 wt. % and a concentration of the catalyst ranges from 0.20 wt. % to about 1 wt. % of the cured polymer composition. In certain embodiments, the cured polymer composition further comprises a concentration of the solvent greater than 10 wt. % and a concentration of the catalyst ranges from 0.20 wt. % to about 1 wt. % of the cured polymer composition. In certain embodiments, the cured polymer composition further comprises a concentration of the solvent greater than 15 wt. % and a concentration of the catalyst ranges from 0.20 wt. % to about 0.85 wt. % of the cured polymer composition. In certain embodiments, the cured polymer composition further comprises a concentration of the solvent greater than 10 wt. % and a concentration of the catalyst ranges from 0.20 wt. % to about 0.85 wt. % of the cured polymer composition.

Another embodiment provides a method comprising:

a) combining a solvent, a catalyst, a first monomer and a second monomer to yield a reaction mixture, and maintaining the reaction mixture at a reaction temperature for a reaction time;

b) holding the reaction mixture at a holding temperature sufficient to co-polymerize the first and second monomer to yield a resin mixture;

c) heating the resin mixture up to a curing temperature, thereby forming a polymer composition comprising the solvent and a polymer formed from co-polymerizing the first and second monomer; and

d) pyrolyzing the polymer composition at a pyrolysis temperature, thereby substantially removing the solvent and pyrolyzing the polymer to yield a carbon material.

Additional embodiments provide a method comprising:

a) combining a solvent, a catalyst, a first monomer and a second monomer to yield a reaction mixture, and maintaining the reaction mixture at a reaction temperature for a reaction time;

b) increasing the temperature of the reaction mixture at a holding ramp rate and holding the reaction mixture at a holding temperature sufficient to co-polymerize the first and second monomer to yield a polymer composition; and

c) optionally heating the polymer composition up to a curing temperature, thereby forming a cured polymer composition comprising the solvent and a polymer formed from co-polymerizing the first and second monomer.

In some embodiments, method further comprises pyrolyzing the cured polymer composition to a pyrolysis temperature, thereby substantially removing the solvent and pyrolyzing the polymer to yield a carbon material. In other embodiments, the method further comprises heating the polymer composition up to a curing temperature, thereby forming a cured polymer composition comprising the solvent and a polymer formed from co-polymerizing the first and second monomer.

Without wishing to be bound by theory, Applicants have discovered that parameters (e.g., holding ramp rate, holding time, holding temperature, curing ramp rate, etc.) have an effect on the reaction time needed to yield carbon materials with desirable properties. As such, the reaction time may be selected in view of the other parameters in a specific embodiment. For example, in one specific embodiment, a relatively long holding time (e.g., 7 days) and high holding temperature (e.g., 130° C.) may warrant a relatively short reaction time (e.g., greater than about 0 hours to about 1 hour).

In some embodiments, the reaction temperature is greater than about 15° C., greater than about 20° C., greater than about 25° C., greater than about 30° C., greater than about 31° C., greater than about 32° C., greater than about 33° C., greater than about 33° C., greater than about 34° C., greater than about 35° C., greater than about 36° C., greater than about 37° C., greater than about 38° C., greater than about 39° C., greater than about 40° C., greater than about 41° C., greater than about 42° C., greater than about 43° C., greater than about 44° C., greater than about 45° C., greater than about 46° C., greater than about 47° C., greater than about 48° C., greater than about 49° C., greater than about 50° C., greater than about 52.5° C., greater than about 55° C., greater than about 57.5° C., greater than about 60° C., greater than about 62.5° C., greater than about 65° C., greater than about 67.5° C., greater than about 70° C., greater than about 72.5° C., greater than about 75° C., greater than about 77.5° C., greater than about 80° C., greater than about 82.5° C., greater than about 85° C., greater than about 87.5° C., greater than about 90° C., greater than about 95° C., greater than about 100° C., greater than about 105° C., greater than about 110° C., greater than about 115° C., greater than about 120° C. or greater than about 125° C.

In some embodiments, the reaction temperature is within a certain range. For example, in some embodiments, the reaction temperature ranges from about 5° C. to about 80° C., from about 20° C. to about 60° C., from about 30° C. to about 50° C., from about 30° C. to about 45° C., from about 30° C. to about 40° C., from about 35° C. to about 50° C., from about 35° C. to about 45° C., from about 35° C. to about 40° C., from about 40° C. to about 60° C., from about 40° C. to about 55° C., from about 40° C. to about 50° C., from about 40° C. to about 45° C. or from about 45° C. to about 65° C.

In some embodiments the reaction time is greater than 1 day, greater than 2 days, greater than 3 days, greater than 4 days, greater than 5 days, greater than 6 days, greater than 7 days, greater than 8 days, greater than 9 days, greater than 10 days, greater than 11 days, greater than 12 days, greater than 13 days or greater than 14 days.

In some embodiments, the reaction time ranges from greater than about 0 hours to about 120 hours, greater than about 0 hours to about 110 hours, greater than about 0 hours to about 100 hours, greater than about 0 hours to about 90 hours, greater than about 0 hours to about 72 hours, greater than about 0 hours to about 60 hours, greater than about 0 hours to about 48 hours, greater than about 0 hours to about 36 hours, greater than about 0 hours to about 24 hours, greater than about 0 hours to about 12 hours, greater than about 0 hours to about 10 hours, greater than about 0 hours to about 8 hours, greater than about 0 hours to about 6 hours, greater than about 0 hours to about 5 hours, greater than about 0 hours to about 4 hours, greater than about 0 hours to about 3 hours, greater than about 0 hours to about 2 hours, greater than about 0 hours to about 1 hour, greater than about 1 hours to about 120 hours, greater than about 2 hours to about 120 hours, greater than about 3 hours to about 120 hours, greater than about 4 hours to about 120 hours, greater than about 4 hours to about 120 hours, greater than about 5 hours to about 120 hours, greater than about 6 hours to about 120 hours, greater than about 8 hours to about 120 hours, greater than about 10 hours to about 120 hours, greater than about 12 hours to about 120 hours, greater than about 24 hours to about 120 hours, greater than about 36 hours to about 120 hours, greater than about 48 hours to about 120 hours, greater than about 60 hours to about 120 hours, greater than about 72 hours to about 120 hours or greater than about 90 hours to about 120 hours.

In some more specific embodiments, the reaction time ranges from greater than about 0 minutes to about 480 minutes, greater than about 0 minutes to about 240 minutes, greater than about 0 minutes to about 180 minutes, greater than about 0 minutes to about 120 minutes, greater than about 0 minutes to about 90 minutes, greater than about 0 minutes to about 60 minutes, greater than about 0 minutes to about 30 minutes, greater than about 0 minutes to about 20 minutes, greater than about 0 minutes to about 10 minutes, greater than about 5 minutes to about 480 minutes, greater than about 10 minutes to about 480 minutes, greater than about 20 minutes to about 480 minutes, greater than about 30 minutes to about 480 minutes, greater than about 40 minutes to about 480 minutes, greater than about 60 minutes to about 480 minutes, greater than about 90 minutes to about 480 minutes, greater than about 120 minutes to about 480 minutes, greater than about 180 minutes to about 480 minutes or greater than about 240 minutes to about 480 minutes.

In other related embodiments, the reaction time ranges from greater than about 0 to about 120 hours. In more specific embodiments, the reaction time ranges from greater than about 0 to about 6 hours. In more specific embodiments, the reaction time ranges from greater than about 3 to about 6 hours.

In certain embodiments, the reaction temperature ranges from about 20° C. to about 130° C. In some embodiments, the reaction temperature ranges from about 38° C. to about 42° C. In some other embodiments, the reaction temperature ranges from about 48° C. to about 52° C.

In other specific embodiments, the reaction temperature ranges from greater than about 20° C. to about 150° C. and the holding temperature ranges from greater than about 20° C. to about 150° C. In more specific embodiments, the reaction temperature ranges from greater than about 25° C. to about 80° C. and the holding temperature ranges from greater than about 40° C. to about 120° C. In some embodiments, the reaction temperature ranges from greater than about 25° C. to about 50° C. and the holding temperature ranges from greater than about 60° C. to about 120° C.

In some embodiments, the reaction temperature ranges from about 20° C. to about 30° C., from about 25° C. to about 35° C., from about 30° C. to about 40° C., from about 35° C. to about 40° C., from about 30° C. to about 35° C., from about 35° C. to about 45° C., from about 30° C. to about 50° C. or from about 45° C. to about 50° C.

Yet another embodiment provides a method comprising:

a) combining a solvent, a catalyst, a first monomer and a second monomer to yield a reaction mixture;

b) holding the reaction mixture for a holding time at a holding temperature sufficient to co-polymerize the first and second monomer to yield a resin mixture;

c) heating the resin mixture at a curing temperature, thereby forming a polymer composition comprising the solvent and a polymer formed from co-polymerizing the first and second monomer; and

d) pyrolyzing the polymer composition at a pyrolysis temperature thereby substantially removing the solvent and pyrolyzing the polymer to yield a carbon material.

In some embodiments, the method comprises:

a) combining a solvent, a catalyst, a first monomer and a second monomer to yield a reaction mixture;

b) increasing the temperature of the reaction mixture at a holding ramp rate and holding the reaction mixture for a holding time at a holding temperature sufficient to co-polymerize the first and second monomer to yield a polymer composition;

c) optionally heating the polymer composition at a curing temperature, thereby forming a cured polymer composition comprising the solvent and a polymer formed from co-polymerizing the first and second monomer.

In some more specific embodiments, the method further comprises pyrolyzing the cured polymer composition at a pyrolysis temperature thereby substantially removing the solvent and pyrolyzing the polymer to yield a carbon material. In other embodiments, the method further comprises heating the polymer composition at a curing temperature, thereby forming a cured polymer composition comprising the solvent and a polymer formed from co-polymerizing the first and second monomer.

In certain embodiment, the refractive index of the reaction mixture is measured. For example, in some embodiments, the reaction mixture has a refractive index ranging from about 1.42 to about 1.46. In some embodiments, the reaction mixture has a refractive index greater than about 1.00, greater than about 1.05, greater than about 1.10, greater than about 1.15, greater than about 1.20, greater than about 1.25, greater than about 1.30, greater than about 1.35, greater than about 1.40, greater than about 1.415, greater than about 1.420, greater than about 1.425, greater than about 1.430, greater than about 1.435, greater than about 1.440, greater than about 1.421, greater than about 1.422, greater than about 1.423, greater than about 1.424, greater than about 1.425, greater than about 1.426, greater than about 1.427, greater than about 1.428, greater than about 1.429, greater than about 1.431, greater than about 1.432, greater than about 1.433, greater than about 1.434, greater than about 1.436, greater than about 1.437, greater than about 1.438, greater than about 1.439, greater than about 1.441, greater than about 1.442, greater than about 1.443, greater than about 1.444 or greater than about 1.445.

In certain embodiments, the refractive index ranges from about 1.300 to about 1.500, from about 1.410 to about 1.450, from about 1.420 to about 1.440, from about 1.420 to about 1.439, from about 1.420 to about 1.438, from about 1.420 to about 1.437, from about 1.420 to about 1.436, from about 1.420 to about 1.435, from about 1.420 to about 1.434, from about 1.420 to about 1.433 or from about 1.425 to about 1.437.

Polymerization (e.g., co-polymerization) to form a polymer composition and/or a cured polymer composition can be accomplished by various means described in the art and may include addition of an electrochemical modifier. For instance, co-polymerization can be accomplished by incubating suitable monomers (e.g., a first and second monomer) or polymer composition, and optionally an electrochemical modifier, in the presence of a suitable catalyst for a sufficient period of time. The reaction time and/or holding time can be a period ranging from minutes or hours to days, depending on the temperature (the higher the temperature the faster, the reaction rate, and correspondingly, the shorter the time required). The reaction temperature and/or holding temperature can range from room temperature (e.g., 25° C. at 1 atm) to a temperature approaching (but lower than) the boiling point of the starting solution. For example, the reaction temperature and/or holding temperature can range from about 20° C. to about 90° C.

In some embodiments, the holding temperature is greater than about 15° C., greater than about 20° C., greater than about 25° C., greater than about 30° C., greater than about 31° C., greater than about 32° C., greater than about 33° C., greater than about 33° C., greater than about 34° C., greater than about 35° C., greater than about 36° C., greater than about 37° C., greater than about 38° C., greater than about 39° C., greater than about 40° C., greater than about 41° C., greater than about 42° C., greater than about 43° C., greater than about 44° C., greater than about 45° C., greater than about 46° C., greater than about 47° C., greater than about 48° C., greater than about 49° C., greater than about 50° C., greater than about 52.5° C., greater than about 55° C., greater than about 57.5° C., greater than about 60° C., greater than about 62.5° C., greater than about 65° C., greater than about 67.5° C., greater than about 70° C., greater than about 72.5° C., greater than about 75° C., greater than about 77.5° C., greater than about 80° C., greater than about 82.5° C., greater than about 85° C., greater than about 87.5° C., greater than about 90° C., greater than about 95° C., greater than about 100° C., greater than about 105° C., greater than about 110° C., greater than about 115° C., greater than about 120° C. or greater than about 125° C.

In some embodiments, the holding temperature is within a certain range. For example, in some embodiments, the holding temperature ranges from about 5° C. to about 150° C., from about 10° C. to about 140° C., from about 10° C. to about 130° C., from about 15° C. to about 120° C., from about 20° C. to about 120° C., from about 25° C. to about 120° C., from about 30° C. to about 110° C., from about 40° C. to about 100° C., from about 50° C. to about 90° C., from about 55° C. to about 85° C., from about 60° C. to about 80° C., from about 20° C. to about 70° C. or from about 65° C. to about 85° C. In some specific embodiments, the holding temperature ranges from about 20° C. to about 80° C. In certain embodiments, the holding temperature ranges from about 15° C. to about 120° C., from about 15° C. to about 80° C., from about 15° C. to about 40° C., from about 20° C. to about 30° C. or from about 20° C. to about 25° C.

In some embodiments, the holding time is greater than about 0 hours, greater than about 1 hour, greater than about 2 hours, greater than about 3 hours, greater than about 4 hours, greater than about 5 hours, greater than about 6 hours, greater than about 7 hours, greater than about 8 hours, greater than about 9 hours, greater than about 10 hours, greater than about 11 hours, greater than about 12 hours, greater than about 24 hours, greater than about 40 hours, greater than about 48 hours, greater than about 60 hours, greater than about 72 hours, greater than about 100 hours, greater than about 120 hours.

In some embodiments the holding time is greater than 1 day, greater than 2 days, greater than 3 days, greater than 4 days, greater than 5 days, greater than 6 days, greater than 7 days, greater than 8 days, greater than 9 days, greater than 10 days, greater than 11 days, greater than 12 days, greater than 13 days or greater than 14 days.

In some embodiments the holding time is greater than 1 week, greater than 2 weeks, greater than 3 weeks, greater than 4 weeks, greater than 1 month, greater than 2 months, greater than 3 months, greater than 4 months, greater than 5 months, greater than 6 months, greater than 7 months, greater than 8 months, greater than 9 months, greater than 10 months, greater than 11 months, greater than 12 months, greater than 18 months, greater than 24 months or greater than 5 years.

Without wishing to be bound by theory, Applicants have discovered that parameters (e.g., reaction time, reaction temperature, holding ramp rate, holding temperature, curing ramp rate, etc.) have an effect on the holding time needed to yield carbon materials with desirable properties. As such, the holding time may be selected in view of the other parameters in a specific embodiment. For example, in one specific embodiment, a relatively long reaction time (e.g., 6 hours) and high reaction temperature (e.g., 85° C.) may warrant a relatively short holding time (e.g., greater than about 0 hours to about 1 hour).

Accordingly, in some embodiments, the holding time ranges from greater than about 0 hours to about 120 hours, greater than about 0 hours to about 110 hours, greater than about 0 hours to about 100 hours, greater than about 0 hours to about 90 hours, greater than about 0 hours to about 72 hours, greater than about 0 hours to about 60 hours, greater than about 0 hours to about 48 hours, greater than about 0 hours to about 36 hours, greater than about 0 hours to about 24 hours, greater than about 0 hours to about 12 hours, greater than about 0 hours to about 10 hours, greater than about 0 hours to about 8 hours, greater than about 0 hours to about 6 hours, greater than about 0 hours to about 5 hours, greater than about 0 hours to about 4 hours, greater than about 0 hours to about 3 hours, greater than about 0 hours to about 2 hours, greater than about 0 hours to about 1 hour, greater than about 1 hours to about 120 hours, greater than about 2 hours to about 120 hours, greater than about 3 hours to about 120 hours, greater than about 4 hours to about 120 hours, greater than about 4 hours to about 120 hours, greater than about 5 hours to about 120 hours, greater than about 6 hours to about 120 hours, greater than about 8 hours to about 120 hours, greater than about 10 hours to about 120 hours, greater than about 12 hours to about 120 hours, greater than about 24 hours to about 120 hours, greater than about 36 hours to about 120 hours, greater than about 48 hours to about 120 hours, greater than about 60 hours to about 120 hours, greater than about 72 hours to about 120 hours or greater than about 90 hours to about 120 hours.

In some more specific embodiments, the reaction time ranges from greater than about 0 minutes to about 240 minutes and the holding time ranges from greater than about 0 hours to about 240 hours. In other embodiments, the reaction time ranges from greater than about 0 minutes to about 120 minutes and the holding time ranges from greater than about 0 hours to about 90 hours. In some embodiments, the reaction time ranges from greater than about 10 minutes to about 180 minutes and the holding time ranges from greater than about 2 hours to about 12 hours. In other embodiments, the reaction time ranges from greater than about 30 minutes to about 180 minutes and the holding time ranges from greater than about 2 hours to about 8 hours.

In some embodiments, the holding time ranges from greater than about 0 hours to about 120 hours. In more specific embodiments, the holding time ranges from greater than about 0 hours to about 40 hours. In some embodiments, the holding time ranges from greater than about 0 hours to about 3 hours. In some embodiments, the holding time ranges from greater than about 0 hours to about 1 month.

In certain embodiments, the holding temperature ranges from about 15° C. to about 120° C. In other embodiments, the holding temperature ranges from about 20° C. to about 80° C.

Yet another embodiment provides a method comprising:

a) combining a solvent, a catalyst, a first monomer and a second monomer to yield a reaction mixture;

b) holding the reaction mixture at a holding temperature sufficient to co-polymerize the first and second monomer to yield a resin mixture;

c) heating the resin mixture by increasing an initial temperature at a curing ramp rate of at least 0.5° C./hour up to a curing temperature, thereby forming a polymer composition comprising the solvent and a polymer formed from co-polymerizing the first and second monomer; and

d) pyrolyzing the polymer composition at a pyrolysis temperature thereby substantially removing the solvent and pyrolyzing the polymer to yield a carbon material.

One embodiment provides a method comprising:

a) combining a solvent, a catalyst, a first monomer and a second monomer to yield a reaction mixture;

b) optionally holding the reaction mixture at a holding temperature sufficient to co-polymerize the first and second monomer to yield a polymer composition;

c) heating the composition by increasing an initial temperature at a curing ramp rate of at least 0.5° C./hour up to a curing temperature, thereby forming a cured polymer composition comprising the solvent and a polymer formed from co-polymerizing the first and second monomer.

In some embodiments, the method further comprises holding the reaction mixture at a holding temperature sufficient to co-polymerize the first and second monomer to yield a polymer composition. In some embodiments, the method further comprises increasing the temperature of the reaction mixture at a holding ramp rate. In some more specific embodiments, the method further comprises pyrolyzing the cured polymer composition at a pyrolysis temperature thereby substantially removing the solvent and pyrolyzing the polymer to yield a carbon material. In still other embodiments, the method further comprises heating the polymer composition at a curing temperature, thereby forming a cured polymer composition comprising the solvent and a polymer formed from co-polymerizing the first and second monomer.

In some embodiments, the curing ramp rate is greater than about 0.5° C./hour. In other embodiments, the curing ramp rate is greater than about 110° C./hour. In other embodiments, the curing ramp rate is greater than about 0.75° C./hour, greater than about 0.9° C./hour, greater than about 1° C./hour, greater than about 2° C./hour, greater than about 3° C./hour, greater than about 4° C./hour, greater than about 5° C./hour, greater than about 10° C./hour, greater than about 15° C./hour, greater than about 20° C./hour, greater than about 25° C./hour, greater than about 30° C./hour, greater than about 35° C./hour, greater than about 40° C./hour, greater than about 45° C./hour, greater than about 50° C./hour, greater than about 55° C./hour, greater than about 60° C./hour, greater than about 65° C./hour, greater than about 70° C./hour, greater than about 75° C./hour, greater than about 80° C./hour, or greater than about 100° C./hour.

In some embodiments, the initial temperature ranges from about 15° C. to about 30° C. For example, in some embodiments, the initial temperature is 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 37° C., 38° C., 39° C. or 40° C.

Additionally, the curing ramp rate is a parameter that affects the final composition of the carbon material. As such, the curing ramp rate is selected in view of the other parameters used in the disclosed methods. In some embodiments, the curing ramp rate ranges from greater than about 0.1° C./hour to about 200° C./hour, greater than about 0.5° C./hour to about 150° C./hour, greater than about 1° C./hour to about 120° C./hour, greater than about 3° C./hour to about 120° C./hour, greater than about 5° C./hour to about 120° C./hour, greater than about 10° C./hour to about 120° C./hour, greater than about 25° C./hour to about 200° C./hour, greater than about 40° C./hour to about 200° C./hour, greater than about 50° C./hour to about 200° C./hour, greater than about 60° C./hour to about 200° C./hour, greater than about 70° C./hour to about 200° C./hour, greater than about 80° C./hour to about 200° C./hour, greater than about 90° C./hour to about 200° C./hour, greater than about 100° C./hour to about 200° C./hour, greater than about 100° C./hour to about 190° C./hour, greater than about 100° C./hour to about 180° C./hour, greater than about 100° C./hour to about 170° C./hour, greater than about 100° C./hour to about 160° C./hour, greater than about 100° C./hour to about 150° C./hour, greater than about 100° C./hour to about 140° C./hour, greater than about 100° C./hour to about 130° C./hour, greater than about 100° C./hour to about 120° C./hour or greater than about 100° C./hour to about 110° C./hour.

In some embodiments, the holding ramp rate is a parameter that affects the final composition of the polymer and/or carbon material. The holding ramp rate is selected in view of the other parameters used in the disclosed methods. In some embodiments, the holding ramp rate ranges from greater than about 0.1° C./hour to about 200° C./hour, greater than about 0.5° C./hour to about 150° C./hour, greater than about 1° C./hour to about 120° C./hour, greater than about 3° C./hour to about 120° C./hour, greater than about 5° C./hour to about 120° C./hour, greater than about 10° C./hour to about 120° C./hour, greater than about 25° C./hour to about 200° C./hour, greater than about 40° C./hour to about 200° C./hour, greater than about 50° C./hour to about 200° C./hour, greater than about 60° C./hour to about 200° C./hour, greater than about 70° C./hour to about 200° C./hour, greater than about 80° C./hour to about 200° C./hour, greater than about 90° C./hour to about 200° C./hour, greater than about 100° C./hour to about 200° C./hour, greater than about 100° C./hour to about 190° C./hour, greater than about 100° C./hour to about 180° C./hour, greater than about 100° C./hour to about 170° C./hour, greater than about 100° C./hour to about 160° C./hour, greater than about 100° C./hour to about 150° C./hour, greater than about 100° C./hour to about 140° C./hour, greater than about 100° C./hour to about 130° C./hour, greater than about 100° C./hour to about 120° C./hour or greater than about 100° C./hour to about 110° C./hour.

In some more specific embodiments, the holding ramp rate is greater than about 3° C./hour. In some embodiments, the holding ramp rate is greater than about 10° C./hour. In some specific embodiments, the holding ramp rate is greater than about 100° C./hour.

In some embodiments, the temperatures and ramp rates are determined using a internal measuring device (e.g., a thermometer or thermocouple). As such, in some embodiments, the temperature and/or ramp rate is determined using an internal temperature reading (i.e., by determining an internal temperature of the reaction mixture, the resin mixture, polymer composition, and/or the cured polymer composition). Accordingly, in some embodiments, the holding ramp rate is determined from an internal temperature reading within the reaction mixture (e.g., via thermocouple). In some other embodiments, the holding temperature is determined from an internal temperature reading within the reaction mixture (e.g., via thermocouple). In certain embodiments, the curing temperature is determined from an internal temperature reading within the resin mixture (e.g., via thermocouple). In certain embodiments, the curing temperature is determined from an internal temperature reading within the polymer composition (e.g., via thermocouple). In some embodiments, the pyrolysis temperature is determined from an internal temperature reading within the cured polymer composition (e.g., via thermocouple).

Advantageously, embodiments of the method disclosed herein can be modified to yield carbon materials that comprise a high surface area, high porosity and/or low levels of undesirable impurities. In some embodiments, the methods further comprise activation of the carbon material following pyrolysis. Embodiments of the present methods provide significant flexibility such that an electrochemical modifier can be incorporated at any number of steps. In other embodiments, a second carbon material or materials from other sources (e.g., carbon nanotubes, carbon fibers, etc.) can be impregnated with an electrochemical modifier and combined with carbon material prepared by the methods disclosed herein. In one embodiment, the method further comprises combining the carbon material with an electrochemical modifier. Details of the variable process parameters of the various embodiments of the disclosed methods are described below.

Another parameter the affects the final carbon material composition and characteristics is the curing temperature. In certain embodiments, the curing temperature ranges from about 80° C. to about 300° C. In some more specific embodiments, the curing temperature is greater than about 50° C., greater than about 55° C., greater than about 60° C., greater than about 65° C., greater than about 70° C., greater than about 75° C., greater than about 80° C., greater than about 85° C., greater than about 90° C., greater than about 95° C., greater than about 100° C., greater than about 105° C., greater than about 110° C., greater than about 120° C., greater than about 130° C., greater than about 135° C., greater than about 140° C., greater than about 150° C., greater than about 160° C., greater than about 170° C., greater than about 180° C., greater than about 190° C., greater than about 200° C., greater than about 250° C. or greater than about 300° C.

In some embodiments, the curing temperature ranges from about 70° C. to about 200° C., from about 80° C. to about 150° C., from about 80° C. to about 120° C. or from about 80° C. to about 110° C.

In certain embodiments, the curing temperature ranges from greater than about 50° C. to about 500° C., greater than about 60° C. to about 500° C., greater than about 70° C. to about 500° C., greater than about 80° C. to about 500° C., greater than about 90° C. to about 500° C., greater than about 95° C. to about 500° C., greater than about 100° C. to about 500° C., greater than about 120° C. to about 500° C., greater than about 150° C. to about 500° C., greater than about 180° C. to about 500° C., greater than about 80° C. to about 400° C., greater than about 80° C. to about 300° C., greater than about 80° C. to about 200° C., greater than about 80° C. to about 150° C., greater than about 80° C. to about 120° C., greater than about 85° C. to about 115° C., greater than about 85° C. to about 110° C., greater than about 85° C. to about 105° C. or greater than about 85° C. to about 100° C.

In some specific embodiments, the curing ramp rate is greater than about 3° C./hour and the curing temperature ranges from greater than about 50° C. to about 500° C. In some embodiments, the curing ramp rate is greater than about 10° C./hour and the curing temperature ranges from greater than about 75° C. to about 150° C. In another embodiment, the curing ramp rate is greater than about 80° C./hour and the curing temperature ranges from greater than about 75° C. to about 150° C. In another embodiment, the curing ramp rate is greater than about 100° C./hour and the curing temperature ranges from greater than about 75° C. to about 150° C.

In some embodiments, the curing temperature is maintained for time period ranging from greater than about 0 hours to about 96 hours. For example, in some embodiments, the curing temperature is maintained for a time period ranging from greater than about 0 hours to about 48 hours, greater than about 0 hours to about 24 hours. In some embodiments, the curing temperature is maintained for a time period ranging from greater than about 0 hours to about 480 hours, greater than about 0 hours to about 240 hours, greater than about 0 hours to about 120 hours, greater than about 0 hours to about 90 hours, greater than about 0 hours to about 84 hours, greater than about 0 hours to about 72 hours, greater than about 0 hours to about 60 hours, greater than about 0 hours to about 36 hours, greater than about 0 hours to about 22 hours, greater than about 0 hours to about 20 hours, greater than about 0 hours to about 18 hours, greater than about 0 hours to about 16 hours, greater than about 0 hours to about 14 hours, greater than about 0 hours to about 12 hours, greater than about 0 hours to about 10 hours, greater than about 0 hours to about 8 hours, greater than about 0 hours to about 7 hours, greater than about 0 hours to about 6 hours, greater than about 0 hours to about 5 hours, greater than about 0 hours to about 4 hours, greater than about 0 hours to about 3 hours, greater than about 0 hours to about 2 hours, greater than about 0 hours to about 1 hours, greater than about 0 hours to about 0.5 hours, greater than about 0.5 hours to about 480 hours, greater than about 1 hours to about 480 hours, greater than about 2 hours to about 480 hours, greater than about 3 hours to about 480 hours, greater than about 4 hours to about 480 hours, greater than about 5 hours to about 480 hours, greater than about 6 hours to about 480 hours, greater than about 7 hours to about 480 hours, greater than about 8 hours to about 480 hours, greater than about 10 hours to about 480 hours, greater than about 12 hours to about 480 hours, greater than about 14 hours to about 480 hours, greater than about 16 hours to about 480 hours, greater than about 18 hours to about 480 hours, greater than about 20 hours to about 480 hours, greater than about 22 hours to about 480 hours, greater than about 24 hours to about 480 hours, greater than about 36 hours to about 480 hours, greater than about 48 hours to about 480 hours, greater than about 60 hours to about 480 hours, greater than about 72 hours to about 480 hours, greater than about 84 hours to about 480 hours, greater than about 96 hours to about 480 hours or greater than about 120 hours to about 480 hours.

In some embodiments, the curing temperature is maintained for a time period greater than about 0 hours, greater than about 0.5 hours, greater than about 0.75 hours, greater than about 1 hour, greater than about 1.5 hours, greater than about 1.75 hours, greater than about 2 hours, greater than about 3 hours, greater than about 4 hours, greater than about 5 hours, greater than about 6 hours, greater than about 7 hours, greater than about 8 hours, greater than about 9 hours, greater than about 10 hours, greater than about 11 hours, greater than about 12 hours, greater than about 14 hours, greater than about 16 hours, greater than about 18 hours, greater than about 20 hours, greater than about 22 hours, greater than about 24 hours, greater than about 26 hours, greater than about 28 hours, greater than about 30 hours, greater than about 36 hours, greater than about 48 hours, greater than about 60 hours, greater than about 72 hours, greater than about 84 hours, greater than about 96 hours, greater than about 120 hours, greater than about 240 hours or greater than about 480 hours.

In some embodiments, the resin mixture is under ambient atmosphere during the heating. In some embodiments, the method does not include a drying step prior to pyrolyzing. In some more specific embodiments, the drying step comprises freeze drying, super critical drying or combinations thereof. In some embodiments, the drying step comprises evaporation.

In some embodiments, the polymer composition is under ambient atmosphere during the heating. In some embodiments, the method does not include a drying step prior to pyrolyzing. In some more specific embodiments, the drying step comprises freeze drying, super critical drying or combinations thereof. In some embodiments, the drying step comprises evaporation.

In certain embodiments, the carbon materials are prepared by a modified sol gel process. For example, in some embodiments a cured polymer composition can be prepared by combining one or more monomers in an appropriate solvent to provide a cured polymer composition comprising the solvent (e.g., water). In one embodiment, the cured polymer composition is synthesized under acidic conditions. In another embodiment, the cured polymer composition is synthesized under basic conditions.

In certain embodiments, the carbon materials are prepared by a modified sol gel process. For example, in some embodiments a polymer composition can be prepared by combining one or more monomers in an appropriate solvent to provide a polymer composition comprising the solvent (e.g., water). In one embodiment, the polymer composition is synthesized under acidic conditions. In another embodiment, the polymer composition is synthesized under basic conditions.

In some embodiments, a first monomer is a phenolic compound. In some embodiments, the second monomer is an aldehyde compound. In one embodiment, the phenolic compound is phenol, resorcinol, catechol, hydroquinone, phloroglucinol, or a combination thereof. In some embodiments, the aldehyde compound is formaldehyde, acetaldehyde, propionaldehyde, butyraldehyde, benzaldehyde, cinnamaldehyde, or a combination thereof. In a further embodiment, the phenolic compound is resorcinol, phenol or a combination thereof, and the aldehyde compound is formaldehyde. In further embodiments, the phenolic compound is resorcinol and the aldehyde compound is formaldehyde.

In some embodiments, the first monomer is resorcinol. In some embodiments, the first monomer a combination of phenol and resorcinol. In some embodiments, the second monomer comprises formaldehyde, paraformaldehyde, butyradehyde or combinations thereof. In some embodiments, the second monomer is formaldehyde.

In some specific embodiments, the phenolic compound has the following structure:

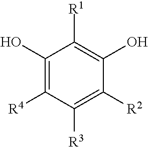

wherein:

R¹, R², R³ and R⁴ are each, independently, H, hydroxyl, halo, nitro, acyl, carboxy, alkylcarbonyl, arylcarbonyl, C₁₋₆ alkyl, C₁₋₆ alkenyl, methacrylate, acrylate, silyl ether, siloxane, aralkyl or alkaryl, wherein at least two of R¹, R² and R⁴ are H.

In certain embodiments, the molar ratio of catalyst to the first monomer (e.g., a phenolic compound) may have an effect on the final properties of the polymer composition as well as the final properties of the carbon materials. Thus, in some embodiments such catalysts are used in the range of molar ratios of 5:1 to 2000:1 phenolic compound:catalyst. In some embodiments, such catalysts can be used in the range of molar ratios of 20:1 to 200:1 phenolic compound:catalyst. For example in other embodiments, such catalysts can be used in the range of molar ratios of 5:1 to 100:1 phenolic compound:catalyst.

In the specific embodiment wherein the first monomer is resorcinol and the second monomer is formaldehyde, the holding temperature can range from about 20° C. to about 100° C., typically from about 25° C. to about 90° C. In some embodiments, holding temperature can be accomplished by incubation of suitable monomers in the presence of a catalyst for at least 24 hours at about 90° C. Generally co-polymerization can be accomplished with a holding time between about 6 and about 24 hours at about 90° C., for example between about 18 and about 24 hours at about 90° C.

The monomers as disclosed herein include (a) alcohols, phenolic compounds, and other mono- or polyhydroxy compounds (e.g., the first monomer) and (b) aldehydes, ketones, and combinations thereof (e.g., the second monomer). Representative alcohols in this context include straight chain and branched, saturated and unsaturated alcohols. Suitable phenolic compounds include polyhydroxy benzene, such as a dihydroxy or trihydroxy benzene. Representative polyhydroxy benzenes include resorcinol (i.e., 1,3-dihydroxy benzene), catechol, hydroquinone, and phloroglucinol. Mixtures of two or more polyhydroxy benzenes can also be used. Phenol (monohydroxy benzene) can also be used. Representative polyhydroxy compounds include sugars, such as glucose, and other polyols, such as mannitol. Aldehydes in this context include: straight chain saturated aldehydes such as methanal (formaldehyde), ethanal (acetaldehyde), propanal (propionaldehyde), butanal (butyraldehyde), and the like; straight chain unsaturated aldehydes such as ethenone and other ketenes, 2-propenal (acrylaldehyde), 2-butenal (crotonaldehyde), 3 butenal, and the like; branched saturated and unsaturated aldehydes; and aromatic-type aldehydes such as benzaldehyde, salicylaldehyde, hydrocinnamaldehyde, and the like. Suitable ketones include: straight chain saturated ketones such as propanone and 2-butanone, and the like; straight chain unsaturated ketones such as propenone, 2-butenone, and 3-butenone (methyl vinyl ketone) and the like; branched saturated and unsaturated ketones; and aromatic-type ketones such as methyl benzyl ketone (phenylacetone), ethyl benzyl ketone, and the like. The first and second monomer can also be combinations of the monomers described above.

In some embodiments, the first monomer is an alcohol-containing species and the second monomer is a carbonyl-containing species. The relative amounts of alcohol-containing species (e.g., alcohols, phenolic compounds and mono- or poly-hydroxy compounds or combinations thereof) reacted with the carbonyl containing species (e.g., aldehydes, ketones or combinations thereof) can vary substantially. In some embodiments, the ratio of alcohol-containing species to aldehyde species is selected so that the total moles of reactive alcohol groups in the alcohol-containing species is approximately the same as the total moles of reactive carbonyl groups in the aldehyde species. Similarly, the ratio of alcohol-containing species to ketone species may be selected so that the total moles of reactive alcohol groups in the alcohol containing species is approximately the same as the total moles of reactive carbonyl groups in the ketone species. The same general 1:1 molar ratio holds true when the carbonyl-containing species comprises a combination of an aldehyde species and a ketone species.

In some embodiments, the molar ratio is varied. For example, in some embodiments, the reaction mixture comprises a ratio of first monomer to second monomer that is greater than about 1:1. For example, in some specific embodiments, the reaction mixture comprises a reaction mixture comprises a ratio of first monomer to second monomer that is greater than about 1.09:1. In some embodiments, the reaction mixture comprises a reaction mixture comprises a ratio of first monomer to second monomer that is about 1.2:1. In some specific embodiments, the ratio of first monomer to second monomer ranges from about 1:1 to about 3:1. In some embodiments, ratio of first monomer to second monomer ranges from about 1:1 to about 2:1. In some embodiments, ratio of first monomer to second monomer is greater than about 1.01:1, greater than about 1.02:1, greater than about 1.03:1, greater than about 1.04:1, greater than about 1.05:1, greater than about 1.06:1, greater than about 1.07:1, greater than about 1.08:1, greater than about 1.10:1, greater than about 1.11:1, greater than about 1.12:1, greater than about 1.13:1, greater than about 1.14:1, greater than about 1.15:1, greater than about 1.16:1, greater than about 1.17:1, greater than about 1.18:1, greater than about 1.19:1, or greater than about 1.20:1.

In some embodiments, the reaction mixture comprises a reaction mixture comprises a ratio of first monomer to second monomer that is about 1.6:1. In some specific embodiments, the ratio of first monomer to second monomer ranges from about 1:1 to about 3:1. In some embodiments, ratio of first monomer to second monomer ranges from about 1:1 to about 2:1. In some embodiments, ratio of first monomer to second monomer is greater than about 1.1:1, greater than about 1.2:1, greater than about 1.3:1, greater than about 1.4:1, greater than about 1.45:1, greater than about 1.50:1, greater than about 1.55:1, greater than about 1.6:1.

In some embodiments, the ratio of first monomer to second monomer ranges from about 1:1 to about 2:1, from about 1.4:1 to about 2:1, from about 1.3:1 to about 2:1, from about 1.4:1 to about 2:1, from about 1.5:1 to about 2:1, from about 1.5:1 to about 1.9:1, from about 1.5:1 to about 1.8:1, from about 1.4:1 to about 1.9:1, from about 1.4:1 to about 1.8:1, or from about 1.5:1 to about 1.7:1,

The monomer concentration affects the reaction kinetics, the degree of heat generated by the reaction as well as the polymer and/or final carbon material composition. The monomer concentration can be selected to meet the needs of a desired process or final product. In addition, the monomer concentration can vary greatly as it may change based on other selected method parameters.

Accordingly, in certain embodiments, the concentration of the first monomer is greater than about 0% and less than about 99% of the reaction mixture measured as weight/weight, volume/volume or weight/volume. In more specific embodiments, the concentration of the first monomer is greater than about 0.1%, greater than about 0.5%, greater than about 1.0%, greater than about 2.0%, greater than about 5.0%, greater than about 10.0%, greater than about 15.0%, greater than about 20.0%, greater than about 25.0%, greater than about 30.0%, greater than about 32.5%, greater than about 35.0%, greater than about 37.5%, greater than about 40.0%, greater than about 42.5%, greater than about 45.0%, greater than about 47.5%, greater than about 50.0%, greater than about 52.5%, greater than about 55.0%, greater than about 57.5%, greater than about 60.0%, greater than about 65.0%, greater than about 67.5%, greater than about 70.0%, greater than about 75.0%, greater than about 80.0%, greater than about 85.0%, greater than about 90.0% or greater than about 95.0% of the reaction mixture measured as weight/weight, volume/volume or weight/volume.

In some more specific embodiments, the concentration of the first monomer ranges from greater than about 0 wt. % to 99 wt. %, greater than about 5 wt. % to 99 wt. %, greater than about 10 wt. % to 99 wt. %, greater than about 15 wt. % to 99 wt. %, greater than about 20 wt. % to 99 wt. %, greater than about 25 wt. % to 99 wt. %, greater than about 30 wt. % to 99 wt. %, greater than about 35 wt. % to 99 wt. %, greater than about 40 wt. % to 99 wt. %, greater than about 45 wt. % to 99 wt. %, greater than about 50 wt. % to 99 wt. %, greater than about 55 wt. % to 99 wt. %, greater than about 60 wt. % to 99 wt. %, greater than about 65 wt. % to 99 wt. %, greater than about 70 wt. % to 99 wt. %, greater than about 75 wt. % to 99 wt. %, greater than about 80 wt. % to 99 wt. %, greater than about 85 wt. % to 99 wt. %, greater than about 90 wt. % to 99 wt. %, greater than about 0 wt. % to 95 wt. %, greater than about 0 wt. % to 90 wt. %, greater than about 0 wt. % to 85 wt. %, greater than about 0 wt. % to 80 wt. %, greater than about 0 wt. % to 75 wt. %, greater than about 0 wt. % to 70 wt. %, greater than about 0 wt. % to 65 wt. %, greater than about 0 wt. % to 60 wt. %, greater than about 0 wt. % to 55 wt. %, greater than about 0 wt. % to 50 wt. %, greater than about 0 wt. % to 45 wt. %, greater than about 0 wt. % to 40 wt. %, greater than about 0 wt. % to 35 wt. %, greater than about 0 wt. % to 30 wt. %, greater than about 0 wt. % to 25 wt. %, greater than about 0 wt. % to 20 wt. %, greater than about 0 wt. % to 15 wt. %, greater than about 0 wt. % to 10 wt. %, greater than about 0 wt. % to 5 wt. %, greater than about 0 wt. % to 2.5 wt. % or greater than about 0 wt. % to 1 wt. % of the reaction mixture.

In certain embodiments, the concentration of the second monomer is greater than about 0% and less than about 99% of the reaction mixture measured as weight/weight, volume/volume or weight/volume. In more specific embodiments, the concentration of the first monomer is greater than about 0.1%, greater than about 0.5%, greater than about 1.0%, greater than about 2.0%, greater than about 5.0%, greater than about 10.0%, greater than about 15.0%, greater than about 20.0%, greater than about 25.0%, greater than about 30.0%, greater than about 32.5%, greater than about 35.0%, greater than about 37.5%, greater than about 40.0%, greater than about 42.5%, greater than about 45.0%, greater than about 47.5%, greater than about 50.0%, greater than about 52.5%, greater than about 55.0%, greater than about 57.5%, greater than about 60.0%, greater than about 65.0%, greater than about 67.5%, greater than about 70.0%, greater than about 75.0%, greater than about 80.0%, greater than about 85.0%, greater than about 90.0% or greater than about 95.0% of the reaction mixture measured as weight/weight, volume/volume or weight/volume.

In some more specific embodiments, the concentration of the second monomer ranges from greater than about 0 wt. % to 99 wt. %, greater than about 5 wt. % to 99 wt. %, greater than about 10 wt. % to 99 wt. %, greater than about 15 wt. % to 99 wt. %, greater than about 20 wt. % to 99 wt. %, greater than about 25 wt. % to 99 wt. %, greater than about 30 wt. % to 99 wt. %, greater than about 35 wt. % to 99 wt. %, greater than about 40 wt. % to 99 wt. %, greater than about 45 wt. % to 99 wt. %, greater than about 50 wt. % to 99 wt. %, greater than about 55 wt. % to 99 wt. %, greater than about 60 wt. % to 99 wt. %, greater than about 65 wt. % to 99 wt. %, greater than about 70 wt. % to 99 wt. %, greater than about 75 wt. % to 99 wt. %, greater than about 80 wt. % to 99 wt. %, greater than about 85 wt. % to 99 wt. %, greater than about 90 wt. % to 99 wt. %, greater than about 0 wt. % to 95 wt. %, greater than about 0 wt. % to 90 wt. %, greater than about 0 wt. % to 85 wt. %, greater than about 0 wt. % to 80 wt. %, greater than about 0 wt. % to 75 wt. %, greater than about 0 wt. % to 70 wt. %, greater than about 0 wt. % to 65 wt. %, greater than about 0 wt. % to 60 wt. %, greater than about 0 wt. % to 55 wt. %, greater than about 0 wt. % to 50 wt. %, greater than about 0 wt. % to 45 wt. %, greater than about 0 wt. % to 40 wt. %, greater than about 0 wt. % to 35 wt. %, greater than about 0 wt. % to 30 wt. %, greater than about 0 wt. % to 25 wt. %, greater than about 0 wt. % to 20 wt. %, greater than about 0 wt. % to 15 wt. %, greater than about 0 wt. % to 10 wt. %, greater than about 0 wt. % to 5 wt. %, greater than about 0 wt. % to 2.5 wt. % or greater than about 0 wt. % to 1 wt. % of the reaction mixture.

In some more specific embodiments, the concentration of the first monomer ranges from about 10.0 wt % to about 50.0 wt. % and the concentration of the second monomer ranges from about 5.0 wt % to about 50.0 wt. % of the reaction mixture. In another embodiment, the concentration of the first monomer ranges from about 10.0 wt % to about 50.0 wt. % and the concentration of the second monomer ranges from about 5.0 wt % to about 35.0 wt. % of the reaction mixture. In another more specific embodiment, the concentration of the first monomer ranges from about 15.0 wt % to about 40.0 wt. % and the concentration of the second monomer ranges from about 10.0 wt % to about 25.0 wt. % of the reaction mixture. In one specific embodiment, the concentration of the first monomer ranges from about 25.0 wt % to about 35.0 wt. % and the concentration of the second monomer ranges from about 10.0 wt % to about 20.0 wt. % of the reaction mixture.

The total solids content in the reaction mixture, the resin mixture, the polymer composition, and/or the cured polymer composition can be varied. In some embodiments, the weight ratio of solids (e.g., resorcinol) to liquid (e.g., solvent) in the reaction mixture ranges from about 0.05 to 1 to about 0.70 to 1, from about 0.15 to 1 to about 0.6 to 1, from about 0.15 to 1 to about 0.35 to 1, from about 0.25 to 1 to about 0.5 to 1, from about 0.3 to 1 to about 0.4 to 1, from about 1 to 1 to about 4 to 1, from about 1 to 1 to about 3 to 1, from about 1 to 1 to about 2 to 1, from about 1.1 to 1 to about 3 to 1, from about 1.2 to 1 to about 3 to 1, from about 1.4 to 1 to about 2 to 1, from about 1.3 to 1 to about 2 to 1, from about 1.4 to 1 to about 3 to 1, from about 1.5 to 1 to about 2 to 1, from about 1.5 to 1 to about 3 to 1, from about 1.5 to 1 to about 2.5 to 1, or from about 1.5 to 1 to about 4 to 1.

In some other embodiments of the foregoing, the solvent is acidic. For example, in certain embodiments the solvent comprises acetic acid. For example, in one embodiment, the solvent is 100% acetic acid. Some embodiments of the disclosed method comprise a solvent exchange step (e.g., exchange t-butanol for water).

In some embodiments, the weight ratio of solids to liquid (e.g., solvent) in the polymer composition ranges from about 0.05 to 1 to about 0.70 to 1, from about 0.15 to 1 to about 0.6 to 1, from about 0.15 to 1 to about 0.35 to 1, from about 0.25 to 1 to about 0.5 to 1 or from about 0.3 to 1 to about 0.4 to 1.

Examples of solvents useful in the preparation of the carbon materials disclosed herein include but are not limited to water or alcohols such as, for example, ethanol, t butanol, methanol or combinations thereof as well as aqueous mixtures of the same. Such solvents are useful for dissolution of the monomers, for example dissolution of the phenolic compound. In addition, in some processes such solvents are employed for solvent exchange in the polymer composition (prior to pyrolysis), wherein the solvent from the reaction mixture or polymer composition, for example, water and acetic acid, is exchanged for a pure alcohol.

Suitable catalysts in the preparation of the carbon materials include volatile basic catalysts that facilitate co-polymerization of the polymer composition into a cured polymer composition. The catalyst can also comprise various combinations of the catalysts described above. In embodiments comprising phenolic compounds, such catalysts can be used in the range of molar ratios of 5:1 to 200:1, 10:1 to 150:1, 15:1 to 100:1, 20:1 to 90:1, 25:1 to 150:1, 30:1 to 120:1 or 40:1 to 110:1 phenolic compound:catalyst. For example, in some specific embodiments such catalysts can be used in the range of molar ratios of 25:1 to 100:1 phenolic compound: catalyst.

In certain embodiments, the catalyst is basic. In more specific embodiments, the catalyst comprises ammonium acetate. In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

The reaction solvent is another process parameter that may be varied to obtain the desired properties (e.g., surface area, porosity, purity, etc.) of the cured polymer composition and carbon materials. In some embodiments, the solvent is a mixed solvent system of water and a miscible co-solvent. For example, in certain embodiments the solvent comprises water and a miscible acid. In a more specific embodiment, the miscible acid is acetic acid. Other examples of water miscible acids include, but are not limited to, propionic acid and formic acid. In further embodiments, the solvent comprises a ratio of water-miscible acid to water of 99:1, 90:10, 75:25, 50:50, 25:75, 10:90 or 1:90. In other embodiments, acidity is provided by adding a solid acid to the solvent.

In some embodiments, the reaction mixture further comprises methanol. In some more specific embodiments, the concentration of methanol ranges from greater than about 0.0 wt. % to about 5.0 wt. % of the reaction mixture.

Without wishing to be bound by theory, Applicants have discovered that a reaction vessel can have a significant impact as to how different parts of the method will proceed and thus, the quality of the different components (e.g., the reaction mixture, polymer composition, cured polymer composition, and/or the carbon materials). In particular, the “aspect ratio” or ratio of surface area to volume of a reaction vessel can be selected to improve characteristics of the desired product.

Accordingly, one embodiment provides a method comprising:

a) combining a solvent, a catalyst, a first monomer and a second monomer to yield a reaction mixture;

b) transferring the reaction mixture to a reaction vessel having a volume greater than 10 L and a surface area to volume aspect ratio greater than about 3 m²/m³;

c) increasing the temperature of the reaction mixture at a holding ramp rate and holding the reaction mixture for a holding time at a holding temperature sufficient to co-polymerize the first and second monomer to yield a polymer composition; and

d) optionally heating the polymer composition at a curing temperature, thereby forming a cured polymer composition comprising the solvent and a polymer formed from co-polymerizing the first and second monomer.

In some embodiments, the reaction vessel has a volume greater than about 50 L. In certain embodiments, the reaction vessel has a volume greater than about 75 L. In some embodiments, the reaction vessel has a volume greater than about 150 L. In certain embodiments, the reaction vessel has a volume greater than about 190 L. In some other embodiments, the reaction vessel has a volume greater than about 1900 L. In some specific embodiments, the reaction vessel has a volume greater than about 0.240 L, greater than about 0.500 L, greater than about 1 L, greater than about 5 L, greater than about 10 L, greater than about 20 L, greater than about 30 L, greater than about 40 L, greater than about 50 L, greater than about 60 L, greater than about 70 L, greater than about 80 L, greater than about 90 L, greater than about 100 L, greater than about 110 L, greater than about 120 L, greater than about 130 L, greater than about 140 L, greater than about 200 L, greater than about 250 L, greater than about 300 L, greater than about 350 L, greater than about 400 L, greater than about 450 L, greater than about 500 L, greater than about 600 L, greater than about 700 L, greater than about 800 L, greater than about 900 L, greater than about 1000 L, or greater than about 1500 L.

In some embodiments, the aspect ratio is greater than about 5 m²/m³. In some embodiments, the aspect ratio is greater than about 7.5 m²/m³. In some specific embodiments, the aspect ratio is greater than about 50 m²/m³. In certain embodiments, the aspect ratio is greater than about 100 m²/m³. In other embodiments, the aspect ratio is about 200 m²/m³.

In some embodiments, the holding is in a reaction vessel having a surface area to volume ratio (aspect ratio) ranging from 0.5 m²/m³ to about 15 m²/m³. In some embodiments, the surface area to volume ratio (the aspect ratio) ranges from about 0.1 m²/m³ to about 30 m²/m³, about 0.5 m²/m³to about 30 m²/m³, about 1 m²/m³ to about 30 m²/m³, about 5 m²/m³ to about 30 m²/m³, about 10 m²/m³ to about 30 m²/m³, about 11 m²/m³ to about 30 m²/m³, about 12 m²/m³ to about 30 m²/m³, about 13 m²/m³ to about 30 m²/m³, about 14 m²/m³ to about 30 m²/m³, about 15 m²/m³ to about 30 m²/m³, about 0.1 m²/m³ to about 25 m²/m³, about 0.1 m²/m³ to about 20 m²/m³, about 0.1 m²/m³ to about 19 m²/m³, about 0.1 m²/m³ to about 18 m²/m³, about 0.1 m²/m³ to about 17.5 m²/m³, about 0.1 m²/m³ to about 17 m²/m³, about 0.1 m²/m³ to about 16.5 m²/m³, about 0.1 m²/m³ to about 16 m²/m³, about 0.1 m²/m³ to about 15.5 m²/m³, about 0.1 m²/m³ to about 15 m²/m³, about 0.1 m²/m³ to about 14.5 m²/m³, about 0.1 m²/m³ to about 14 m²/m³, about 0.1 m²/m³ to about 13.5 m²/m³, about 0.1 m²/m³ to about 13 m²/m³, about 10 m²/m³ to about 15 m²/m³ or about 5 m²/m³ to about 15 m²/m³.

In some embodiments, the holding is in a reaction vessel having a surface area to volume ratio (aspect ratio) greater than 0.1 m²/m³, greater than 0.2 m²/m³, greater than 0.3 m²/m³, greater than 0.4 m²/m³, greater than 0.5 m²/m³, greater than 0.6 m²/m³, greater than 0.75 m²/m³, greater than 1 m²/m³, greater than 1.5 m²/m³, greater than 2 m²/m³, greater than 2.5 m²/m³, greater than 3 m²/m³, greater than 3.5 m²/m³, greater than 4 m²/m³, greater than 4.5 m²/m³, greater than 5 m²/m³, greater than 5.5 m²/m³, greater than 6 m²/m³, greater than 6.5 m²/m³, greater than 7 m²/m³, greater than 7.5 m²/m³, greater than 8 m²/m³, greater than 8.5 m²/m³, greater than 9 m²/m³, greater than 9.5 m²/m³, greater than 10 m²/m³, greater than 10.5 m²/m³, greater than 11 m²/m³, greater than 11.5 m²/m³, greater than 12 m²/m³, greater than 12.5 m²/m³, greater than 13 m²/m³, greater than 13.5 m²/m³, greater than 14 m²/m³, greater than 14.5 m²/m³, greater than 14.5 m²/m³, greater than 15, greater than 20 m²/m³, greater than 25 m²/m³, greater than 30 m²/m³, greater than 35 m²/m³, greater than 40 m²/m³, greater than 45 m²/m³, greater than 50 m²/m³, greater than 55 m²/m³, greater than 60 m²/m³, greater than 65 m²/m³, greater than 70 m²/m³, greater than 75 m²/m³, greater than 80 m²/m³, greater than 85 m²/m³, greater than 90 m²/m³, greater than 95 m²/m³, greater than 100 m²/m³, greater than 125 m²/m³, greater than 150 m²/m³, or greater than 175 m²/m³.

Advantageously, embodiments of the present invention can be carried out on a large scale amenable to the demands of manufacturing. For example, in some embodiments, large scale reaction vessels are used (e.g., ranging from 2,000 L to 20,000 L reactor). In certain embodiments, the reaction temperature ranges from 30° C. to 40° C. followed by cooling to 15° C. to 25° C. and decanting into 200 L drum for holding. In certain embodiments, the material is cooled by discharging heat through a flat plate heat exchanger. Variations of manufacture will be apparent to those of skill in the art and are contemplated as being within the scope of the present disclosure.

In some embodiments, the cured polymer composition comprises polymer particles. In some embodiments, the carbon material comprises carbon particles. In certain embodiments, the particles (i.e., either polymer particles or carbon particles) are rinsed with water. In one embodiment, the average diameter of the particles is less than 25 mm, for example, between 0.001 mm and 25 mm, between 0.01 mm and 15 mm, between 1.0 mm and 15 mm, between 0.05 mm and 25 mm, between 0.05 and 15 mm, between 0.5 and 25 mm, between 0.5 mm and 15 mm or between 1 mm and 10 mm.

Advantageously, embodiments of the present method do not require a drying step prior to pyrolysis, yet still provide carbon materials with desirable characteristics (e.g., porosity, purity, surface area, etc.). Specifically, in some embodiments the cured polymer composition is not frozen via immersion in a medium having a temperature of below about −10° C., for example, below about −20° C., or alternatively below about −30° C. For example, the medium may be liquid nitrogen or ethanol (or other organic solvent) in dry ice or ethanol cooled by another means. In some embodiments, the cured polymer composition is not dried under a vacuum pressure of below about 3000 mTorr, about 1000 mTorr, about 300 mTorr or about 100 mTorr.

Additionally, in some embodiments, the cured polymer composition is not rapidly frozen by co-mingling or physical mixing with a suitable cold solid, for example, dry ice (solid carbon dioxide). In another embodiment, the cured polymer composition is not contacted using a blast freezer with a metal plate at −60° C. to rapidly remove heat from the cured polymer composition (e.g., comprising polymer particles) scattered over its surface.

Another method of rapidly cooling water in a cured polymer composition is to snap freeze the particle by pulling a high vacuum very rapidly (the degree of vacuum is such that the temperature corresponding to the equilibrium vapor pressure allows for freezing). Yet another method for rapid freezing comprises ad-mixing a cured polymer composition with a suitably cold gas. In some embodiments, the cold gas may have a temperature below about −10° C. In some embodiments, the cold gas may have a temperature below about −20° C. In some embodiments, the cold gas may have a temperature below about −30° C. In yet other embodiments, the gas may have a temperature of about −196° C. For example, in some embodiments, the gas is nitrogen. In yet other embodiments, the gas may have a temperature of about −78° C. For example, in some embodiments, the gas is carbon dioxide. In some embodiments, the method does not include the snap freezing or ad-mixing the cured polymer composition with a suitable cold as described above.

In other embodiments, the cured polymer composition is not frozen on a lyophilizer shelf, for example, at a temperature of −20° C. or lower. For example, in some embodiments the cured polymer composition is not frozen on the lyophilizer shelf at a temperature of −30° C. or lower. In some other embodiments, the cured polymer composition is not subjected to a freeze thaw cycle (from room temperature to −20° C. or lower and back to room temperature), physical disruption of the freeze-thawed composition to create particles, and then further lyophilization processing. For example, in some embodiments, the cured polymer composition is not subjected to a freeze thaw cycle (from room temperature to −30° C. or lower and back to room temperature), physical disruption of the freeze-thawed composition to create particles, and then further lyophilization processing.

A monolithic cured polymer composition or carbon material can be physically disrupted to create smaller particles according to various techniques known in the art. The resultant cured polymer composition or carbon material particles generally have an average diameter of less than about 30 mm, less than about 25 mm, less than about 20 mm, less than about 15 mm, less than about 10 mm, less than about 9 mm, less than about 8 mm, less than about 7 mm, less than about 6 mm, less than about 5 mm, less than about 4 mm, less than about 3 mm, less than about 2 mm or less than about 1 mm. In some embodiments, in the particles size ranges from about 1 mm to about 25 mm, about 1 mm to about 5 mm, about 0.5 mm to about 10 mm.

Alternatively, in some embodiments, the size of the cured polymer composition or carbon material particles range from about 10 to 1000 microns, 10 to 500 microns, 10 to 400 microns, 10 to 300 microns, 10 to 200 microns, 10 to 100 microns, 100 to 1000 microns, 200 to 1000 microns, 300 to 1000 microns, 400 to 1000 microns or 500 to 1000 microns.

Techniques for creating cured polymer composition or carbon material particles from monolithic material include manual or machine disruption methods, such as sieving, grinding, milling, or combinations thereof. Such methods are well-known to those of skill in the art. Various types of mills can be employed in this context such as roller, bead, and ball mills and rotary crushers and similar particle creation equipment known in the art.

In a specific embodiment, a roller mill is employed. A roller mill has three stages to gradually reduce the size of the particles. The carbon materials are generally very brittle and are not damp to the touch. Consequently they are easily milled using this approach; however, the width of each stage must be set appropriately to achieve the targeted final mesh. This adjustment is made and validated for each combination of reaction recipe and mesh size. Each material is milled via passage through a sieve of known mesh size. Sieved particles can be temporarily stored in sealed containers.

In one embodiment, a rotary crusher is employed. The rotary crusher has a screen mesh size of about ⅛ inch. In another embodiment, the rotary crusher has a screen mesh size of about ⅜ inch. In another embodiment, the rotary crusher has a screen mesh size of about ⅝ inch.

Methods of preparing carbon materials previously known in the art typically include a process for drying the cured polymer composition before pyrolyzing. Advantageously, the present Applicants have discovered that selecting specific method parameters (e.g., reaction time/temperature, holding time/temperature, curing ramp rate, etc.) can yield a cured polymer composition that does not require any freezing and/or drying procedure prior to pyrolysis. Specifically, the present Applicants have discovered that reaction parameters can be selected to ensure carbon material with desirable characteristics (e.g., mesopore volume, pore distribution, high surface area) are produced but the need for costly drying procedures (e.g., freeze drying, super critical drying, oven drying, evaporative drying and the like) is eliminated.

Accordingly, in one embodiment, the cured polymer composition is not frozen or lyophilized and avoids collapse of the material and maintains fine surface structure and porosity in the carbon materials. Generally drying is accomplished during pyrolysis and the temperature of the cured polymer composition is never below a temperature that would freeze solvent (i.e., about 0° C.) yet the carbon materials retain an extremely high surface area and desirable pore characteristics.

Without wishing to be bound by theory, the structure of the final carbon material is thought to be reflected in the structure of the cured polymer composition which in turn is established by the polymer composition and reaction mixture as well as a function of the method parameters (e.g., temperatures and times used for various steps of the process). Advantageously, the present Applicants have discovered the features can be created without requiring any previously known polymer gel process (e.g., using a sol-gel processing approach) where care is required for removal of the solvent in order to preserve carbon material structures. Previously known methods required optimization to retain the original structure of the polymer gel and modify its structure with ice crystal formation based on control of the freezing process. In contrast, embodiments of the present invention provide a robust method for removing solvent by pyrolyzing a cured polymer composition to yield valuable carbon materials with a more direct approach (i.e., without freezing or drying prior to pyrolysis).

In certain embodiments, the cured polymer composition and/or carbon material is not placed in a lyophilizer chamber.

The cured polymer compositions described above can be further processed to obtain carbon materials. Such processing includes, for example, pyrolysis and/or activation. Generally, in the pyrolysis process, dried polymer gels are weighed and placed in a rotary kiln. In contrast, embodiments of the present disclosure allow a relatively wet cured polymer composition (e.g., comprising >5 wt. % solvent) to be pyrolyzed directly by placing the wet cured polymer composition in the rotary kiln.

In certain embodiments, the pyrolysis ramp rate is set at 5° C. per minute, a pyrolysis time and pyrolysis temperature are set and cool down is determined by the natural cooling rate of the furnace. In some embodiments, the cured polymer composition is under an inert atmosphere during the pyrolyzing. In other embodiments, the cured polymer composition is under ambient atmosphere during the pyrolyzing. Pyrolyzed carbon materials are then removed and weighed. Other pyrolysis processes are well known to those of skill in the art.

In some embodiments, the pyrolysis ramp rate is greater than 1° C. per minute, greater than 2° C. per minute, greater than 3° C. per minute, greater than 4° C. per minute, greater than 5° C. per minute, greater than 6° C. per minute, greater than 7° C. per minute, greater than 8° C. per minute, greater than 9° C. per minute, greater than 10° C. per minute, greater than 11° C. per minute, greater than 12° C. per minute, greater than 13° C. per minute, greater than 14° C. per minute, greater than 15° C. per minute, greater than 16° C. per minute, greater than 17° C. per minute, greater than 18° C. per minute, greater than 19° C. per minute, greater than 20° C. per minute or greater than 25° C. per minute.

Applicants have discovered that, in some embodiments, an inert atmosphere is not required for pyrolysis. Without wishing to be bound by theory, it is thought that parameters of embodiments of the methods disclosed herein result in carbon materials that do not require an inert atmosphere, yet still have optimal pore size, surface area and/or purity.

In some embodiments, pyrolysis time (the period of time during which the sample is at the pyrolysis temperature) is from about 0 minutes to about 120 minutes, from about 0 minutes to about 60 minutes, from about 0 minutes to about 30 minutes, from about 0 minutes to about 10 minutes, from about 0 to 5 minutes or from about 0 to 1 minute. In some embodiments, pyrolysis time is greater than 15 minutes, greater than 20 minutes, greater than 30 minutes, greater than 45 minutes, greater than 60 minutes, greater than 75 minutes, greater than 90 minutes, greater than 105 minutes, greater than 120 minutes, greater than 150 minutes, greater than 180 minutes, greater than 240 minutes, greater than 300 minutes, greater than 360 minutes or greater than 480 minutes.

In some embodiments, the pyrolyzing is carried out more slowly than described above. For example, in one embodiment the pyrolysis is carried out in about 120 to 480 minutes. In other embodiments, the pyrolysis is carried out in about 120 to 240 minutes.

In some embodiments, the pyrolysis temperature ranges from about 500° C. to 2400° C. In some embodiments, the pyrolysis temperature ranges from about 650° C. to 1800° C. In other embodiments, the pyrolysis temperature ranges from about 700° C. to about 1200° C., about 750° C. to about 1500° C. or about 850° C. to about 950° C. In other embodiments, the pyrolysis temperature ranges from about 850° C. to about 1050° C. In other embodiments, the pyrolysis temperature ranges from about 550° C. to about 2400° C. In other embodiments, the pyrolysis temperature ranges from about 600° C. to about 2400° C., from about 700° C. to about 2400° C., from about 800° C. to about 2400° C., from about 850° C. to about 2400° C., from about 890° C. to about 2400° C., from about 890° C. to about 2000° C., from about 890° C. to about 1900° C., from about 890° C. to about 1800° C., from about 890° C. to about 1600° C., from about 890° C. to about 1500° C., from about 890° C. to about 1300° C., from about 890° C. to about 1200° C., from about 890° C. to about 1100° C., from about 890° C. to about 1050° C., from about 890° C. to about 1000° C., from about 910° C. to about 1050° C., from about 920° C. to about 1050° C., from about 930° C. to about 1050° C., from about 940° C. to about 1050° C., from about 950° C. to about 1050° C., from about 960° C. to about 1050° C., from about 970° C. to about 1050° C., from about 980° C. to about 1050° C., from about 990° C. to about 1050° C. or from about 1000° C. to about 1050° C.

In some embodiments the pyrolysis temperature is greater than about 250° C. In some embodiments the pyrolysis temperature is greater than about 350° C. In some embodiments the pyrolysis temperature is greater than about 450° C. In some embodiments the pyrolysis temperature is greater than about 500° C. In some embodiments the pyrolysis temperature is greater than about 550° C. In some embodiments the pyrolysis temperature is greater than about 600° C. In some embodiments the pyrolysis temperature is greater than about 650° C. In some embodiments the pyrolysis temperature is greater than about 850° C. In some embodiments the pyrolysis temperature is greater than about 500° C., greater than about 550° C., greater than about 600° C., greater than about 650° C., greater than about 700° C., greater than about 750° C., greater than about 800° C., greater than about 850° C., greater than about 860° C., greater than about 870° C., greater than about 880° C., greater than about 890° C., greater than about 900° C., greater than about 910° C., greater than about 920° C., greater than about 930° C., greater than about 940° C., greater than about 950° C., greater than about 1000° C., greater than about 1050° C., greater than about 1100° C., greater than about 1150° C., greater than about 1200° C., greater than about 1250° C., greater than about 1300° C., greater than about 1350° C., greater than about 1400° C., greater than about 1450° C. or greater than about 1500° C.

In some embodiments, the pyrolysis temperature is varied during the course of the pyrolyzing. In one embodiment, the pyrolyzing is carried out in a rotary kiln with separate, distinct heating zones. In some more specific embodiments, the pyrolysis temperature for each zone is sequentially decreased from the entrance to the exit end of the rotary kiln tube. In one embodiment, the pyrolysis is carried out in a rotary kiln with separate distinct heating zones, and the temperature for each zone is sequentially increased from entrance to exit end of the rotary kiln tube.

Activation time and activation temperature both have a large impact on the performance of the resulting activated carbon material, as well as the manufacturing cost thereof. Increasing the activation temperature and the activation time results in higher activation percentages, which generally correspond to the removal of more material compared to lower activation temperatures and shorter activation times. Activation temperature can also alter the pore structure of the carbon where lower activation temperatures result in more microporous carbon and higher activation temperatures result in mesoporosity. This is a result of the activation gas diffusion limited reaction that occurs at higher activation temperatures and reaction kinetic driven reactions that occur at lower activation temperature. Higher activation percentage often increases performance of the final activated carbon, but it also increases cost by reducing overall yield. Improving the level of activation corresponds to achieving a higher performance product at a lower cost.

Accordingly, in some embodiments, the activation time is between 1 minute and 48 hours. In other embodiments, the activation time is between 1 minute and 24 hours. In other embodiments, the activation time is between 5 minutes and 24 hours. In other embodiments, the activation time is between 1 hour and 24 hours. In further embodiments, the activation time is between 12 hours and 24 hours. In certain other embodiments, the activation time is between 30 minutes and 4 hours. In some further embodiments, the activation time is between 1 hour and 2 hours.

In some embodiments, the activation time is greater than 0 minutes, 5 minutes, 10 minutes, 15 minutes, 20 minutes, 30 minutes, 40 minutes, 50 minutes, 1 hour, 90 minutes, 2 hours, 6 hours, 8 hours, 12 hours, 24 hours, 36 hours, 48 hours or 96 hours.

In some of the embodiments disclosed herein, activation temperatures may range from 800° C. to 1300° C. In another embodiment, activation temperatures may range from 800° C. to 1050° C. In another embodiment, activation temperatures may range from about 850° C. to about 950° C. One skilled in the art will recognize that other activation temperatures, either lower or higher, may be employed.

Pyrolyzed carbon materials may be activated by contacting the pyrolyzed carbon material with an activating agent. Many gases are suitable for activating, for example gases which contain oxygen. Non-limiting examples of activating gases include carbon dioxide, carbon monoxide, steam, oxygen and combinations thereof. Activating agents may also include corrosive chemicals such as acids, bases or salts (e.g., phosphoric acid, acetic acid, citric acid, formic acid, oxalic acid, uric acid, lactic acid, potassium hydroxide, sodium hydroxide, zinc chloride, etc.). Other activating agents are known to those skilled in the art.

Pyrolyzed carbon materials may be activated using any number of suitable apparatuses known to those skilled in the art, for example, fluidized beds, rotary kilns, elevator kilns, roller hearth kilns, pusher kilns and the like. In one embodiment of the activation process, samples are weighed and placed in a rotary kiln, for which the automated gas control manifold is set to a ramp rate of 20° C. per minute. In some embodiments, carbon dioxide is introduced to the kiln environment for a period of time once the activation temperature has been reached. In some embodiments, after activation has occurred, the carbon dioxide is replaced by nitrogen and the kiln is cooled down. Generally, samples are weighed at the end of the activation process to assess the level of activation. Other activation processes are well known to those of skill in the art.

The degree of activation is measured in terms of the mass percent of the pyrolyzed carbon material that is lost during the activation step. In one embodiment of the methods described herein, activating comprises a degree of activation from 5% to 90%; or a degree of activation from 10% to 80%. In some embodiments, the degree of activation ranges from 40% to 70%, from 45% to 65%, from 5% to 95%, from 5% to 80%, from 5% to 75%, from 5% to 70%, from 5% to 65%, from 5% to 60%, from 5% to 55%, from 5% to 50%, from 5% to 45%, from 5% to 40%, from 5% to 35%, from 5% to 30%, from 5% to 25%, from 5% to 20%, from 5% to 15%, from 5% to 10%, from 10% to 95%, from 15% to 95%, from 20% to 95%, from 25% to 95%, from 30% to 95%, from 35% to 95%, from 40% to 95%, from 45% to 95%, from 50% to 95%, from 55% to 95%, from 60% to 95%, from 65% to 95%, from 70% to 95%, from 75% to 95%, from 80% to 95%, from 85% to 95% or from 90% to 95%.

### B. Carbon Materials Comprising Optimized Pore Size Distributions

Certain embodiments of the present disclosure provide carbon material comprising an optimized pore size distribution. The optimized pore size distribution contributes to the superior performance of electrical devices comprising the carbon materials relative. For example, in some embodiments, the carbon material comprises an optimized blend of both micropores and mesopores and may also comprise low surface functionality upon pyrolysis and/or activation. In other embodiments, the carbon material comprises a total of less than 500 ppm of all elements having atomic numbers ranging from 11 to 92, as measured by total reflection x-ray fluorescence. The high purity and optimized micropore/mesopore distribution make the carbon materials ideal for use in electrical storage and distribution devices, for example ultracapacitors. Advantageously, embodiments of the method disclosed herein provide such carbon materials having high purity and optimized micropore/mesopore distributions while eliminating costly processes typically used in prior methods (i.e., freeze drying or super critical drying).

The optimized pore size distributions, as well as the high purity, of the carbon materials can be attributed to embodiments of the disclosed methods and subsequent processing of the carbon materials (e.g., activation). Monomers, for example a phenolic compound and an aldehyde, are co-polymerized under acidic conditions in the presence of a volatile basic catalyst, an ultrapure polymer composition results, which can then be pyrolyzed without drying the composition. This is in contrast to other reported methods for the preparation of xerogels, cryogels or aerogels which require a drying step prior to pyrolysis. In certain embodiments, pyrolysis and/or activation of ultrapure polymer compositions under the disclosed conditions results in an ultrapure carbon material having an optimized pore size distribution.

The properties of the disclosed carbon materials, as well as methods for their preparation are discussed in more detail below.

1. Polymer Compositions

In embodiments of the methods disclosed herein, polymer compositions are intermediates that are pyrolyzed to yield carbon materials. As such, the physical and chemical properties of the polymer compositions contribute to the properties of the final carbon materials.

In other embodiments, the cured polymer composition comprises a total of less than 500 ppm of all other elements (i.e., excluding the solvent, catalyst and optional electrochemical modifier) having atomic numbers ranging from 11 to 92. For example, in some other embodiments the cured polymer composition comprises less than 200 ppm, less than 100 ppm, less than 50 ppm, less than 25 ppm, less than 10 ppm, less than 5 ppm or less than 1 ppm of all other elements having atomic numbers ranging from 11 to 92. In some embodiments, the electrochemical modifier content and impurity content of the cured polymer composition can be determined by proton induced x-ray emission (PIXE) or total reflection x-ray fluorescence (TXRF) analysis.

In some embodiments, the cured polymer composition is prepared from phenolic compounds and aldehyde compounds; for example, in one embodiment the cured polymer composition can be produced from resorcinol and formaldehyde. In other embodiments, the cured polymer composition is produced under acidic conditions (e.g., the reaction mixture and/or polymer composition), and in other embodiments the cured polymer compositions further comprise and electrochemical modifier. In some embodiments, acidity can be provided by dissolution of a solid acid compound, by employing an acid as the solvent or by employing a mixed solvent system where one of the solvents is an acid.

The disclosed process comprises co-polymerization to form a polymer composition or cured polymer composition in the presence of a basic volatile catalyst. Accordingly, in some embodiments, the polymer composition or cured polymer composition comprises one or more salts, for example, in some embodiments the one or more salts are basic volatile salts. Examples of basic volatile salts include, but are not limited to, ammonium carbonate, ammonium bicarbonate, ammonium acetate, ammonium hydroxide, and combinations thereof. Accordingly, in some embodiments, the present disclosure provides a polymer composition or cured polymer composition comprising ammonium carbonate, ammonium bicarbonate, ammonium acetate, ammonium hydroxide, or combinations thereof. In further embodiments, the polymer composition or cured polymer composition comprises ammonium carbonate. In other further embodiments, the polymer composition or cured polymer composition comprises ammonium acetate.

The polymer composition may also comprise low ash content which may contribute to the low ash content of a carbon material prepared therefrom. Thus, in some embodiments, the ash content of the polymer composition or cured polymer composition ranges from 0.1% to 0.001%. In other embodiments, the ash content of the polymer composition or cured polymer composition is less than 0.1%, less than 0.08%, less than 0.05%, less than 0.03%, less than 0.025%, less than 0.01%, less than 0.0075%, less than 0.005% or less than 0.001%.

In other embodiments, the polymer composition or cured polymer composition has a total PIXE impurity content of all other elements of less than 500 ppm and an ash content of less than 0.08%. In a further embodiment, the polymer composition or cured polymer composition has a total PIXE impurity content of all other elements of less than 300 ppm and an ash content of less than 0.05%. In another further embodiment, the polymer composition or cured polymer composition has a total PIXE impurity content of all other elements of less than 200 ppm and an ash content of less than 0.02%. In another further embodiment, the polymer composition or cured polymer composition has a total PIXE impurity content of all other elements of less than 200 ppm and an ash content of less than 0.01%.

In other embodiments, the polymer composition or cured polymer composition has a total TXRF impurity content of all other elements of less than 500 ppm and an ash content of less than 0.08%. In a further embodiment, the polymer composition or cured polymer composition has a total TXRF impurity content of all other elements of less than 300 ppm and an ash content of less than 0.05%. In another further embodiment, the polymer composition or cured polymer composition has a total TXRF impurity content of all other elements of less than 200 ppm and an ash content of less than 0.02%. In another further embodiment, the polymer composition or cured polymer composition has a total TXRF impurity content of all other elements of less than 200 ppm and an ash content of less than 0.01%.

As noted above, methods that produce polymer compositions comprising impurities generally yield carbon materials which also comprise impurities. Accordingly, one aspect of the present methods provides a polymer composition or cured polymer composition with low levels of residual undesired impurities. The amount of individual PIXE impurities present in the polymer composition or cured polymer composition can be determined by proton induced x-ray emission. In some embodiments, the level of sodium present in the polymer composition or cured polymer composition is less than 1000 ppm, less than 500 ppm, less than 100 ppm, less than 50 ppm, less than 10 ppm, or less than 1 ppm. In some embodiments, the level of magnesium present in the polymer composition or cured polymer composition is less than 1000 ppm, less than 100 ppm, less than 50 ppm, less than 10 ppm, or less than 1 ppm. As noted above, in some embodiments other impurities such as hydrogen, oxygen and/or nitrogen may be present in levels ranging from less than 10% to less than 0.01%.

As noted above, methods that produce polymer compositions comprising impurities generally yield carbon materials which also comprise impurities. Accordingly, one aspect of the present methods provides a polymer composition or cured polymer composition with low levels of residual undesired impurities. The amount of individual TXRF impurities present in the polymer composition or cured polymer composition can be determined by total reflection x-ray fluorescence. In some embodiments, the level of sodium present in the polymer composition or cured polymer composition is less than 1000 ppm, less than 500 ppm, less than 100 ppm, less than 50 ppm, less than 10 ppm, or less than 1 ppm. In some embodiments, the level of magnesium present in the polymer composition or cured polymer composition is less than 1000 ppm, less than 100 ppm, less than 50 ppm, less than 10 ppm, or less than 1 ppm. As noted above, in some embodiments other impurities such as hydrogen, oxygen and/or nitrogen may be present in levels ranging from less than 10% to less than 0.01%.

In some specific embodiments, the polymer composition or cured polymer composition comprises less than 100 ppm sodium, less than 300 ppm silicon, less than 50 ppm sulfur, less than 100 ppm calcium, less than 20 ppm iron, less than 10 ppm nickel, less than 40 ppm copper, less than 5 ppm chromium and less than 5 ppm zinc. In other specific embodiments, the polymer composition or cured polymer composition comprises less than 50 ppm sodium, less than 100 ppm silicon, less than 30 ppm sulfur, less than 50 ppm calcium, less than 10 ppm iron, less than 5 ppm nickel, less than 20 ppm copper, less than 2 ppm chromium and less than 2 ppm zinc.

In other specific embodiments, the polymer composition or cured polymer composition comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the polymer composition or cured polymer composition comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In some embodiments, the method yields a polymer composition or cured polymer composition comprising a high specific surface area. Without being bound by theory, it is believed that the surface area of the polymer composition or cured polymer composition contributes, at least in part, to the desirable surface area properties of the carbon materials. The surface area can be measured using the BET technique well-known to those of skill in the art. In one embodiment, the method provides a polymer composition or cured polymer composition comprising a BET specific surface area of at least 150 m²/g, at least 250 m²/g, at least 400 m²/g, at least 500 m²/g, at least 600 m²/g or at least 700 m²/g.

In one embodiment, the polymer composition or cured polymer composition comprises a BET specific surface area of 100 m²/g to 1000 m²/g. Alternatively, the polymer composition or cured polymer composition comprises a BET specific surface area of between 150 m²/g and 900 m²/g. Alternatively, the polymer composition or cured polymer composition comprises a BET specific surface area of between 400 m²/g and 800 m²/g.

In one embodiment, the polymer composition or cured polymer composition comprises a tap density of from 0.10 g/cc to 0.60 g/cc. In one embodiment, the polymer composition or cured polymer composition comprises a tap density of from 0.15 g/cc to 0.25 g/cc. In one embodiment, the polymer composition or cured polymer composition comprises a BET specific surface area of at least 150 m²/g and a tap density of less than 0.60 g/cc. Alternately, the polymer composition or cured polymer composition comprises a BET specific surface area of at least 250 m²/g and a tap density of less than 0.4 g/cc. In another embodiment, the polymer composition or cured polymer composition comprises a BET specific surface area of at least 500 m²/g and a tap density of less than 0.30 g/cc.

In one embodiment, the polymer composition or cured polymer composition comprises a fractional pore volume of pores at or below 500 angstroms that comprises at least 25% of the total pore volume, 50% of the total pore volume, at least 75% of the total pore volume, at least 90% of the total pore volume or at least 99% of the total pore volume. In another embodiment, the polymer composition or cured polymer composition comprises a fractional pore volume of pores at or below 20 nm that comprises at least 50% of the total pore volume, at least 75% of the total pore volume, at least 90% of the total pore volume or at least 99% of the total pore volume.

In some embodiments, the amount of nitrogen adsorbed per mass of polymer composition or cured polymer composition at 0.11 relative pressure is at least 10% of the total nitrogen adsorbed up to 0.99 relative pressure or at least 20% of the total nitrogen adsorbed up to 0.99 relative pressure. In another embodiment, the amount of nitrogen adsorbed per mass of polymer composition or cured polymer composition at 0.11 relative pressure is between 10% and 50% of the total nitrogen adsorbed up to 0.99 relative pressure, is between 20% and 40% of the total nitrogen adsorbed up to 0.99 relative pressure or is between 20% and 30% of the total nitrogen adsorbed up to 0.99 relative pressure.

In one embodiment, the polymer composition or cured polymer composition comprises a fractional pore surface area of pores at or below 100 nm that comprises at least 50% of the total pore surface area, at least 75% of the total pore surface area, at least 90% of the total pore surface area or at least 99% of the total pore surface area. In another embodiment, the polymer composition or cured polymer composition comprises a fractional pore surface area of pores at or below 20 nm that comprises at least 50% of the total pore surface area, at least 75% of the total pore surface area, at least 90% of the total pore surface or at least 99% of the total pore surface area.

In some embodiments, the pyrolyzed carbon material has a surface area from about 100 to about 1200 m²/g. In other embodiments, the pyrolyzed carbon material has a surface area from about 500 to about 800 m²/g. In other embodiments, the pyrolyzed carbon material has a surface area from about 500 to about 700 m²/g.

In some embodiments, the carbon material comprises a total pore volume of at least 0.01 cc/g. In certain embodiments, the carbon material comprises a total pore volume of at least 0.05 cc/g. In some more specific embodiments, the carbon material comprises a total pore volume of at least 0.10 cc/g. In certain more specific embodiments, the carbon material comprises a total pore volume of at least 0.40 cc/g. In some embodiments, the carbon material comprises a total pore volume of at least 1.00 cc/g.

In some embodiments, the carbon material comprises a BET specific surface area of at least 5 m²/g. In certain embodiments, the carbon material comprises a BET specific surface area of at least 10 m²/g. In some more specific embodiments, the carbon material comprises a BET specific surface area of at least 50 m²/g. In certain more specific embodiments, the carbon material comprises a BET specific surface area of at least 100 m²/g. In certain more specific embodiments, the carbon material comprises a BET specific surface area of at least 100 m²/g. In certain more specific embodiments, the carbon material comprises a BET specific surface area of at least 150 m²/g. In certain more specific embodiments, the carbon material comprises a BET specific surface area of at least 1500 m²/g.

In other embodiments, the pyrolyzed carbon material has a tap density from about 0.1 to about 1.0 g/cc. In other embodiments, the pyrolyzed carbon material has a tap density from about 0.3 to about 0.6 g/cc. In other embodiments, the pyrolyzed carbon material has a tap density from about 0.3 to about 0.5 g/cc.

The polymer compositions (i.e., cured or not) can be prepared by the co-polymerization of the respective monomers in an appropriate solvent system under catalytic conditions. An optional electrochemical modifier can be incorporated into the composition either during or after the co-polymerization process (i.e., added to the reaction mixture or polymer composition).

Some embodiments provide a polymer composition or cured polymer composition comprising a solvent concentration greater than about 10 wt. % of the polymer composition or cured polymer composition, and a polymer having a relative pore integrity greater than 0.5.

In some embodiments, the polymer is a resorcinol-formaldehyde polymer. For example, a polymer synthesized from a co-polymerization of the first and second monomer as described in any of the foregoing embodiments.

In some specific embodiments, the relative pore integrity is greater than about 0.40, 0.45, 0.50, 0.55, 0.60, 0.65, 0.70, 0.75, 0.80, 0.85, 0.90, 0.95, 1.00, 1.05, 1.10, 1.15 or 1.20. relative pore integrity can be calculated by synthesizing carbon materials—one without a drying step (e.g., freeze drying) and one with a drying step—and measuring mesopore volumes or total pore volumes using the methods described herein or known in the art (e.g., Nitrogen sorption). In some embodiments, the relative pore integrity is greater than 0.5. In other embodiments, the relative pore integrity is greater than 0.65. In some embodiments, the relative pore integrity is greater than 0.80. In certain embodiments, the relative pore integrity is greater than 0.90. In still other embodiments, the relative pore integrity is greater than 0.95. In any one of the foregoing embodiments, the relative pore volume may be calculated using total pore volume (i.e., according to Equation 2).

In one embodiment, relative pore integrity can be calculated by comparing the mesopore volume measurements. For example, in some embodiments, the relative pore integrity is calculated according to the following equation (Equation 1):

$$relative pore integrity = \frac{Mesopore Volume of Carbon Material 1}{Mesopore Volume of Carbon Material 2}$$

wherein Carbon Material 1 is obtained by pyrolyzing a cured polymer composition and Carbon Material 2 is obtained by freeze drying and pyrolyzing the cured polymer composition. That is, in some of the above embodiments, Carbon Material 1 and Carbon Material 2 are obtained from the same starting material. As the equation above shows, when Carbon Material 1 has the same mesopore volume as Carbon Material 2, the polymer of the polymer composition or cured polymer composition has a relative pore integrity of 1.00.

In one embodiment, relative pore integrity can be calculated by comparing the total pore volume measurements. For example, in some embodiments, the relative pore integrity is calculated according to the following equation (Equation 2):

$$relative pore integrity = \frac{Total Pore Volume of Carbon Material 1}{Total P ore Volume of Carbon Material 2}$$

wherein Carbon Material 1 is obtained by pyrolyzing a cured polymer composition and Carbon Material 2 is obtained by freeze drying and pyrolyzing the cured polymer composition. That is, in some of the above embodiments, Carbon Material 1 and Carbon Material 2 are obtained from the same starting material. As the equation above shows, when Carbon Material 1 has the same total pore volume as Carbon Material 2, the polymer of the polymer composition or cured polymer composition has a relative pore integrity of 1.00.

In some of the above embodiments, the solvent concentration is greater than about 40 wt. % of the polymer composition or cured polymer composition. In some embodiments, the solvent concentration is greater than about 10 wt. %, 20 wt. %, 30 wt. %, 40 wt. %, 50 wt. %, 60 wt. %, 70 wt. %, 15 wt. %, 25 wt. %, 35 wt. %, 45 wt. %, 55 wt. %, 65 wt. %, 75 wt. %, 8 wt. %, 18 wt. %, 28 wt. %, 38 wt. %, 48 wt. %, 58 wt. %, 68 wt. %, 12 wt. %, 22 wt. %, 32 wt. %, 42 wt. % or 52 wt. % of the polymer composition.

In some embodiments, the polymer composition or cured polymer composition comprises greater than about 75% solvent by weight. In certain embodiments, the polymer composition or cured polymer composition comprises greater than about 65% solvent by weight. In some embodiments, the polymer composition or cured polymer composition comprises greater than about 5%, greater than about 10%, greater than about 15%, greater than about 20%, greater than about 25%, greater than about 30%, greater than about 35%, greater than about 40%, greater than about 45%, greater than about 50%, greater than about 55%, greater than about 60%, greater than about 67.5%, greater than about 70%, greater than about 72.5%, greater than about 75%, greater than about 77.5%, greater than about 80%, greater than about 82.5%, greater than about 85%, greater than about 87.5%, greater than about 90%, greater than about 92.5%, greater than about 95%, greater than about 97.5%, or greater than about 99% solvent by weight.

In some of the foregoing embodiments, the solvent concentration ranges from about 45 wt. % to about 65 wt. % of the polymer composition or cured polymer composition. In some embodiments, the solvent concentration ranges from about 10 wt. % to about 65 wt. %, from about 15 wt. % to about 65 wt. %, from about 25 wt. % to about 65 wt. %, from about 35 wt. % to about 65 wt. %, from about 55 wt. % to about 65 wt. %, from about 10 wt. % to about 60 wt. %, from about 10 wt. % to about 55 wt. %, from about 10 wt. % to about 45 wt. %, from about 10 wt. % to about 35 wt. %, from about 10 wt. % to about 25 wt. %, from about 10 wt. % to about 15 wt. %, from about 25 wt. % to about 65 wt. %, from about 40 wt. % to about 65 wt. %, from about 40 wt. % to about 70 wt. %, from about 48 wt. % to about 65 wt. %, from about 50 wt. % to about 55 wt. %, from about 45 wt. % to about 55 wt. %, from about 35 wt. % to about 55 wt. % or from about 25 wt. % to about 75 wt. % of the polymer composition or cured polymer composition.

In some of the foregoing embodiments, the polymer composition or cured polymer composition comprises a mesopore volume greater than 0.35 cm³/g, greater than 0.20 cm³/g or greater than 0.50 cm³/g. In some more specific embodiments, the polymer comprises a mesopore volume greater than 0.75 cm³/g. In some embodiments the polymer comprises a mesopore volume of at least 0.1 cm³/g, at least 0.2 cm³/g, at least 0.3 cm³/g, at least 0.4 cm3/g, at least 0.5 cm³/g, at least 0.7 cm³/g, at least 0.75 cm³/g, at least 0.9 cm³/g, at least 1.0 cm³/g, at least 1.1 cm³/g, at least 1.2 cm³/g, at least 1.3 cm³/g, at least 1.4 cm³/g, at least 1.5 cm³/g or at least 1.6 cm³/g.

In some embodiments, the polymer comprises a total pore volume of at least 0.60 cc/g. In some embodiments, the polymer of the method comprises a total pore volume of at least 1.00 cc/g. In some embodiments, the carbon material comprises a total pore volume of at least 0.40 cc/g. In some embodiments, the polymer comprises a total pore volume of at least 0.01 cc/g. In some embodiments, the polymer comprises a total pore volume of at least 0.05 cc/g. In some embodiments, the polymer comprises a total pore volume of at least 0.10 cc/g.

In some embodiments, the polymer comprises a total pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g or at least 0.20 cc/g.

In other embodiments, the polymer comprises a BET specific surface area of at least 500 m²/g. In some embodiments, the polymer comprises a BET specific surface area of at least 1500 m²/g. In some embodiments, the polymer comprises a BET specific surface area of at least 150 m²/g.

In in some embodiments, the method provides polymer comprising a BET specific surface area of at least 100 m²/g, at least 300 m²/g, at least 500 m²/g, at least 1000 m²/g, at least 1500 m²/g, at least 2000 m²/g, at least 2400 m²/g, at least 2500 m²/g, at least 2750 m²/g or at least 3000 m²/g. In other embodiments, the BET specific surface area ranges from about 100 m²/g to about 3000 m²/g, for example from about 500 m²/g to about 1000 m²/g, from about 1000 m²/g to about 1500 m²/g, from about 1500 m²/g to about 2000 m²/g, from about 2000 m²/g to about 2500 m²/g or from about 2500 m²/g to about 3000 m²/g.

In certain embodiments, the polymer has a pore structure comprising micropores, mesopores and a total pore volume, and wherein from 40% to 90% of the total pore volume resides in micropores, from 10% to 60% of the total pore volume resides in mesopores and less than 10% of the total pore volume resides in pores greater than 20 nm.

In still other embodiments, the pore structure of the polymer comprises from 40% to 90% micropores and from 10% to 60% mesopores. In other embodiments, the pore structure of the polymer comprises from 45% to 90% micropores and from 10% to 55% mesopores. In other embodiments, the pore structure of the polymer comprises from 40% to 85% micropores and from 15% to 40% mesopores. In yet other embodiments, the pore structure of the polymer comprises from 55% to 85% micropores and from 15% to 45% mesopores, for example from 65% to 85% micropores and from 15% to 35% mesopores. In other embodiments, the pore structure of the polymer comprises from 65% to 75% micropores and from 15% to 25% mesopores, for example from 67% to 73% micropores and from 27% to 33% mesopores In some other embodiments, the pore structure of the polymer comprises from 75% to 85% micropores and from 15% to 25% mesopores, for example from 83% to 77% micropores and from 17% to 23% mesopores. In other certain embodiments, the pore structure of the polymer comprises about 80% micropores and about 20% mesopores, or in other embodiments, the pore structure of the polymer comprises about 70% micropores and about 30% mesopores.

In some embodiments, the polymer comprises a total impurity content of less than 500 ppm of elements having atomic numbers ranging from 11 to 92 as measured by total reflection x-ray fluorescence. In certain embodiments, the polymer comprises a total impurity content of less than 100 ppm of elements having atomic numbers ranging from 11 to 92 as measured by total reflection x-ray fluorescence.

Certain embodiments provide a polymer composition or cured polymer composition wherein the polymer is prepared according to any one of the embodiments disclosed herein.

In some embodiments, the polymer comprises a total pore volume of at least 0.01 cc/g. In some embodiments, the polymer comprises a total pore volume of at least 0.05 cc/g. In some embodiments, the polymer comprises a total pore volume of at least 0.10 cc/g. In some embodiments, the polymer comprises a total pore volume of at least 0.40 cc/g. In some embodiments, the polymer comprises a total pore volume of at least 0.60 cc/g. In some embodiments, the polymer comprises a total pore volume of at least 1.00 cc/g. In some embodiments, the polymer comprises a total pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g or at least 0.20 cc/g.

In some embodiments, the polymer comprises a BET specific surface area of at least 5 m²/g. In some embodiments, the polymer comprises a BET specific surface area of at least 10 m²/g. In some embodiments, the polymer comprises a BET specific surface area of at least 50 m²/g. In some embodiments, the polymer comprises a BET specific surface area of at least 100 m²/g. In some embodiments, the polymer comprises a BET specific surface area of at least 150 m²/g. In some embodiments, the polymer comprises a BET specific surface area of at least 300 m²/g. In some embodiments, the polymer comprises a BET specific surface area of at least 500 m²/g. In certain embodiments, the polymer comprises a BET specific surface area of at least 1500 m²/g. In some embodiments, the polymer comprises a BET specific surface area of at least 100 m²/g, at least 300 m²/g, at least 500 m²/g, at least 1000 m²/g, at least 1500 m²/g, at least 2000 m²/g, at least 2400 m²/g, at least 2500 m²/g, at least 2750 m²/g or at least 3000 m²/g. In other embodiments, the BET specific surface area ranges from about 100 m²/g to about 3000 m²/g, for example from about 500 m²/g to about 1000 m²/g, from about 1000 m²/g to about 1500 m²/g, from about 1500 m²/g to about 2000 m²/g, from about 2000 m²/g to about 2500 m²/g or from about 2500 m²/g to about 3000 m²/g.

In some embodiments, the polymer comprises a first monomer. In some embodiments, the first monomer is a phenolic monomer. In one embodiment, the phenolic monomer is phenol, resorcinol, catechol, hydroquinone, phloroglucinol, or a combination thereof. In some embodiments, the phenolic monomer has the following structure:

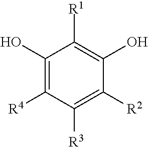

wherein:

R¹, R², R³ and R⁴ are each, independently, H, hydroxyl, halo, nitro, acyl, carboxy, alkylcarbonyl, arylcarbonyl, C₁₋₆ alkyl, C₁₋₆ alkenyl, methacrylate, acrylate, silyl ether, siloxane, aralkyl or alkaryl, wherein at least two of R¹, R² and R⁴ are H.

In some embodiments, the phenolic monomer is resorcinol. In some more specific embodiments, the phenolic monomer is a mixture of resorcinol and phenol.

In some embodiments, the polymer comprises a second monomer. In some embodiments, the second monomer is formaldehyde, paraformaldehyde, butyradehyde or combinations thereof. In some embodiments, the second monomer is formaldehyde.

2. Carbon Materials The present disclosure is generally directed to a method for preparing pyrolyzed carbon material from a polymer composition comprising water. While not wishing to be bound by theory, it is believed that, in addition to the pore structure, the purity profile, surface area and other properties of the carbon materials are a function of its preparation method, and variation of the preparation parameters may yield carbon materials having different properties. Accordingly, in some embodiments, the carbon material is produced from pyrolyzing a non-dried cured polymer composition. In other embodiments, the carbon material is pyrolyzed and activated.

As noted above, activated carbon materials are widely employed as an energy storage material. In this regard, it is a critically important characteristic of the methods disclosed herein is to produce carbon material with a high power density. It is important for embodiments of the method to produce carbon material with low ionic resistance, for instance for use in devices required to respond under a cyclic performance constraints.

Additionally, minimizing the cost of production as well as providing high quality materials at scale is vitally important. Embodiments of the disclosed methods solve the problem of producing carbon materials optimized for electrode formulation that maximize the power performance of electrical energy storage and distribution devices. Devices comprising the carbon materials exhibit long-term stability, fast response time and high pulse power performance.

The disclosed methods produce carbon materials comprising specific micropore structure, which is typically described in terms of fraction (percent) of total pore volume residing in either micropores or mesopores or both. Accordingly, in some embodiments the pore structure of the carbon materials comprises from 10% to 90% micropores. In some other embodiments the pore structure of the carbon materials comprises from 20% to 80% micropores. In other embodiments, the pore structure of the carbon materials comprises from 30% to 70% micropores. In other embodiments, the pore structure of the carbon materials comprises from 40% to 60% micropores. In other embodiments, the pore structure of the carbon materials comprises from 40% to 50% micropores. In other embodiments, the pore structure of the carbon materials comprises from 43% to 47% micropores. In certain embodiments, the pore structure of the carbon materials comprises about 45% micropores.

In some other embodiments the pore structure of the carbon materials comprises from 20% to 50% micropores. In still other embodiments the pore structure of the carbon materials comprises from 20% to 40% micropores, for example from 25% to 35% micropores or 27% to 33% micropores. In some other embodiments, the pore structure of the carbon materials comprises from 30% to 50% micropores, for example from 35% to 45% micropores or 37% to 43% micropores. In some certain embodiments, the pore structure of the carbon materials comprises about 30% micropores or about 40% micropores.

In one particular embodiment, the carbon materials have a pore structure comprising micropores, mesopores and a total pore volume, and wherein from 40% to 90% of the total pore volume resides in micropores, from 10% to 60% of the total pore volume resides in mesopores and less than 10% of the total pore volume resides in pores greater than 20 nm.

In some other embodiments the pore structure of the carbon materials comprises from 40% to 90% micropores. In still other embodiments the pore structure of the carbon materials comprises from 45% to 90% micropores, for example from 55% to 85% micropores. In some other embodiments, the pore structure of the carbon materials comprises from 65% to 85% micropores, for example from 75% to 85% micropores or 77% to 83% micropores. In yet other embodiments the pore structure of the carbon materials comprises from 65% to 75% micropores, for example from 67% to 73% micropores. In some certain embodiments, the pore structure of the carbon materials comprises about 80% micropores or about 70% micropores.

The mesoporosity of the carbon materials contributes to high ion mobility and low resistance. In some embodiments, the pore structure of the carbon materials comprises from 10% to 90% mesopores. In some other embodiments, the pore structure of the carbon materials comprises from 20% to 80% mesopores. In other embodiments, the pore structure of the carbon materials comprises from 30% to 70% mesopores. In other embodiments, the pore structure of the carbon materials comprises from 40% to 60% mesopores. In other embodiments, the pore structure of the carbon materials comprises from 50% to 60% mesopores. In other embodiments, the pore structure of the carbon materials comprises from 53% to 57% mesopores. In other embodiments, the pore structure of the carbon materials comprises about 55% mesopores.

In some other embodiments the pore structure of the carbon materials comprises from 50% to 80% mesopores. In still other embodiments the pore structure of the carbon materials comprises from 60% to 80% mesopores, for example from 65% to 75% mesopores or 67% to 73% mesopores. In some other embodiments, the pore structure of the carbon materials comprises from 50% to 70% mesopores, for example from 55% to 65% mesopores or 57% to 53% mesopores. In some certain embodiments, the pore structure of the carbon materials comprises about 30% mesopores or about 40% mesopores.

In some other embodiments the pore structure of the carbon materials comprises from 10% to 60% mesopores. In some other embodiments the pore structure of the carbon materials comprises from 10% to 55% mesopores, for example from 15% to 45% mesopores or from 15% to 40% mesopores. In some other embodiments, the pore structure of the carbon materials comprises from 15% to 35% mesopores, for example from 15% to 25% mesopores or from 17% to 23% mesopores. In some other embodiments, the pore structure of the carbon materials comprises from 25% to 35% mesopores, for example from 27% to 33% mesopores. In some certain embodiments, the pore structure of the carbon materials comprises about 20% mesopores and in other embodiments the carbon materials comprise about 30% mesopores.

In some embodiments, the method provides carbon materials with an optimized blend of micropores and mesopores that contributes to enhanced electrochemical performance of the carbon material. Thus, in some embodiments the pore structure of the carbon materials comprises from 10% to 90% micropores and from 10% to 90% mesopores. In some other embodiments the pore structure of the carbon materials comprises from 20% to 80% micropores and from 20% to 80% mesopores. In other embodiments, the pore structure of the carbon materials comprises from 30% to 70% micropores and from 30% to 70% mesopores. In other embodiments, the pore structure of the carbon materials comprises from 40% to 60% micropores and from 40% to 60% mesopores. In other embodiments, the pore structure of the carbon materials comprises from 40% to 50% micropores and from 50% to 60% mesopores. In other embodiments, the pore structure of the carbon materials comprises from 43% to 47% micropores and from 53% to 57% mesopores. In other embodiments, the pore structure of the carbon materials comprises about 45% micropores and about 55% mesopores.

In still other embodiments, the pore structure of the carbon materials comprises from 40% to 90% micropores and from 10% to 60% mesopores. In other embodiments, the pore structure of the carbon materials comprises from 45% to 90% micropores and from 10% to 55% mesopores. In other embodiments, the pore structure of the carbon materials comprises from 40% to 85% micropores and from 15% to 40% mesopores. In yet other embodiments, the pore structure of the carbon materials comprises from 55% to 85% micropores and from 15% to 45% mesopores, for example from 65% to 85% micropores and from 15% to 35% mesopores. In other embodiments, the pore structure of the carbon materials comprises from 65% to 75% micropores and from 15% to 25% mesopores, for example from 67% to 73% micropores and from 27% to 33% mesopores In some other embodiments, the pore structure of the carbon materials comprises from 75% to 85% micropores and from 15% to 25% mesopores, for example from 83% to 77% micropores and from 17% to 23% mesopores. In other certain embodiments, the pore structure of the carbon materials comprises about 80% micropores and about 20% mesopores, or in other embodiments, the pore structure of the carbon materials comprises about 70% micropores and about 30% mesopores.

In still other embodiments, the pore structure comprises from 20% to 50% micropores and from 50% to 80% mesopores. For example, in some embodiments, from 20% to 40% of the total pore volume resides in micropores and from 60% to 80% of the total pore volume resides in mesopores. In other embodiments, from 25% to 35% of the total pore volume resides in micropores and from 65% to 75% of the total pore volume resides in mesopores. For example, in some embodiments about 30% of the total pore volume resides in micropores and about 70% of the total pore volume resides in mesopores.

In still other embodiments, from 30% to 50% of the total pore volume resides in micropores and from 50% to 70% of the total pore volume resides in mesopores. In other embodiments, from 35% to 45% of the total pore volume resides in micropores and from 55% to 65% of the total pore volume resides in mesopores. For example, in some embodiments, about 40% of the total pore volume resides in micropores and about 60% of the total pore volume resides in mesopores.

In other variations of any of the foregoing methods, the carbon materials do not have a substantial volume of pores greater than 20 nm. For example, in certain embodiments the carbon materials comprise less than 50%, less than 40%, less than 30%, less than 25%, less than 20%, less than 15%, less than 10%, less than 5%, less than 2.5% or even less than 1% of the total pore volume in pores greater than 20 nm.

In some embodiments, the methods provide carbon materials having a porosity that contributes to their enhanced electrochemical performance. Accordingly, in one embodiment, the carbon material comprises a pore volume residing in pores less than 20 angstroms of at least 1.8 cc/g, at least 1.2 cc/g, at least 0.6 cc/g, at least 0.30 cc/g, at least 0.25 cc/g, at least 0.20 cc/g or at least 0.15 cc/g. In other embodiments, the carbon material comprises a pore volume residing in pores greater than 20 angstroms of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, or at least 0.5 cc/g.

In other embodiments, the carbon material comprises a pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g or at least 0.50 cc/g for pores ranging from 20 angstroms to 300 angstroms.

In yet other embodiments, the carbon materials comprise a total pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g or at least 0.20 cc/g.

In one embodiment the carbon material comprises a pore volume of at least 0.35 cc/g, at least 0.30 cc/g, at least 0.25 cc/g, at least 0.20 cc/g or at least 0.15 cc/g for pores less than 20 angstroms. In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores greater than 20 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 500 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 1000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 2000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 5000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 1 micron.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 2 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 3 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 4 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 20 angstroms to 5 microns.

In yet other embodiments, the carbon material comprises a total pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g.

In other embodiments, the carbon material comprises a pore volume (e.g., mesopore volume) of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g.

In yet other embodiments, the carbon materials comprise a pore volume residing in pores of less than 20 angstroms of at least 0.2 cc/g and a pore volume residing in pores of between 20 and 300 angstroms of at least 0.8 cc/g. In yet other embodiments, the carbon materials comprise a pore volume residing in pores of less than 20 angstroms of at least 0.5 cc/g and a pore volume residing in pores of between 20 and 300 angstroms of at least 0.5 cc/g. In yet other embodiments, the carbon materials comprise a pore volume residing in pores of less than 20 angstroms of at least 0.6 cc/g and a pore volume residing in pores of between 20 and 300 angstroms of at least 2.4 cc/g. In yet other embodiments, the carbon materials comprise a pore volume residing in pores of less than 20 angstroms of at least 1.5 cc/g and a pore volume residing in pores of between 20 and 300 angstroms of at least 1.5 cc/g.

In certain embodiments a mesoporous carbon material having low pore volume in the micropore region (e.g., less than 60%, less than 50%, less than 40%, less than 30%, less than 20% microporosity) is provided. In some embodiments, the carbon material comprises a specific surface area of 100 m²/g, at least 200 m²/g, at least 300 m²/g, at least 400 m²/g, at least 500 m²/g, at least 600 m²/g, at least 675 m²/g or at least 750 m²/g. In other embodiments, the mesoporous carbon material comprises a total pore volume of at least 0.50 cc/g, at least 0.60 cc/g, at least 0.70 cc/g, at least 0.80 cc/g or at least 0.90 cc/g. In yet other embodiments, the mesoporous carbon material comprises a tap density of at least 0.30 g/cc, at least 0.35 g/cc, at least 0.40 g/cc, at least 0.45 g/cc, at least 0.50 g/cc or at least 0.55 g/cc.

Embodiments of the present method provide carbon material having low total PIXE impurities (excluding the electrochemical modifier). Thus, in some embodiments the total PIXE impurity content (excluding the electrochemical modifier) of all other PIXE elements in the carbon material (as measured by proton induced x-ray emission) is less than 1000 ppm. In other embodiments, the total PIXE impurity content (excluding the electrochemical modifier) of all other PIXE elements in the carbon material is less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm. In further embodiments of the foregoing, the method further comprises activating the carbon material.

Embodiments of the present method provide carbon material having low total TXRF impurities (excluding the electrochemical modifier). Thus, in some embodiments the total TXRF impurity content (excluding the electrochemical modifier) of all other TXRF elements in the carbon material (as measured by total reflection x-ray fluorescence) is less than 1000 ppm. In other embodiments, the total TXRF impurity content (excluding the electrochemical modifier) of all other TXRF elements in the carbon material is less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm. In further embodiments of the foregoing, the method further comprises activating the carbon material.

In one embodiment, the carbon materials comprise a total impurity content of less than 500 ppm of elements having atomic numbers ranging from 11 to 92 as measured by proton induced x-ray emission. In another embodiment, the carbon materials comprise a total impurity content of less than 100 ppm of elements having atomic numbers ranging from 11 to 92 as measured by proton induced x-ray emission.

In one embodiment, the carbon materials comprise a total impurity content of less than 500 ppm of elements having atomic numbers ranging from 11 to 92 as measured by total reflection x-ray fluorescence. In another embodiment, the carbon materials comprise a total impurity content of less than 100 ppm of elements having atomic numbers ranging from 11 to 92 as measured by total reflective x-ray fluorescence.

In addition to low content of undesired PIXE or TXRF impurities, the carbon materials of certain embodiments of the present methods may comprise high total carbon content. In addition to carbon, the carbon material may also comprise oxygen, hydrogen, nitrogen and the electrochemical modifier. In some embodiments, the carbon material comprises at least 75% carbon, 80% carbon, 85% carbon, at least 90% carbon, at least 95% carbon, at least 96% carbon, at least 97% carbon, at least 98% carbon or at least 99% carbon on a weight/weight basis. In some other embodiments, the carbon material comprises less than 10% oxygen, less than 5% oxygen, less than 3.0% oxygen, less than 2.5% oxygen, less than 1% oxygen or less than 0.5% oxygen on a weight/weight basis. In other embodiments, the carbon material comprises less than 10% hydrogen, less than 5% hydrogen, less than 2.5% hydrogen, less than 1% hydrogen, less than 0.5% hydrogen or less than 0.1% hydrogen on a weight/weight basis. In other embodiments, the carbon material comprises less than 5% nitrogen, less than 2.5% nitrogen, less than 1% nitrogen, less than 0.5% nitrogen, less than 0.25% nitrogen or less than 0.01% nitrogen on a weight/weight basis. The oxygen, hydrogen and nitrogen content of the disclosed carbon materials can be determined by combustion analysis. Techniques for determining elemental composition by combustion analysis are well known in the art.

Certain embodiments of the method provide carbon material with a total ash content that may, in some instances, have an effect on the electrochemical performance of the carbon material. Accordingly, in some embodiments, the ash content of the carbon material ranges from 0.1% to 0.001% weight percent ash, for example in some specific embodiments the ash content of the carbon material is less than 0.1%, less than 0.08%, less than 0.05%, less than 0.03%, than 0.025%, less than 0.01%, less than 0.0075%, less than 0.005% or less than 0.001%.

In some embodiments, the ash content of the carbon material is less than 0.03% as calculated from total reflection x-ray fluorescence data. In another embodiment, the ash content of the carbon material is less than 0.01% as calculated from total reflection x-ray fluorescence data.

In other embodiments, the carbon material comprises a total PIXE or TXRF impurity content of less than 500 ppm and an ash content of less than 0.08%. In further embodiments, the carbon material comprises a total PIXE or TXRF impurity content of less than 300 ppm and an ash content of less than 0.05%. In other further embodiments, the carbon material comprises a total PIXE or TXRF impurity content of less than 200 ppm and an ash content of less than 0.05%. In other further embodiments, the carbon material comprises a total PIXE or TXRF impurity content of less than 200 ppm and an ash content of less than 0.025%. In other further embodiments, the carbon material comprises a total PIXE or TXRF impurity content of less than 100 ppm and an ash content of less than 0.02%. In other further embodiments, the carbon material comprises a total PIXE or TXRF impurity content of less than 50 ppm and an ash content of less than 0.01%.

The amount of individual PIXE or TXRF impurities present in the carbon materials obtained from embodiments of the methods provided can be determined by proton induced x-ray emission or total reflective x-ray fluorescence, respectively. Individual PIXE or TXRF impurities may contribute in different ways to the overall electrochemical performance of the carbon materials produced. Thus, in some embodiments, the level of sodium present in the carbon material is less than 1000 ppm, less than 500 ppm, less than 100 ppm, less than 50 ppm, less than 10 ppm, or less than 1 ppm. As noted above, in some embodiments other impurities such as hydrogen, oxygen and/or nitrogen may be present in levels ranging from less than 10% to less than 0.01%.

In some embodiments, the carbon material comprises undesired PIXE or TXRF impurities near or below the detection limit of the proton induced x-ray emission or total reflection x-ray fluorescence analyses, respectively. For example, in some embodiments the carbon material comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm, technetium, less than 7 ppm rubidium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hafnium, less than 1 ppm tantalum, less than 1 ppm tungsten, less than 1.5 ppm rhenium, less than 1 ppm osmium, less than 1 ppm iridium, less than 1 ppm platinum, less than 1 ppm silver, less than 1 ppm mercury, less than 1 ppm thallium, less than 1 ppm lead, less than 1.5 ppm bismuth, less than 2 ppm thorium, or less than 4 ppm uranium.

In some specific embodiments, the carbon material comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission or total reflection x-ray fluorescence. In other specific embodiments, the carbon material comprises less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, the carbon material comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the carbon material comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In some embodiments, the carbon materials comprise less than 10 ppm iron. In other embodiments, the carbon materials comprise less than 3 ppm nickel. In other embodiments, the carbon materials comprise less than 30 ppm sulfur. In other embodiments, the carbon materials comprise less than 1 ppm chromium. In other embodiments, the carbon materials comprise less than 1 ppm copper. In other embodiments, the carbon materials comprise less than 1 ppm zinc.

Embodiments of the disclosed methods also produce carbon materials with a high surface area. While not wishing to be bound by theory, it is thought that such high surface area may contribute, at least in part, to their superior electrochemical performance. Accordingly, in some embodiments, the method provides carbon material comprises a BET specific surface area of at least 100 m²/g, at least 300 m²/g, at least 500 m²/g, at least 1000 m²/g, at least 1500 m²/g, at least 2000 m²/g, at least 2400 m²/g, at least 2500 m²/g, at least 2750 m²/g or at least 3000 m²/g. In other embodiments, the BET specific surface area ranges from about 100 m²/g to about 3000 m²/g, for example from about 500 m²/g to about 1000 m²/g, from about 1000 m²/g to about 1500 m²/g, from about 1500 m²/g to about 2000 m²/g, from about 2000 m²/g to about 2500 m²/g or from about 2500 m²/g to about 3000 m²/g. For example, in some embodiments of the foregoing, the carbon material is activated.

In certain embodiments, the carbon material comprises a BET specific surface area of at least 5 m²/g. In certain embodiments, the carbon material comprises a BET specific surface area of at least 10 m²/g. In certain embodiments, the carbon material comprises a BET specific surface area of at least 50 m²/g. In certain embodiments, the carbon material comprises a BET specific surface area of at least 100 m²/g. In certain embodiments, the carbon material comprises a BET specific surface area of at least 500 m²/g. In another embodiment, the carbon material comprises a BET specific surface area of at least 1500 m²/g.

In still other examples, the carbon material comprises less than 100 ppm sodium, less than 100 ppm silicon, less than 10 ppm sulfur, less than 25 ppm calcium, less than 1 ppm iron, less than 2 ppm nickel, less than 1 ppm copper, less than 1 ppm chromium, less than 50 ppm magnesium, less than 10 ppm aluminum, less than 25 ppm phosphorous, less than 5 ppm chlorine, less than 25 ppm potassium, less than 2 ppm titanium, less than 2 ppm manganese, less than 0.5 ppm cobalt and less than 5 ppm zinc as measured by proton induced x-ray emission or total reflection x-ray fluorescence, and wherein all other elements having atomic numbers ranging from 11 to 92 are undetected by proton induced x-ray emission or total reflection x-ray fluorescence.

In another embodiment, the method provide carbon material having a tap density between 0.1 and 1.0 g/cc, between 0.2 and 0.8 g/cc, between 0.3 and 0.5 g/cc or between 0.4 and 0.5 g/cc. In another embodiment, the carbon material has a total pore volume of at least 0.1 cm³/g, at least 0.2 cm³/g, at least 0.3 cm³/g, at least 0.4 cm3/g, at least 0.5 cm³/g, at least 0.7 cm³/g, at least 0.75 cm³/g, at least 0.9 cm³/g, at least 1.0 cm³/g, at least 1.1 cm³/g, at least 1.2 cm³/g, at least 1.3 cm³/g, at least 1.4 cm³/g, at least 1.5 cm³/g or at least 1.6 cm³/g.

The pore size distribution is one parameter that may have an effect on the electrochemical performance of carbon materials. For example, certain embodiments of the method provide carbon materials having mesopores with a short effective length (i.e., less than 10 nm, less than 5, nm or less than 3 nm as measured by TEM) which decreases ion diffusion distance and may be useful to enhance ion transport and maximize power.

In one embodiment, the carbon material comprises a fractional pore volume of pores at or below 100 nm that comprises at least 50% of the total pore volume, at least 75% of the total pore volume, at least 90% of the total pore volume or at least 99% of the total pore volume. In other embodiments, the carbon material comprises a fractional pore volume of pores at or below 50 nm that comprises at least 50% of the total pore volume, at least 75% of the total pore volume, at least 90% of the total pore volume or at least 99% of the total pore volume. In other embodiments, the carbon material comprises a fractional pore volume of pores at or below 20 nm that comprises at least 50% of the total pore volume, at least 75% of the total pore volume, at least 90% of the total pore volume or at least 99% of the total pore volume. In other embodiments, the carbon material comprises a fractional pore volume of pores ranging from 50 nm to 20 nm that comprises at least 50% of the total pore volume, at least 75% of the total pore volume, at least 90% of the total pore volume or at least 99% of the total pore volume.

In another embodiment, the carbon material comprises a fractional pore surface area of pores at or below 100 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores at or below 50 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores at or below 20 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores ranging from 50 nm to 20 nm that comprises at least 50% of the total pore surface area, at least 75% of the total pore surface area, at least 90% of the total pore surface area or at least 99% of the total pore surface area.

In another embodiment, the method provides carbon material comprising a fractional pore surface area of pores between 20 and 300 angstroms that comprises at least 40% of the total pore surface area, at least 50% of the total pore surface area, at least 70% of the total pore surface area or at least 80% of the total pore surface area. In another embodiment, the method provides carbon material having a fractional pore surface area of pores at or below 20 nm that comprises at least 20% of the total pore surface area, at least 30% of the total pore surface area, at least 40% of the total pore surface area or at least 50% of the total pore surface area.

In another embodiment, the method provides carbon material having pores predominantly in the range of 1000 angstroms or lower, for example 100 angstroms or lower, for example 50 angstroms or lower. Alternatively, the carbon material comprises micropores in the range of 0-20 angstroms and mesopores in the range of 20-300 angstroms. The ratio of pore volume (e.g., mesopore volume) or pore surface in the micropore range compared to the mesopore range can be in the range of 95:5 to 5:95. Alternatively, the ratio of pore volume (e.g., mesopore volume) or pore surface in the micropore range compared to the mesopore range can be in the range of 20:80 to 60:40.

In some embodiments, the carbon materials (e.g., particles) exhibit a surface functionality of less than 20 mEq per 100 gram of carbon material, less than 10 mEq per 100 gram of carbon material, less than 5 mEq per 100 gram of carbon material as determined by Boehm titration or less than 1 mEq per 100 gram of carbon material as determined by Boehm titration. In other embodiments, the carbon materials exhibit a surface functionality of greater than 20 mEq per 100 gram of carbon material as determined by Boehm titration.

The specific capacity (Q, Ah/gram carbon) of a mesoporous carbon material is defined by the amount of reaction product that can form on the pore surfaces. If the mixture of reaction products is constant, the current generated during reaction product formation is directly proportional to the volume of a reaction product. The high mesopore volume of mesoporous carbon material provides a reservoir for reaction products (e.g., lithium peroxide) while still maintaining electrochemical activity in pores present in the material. Such a high mesopore volume provides a significant increase in the energy density of a device (e.g., metal-air battery) comprising the carbon materials. In some embodiments, the pore structure of carbon materials comprises pores ranging from 2-50 nm, 10-50 nm, 15-30 nm or even 20-30 nm.

Still other aspects of the disclosure provide a method for preparing carbon materials that have different electrolyte wetting characteristics. In certain embodiments, such carbon materials are mesoporous, while in other embodiments the carbon materials are microporous or comprise a blend of micropores and mesopores. For example, in some embodiments, the inner surfaces of the pores can be wetted by an electrolyte while the outer surface of the particles remains relatively un-wetted by the electrolyte such that gas diffusion can occur between particles. Still in other embodiments, the inner surface of the pore has a higher affinity for a solvent relative to the outer surface of the particle. Yet in other embodiments, the outer surface of the particle has a higher affinity for a solvent relative to the inner surface of the pore.

In this manner, a wide range of applications are possible with the mesoporous carbon materials prepared by methods disclosed herein. For example, when the inner surface of the pores have a higher affinity for a lithium ion solvent, the reaction products of lithium-air batteries are more likely to be trapped within the pores of such material. In another approach carbon materials which have different wetting characteristics can be combined in a blend whereby certain particles that repel electrolyte can be used for gas diffusion channels and other particles that are easily wetted by electrolytes can be used for ion conduction and electrochemical reactions.

The carbon materials prepared by the methods of the present disclosure can be used as a gas diffusion electrode and mesoporous, i.e., have intra-particle pores. In some embodiments, the majority of intra-particle pores are mesopores, for example in some embodiments greater than 50%, greater than 60%, greater than 70%, greater than 80% or greater than 90% of the pores are mesopores.

Yet in other embodiments, the carbon materials prepared according to disclosed methods comprise a pore volume (e.g., mesopore volume) of at least 1 cc/g, at least 2 cc/g, at least 3 cc/g, at least 4 cc/g, at least 5cc/g, at least 6cc/g, or at least 7 cc/g. In one particular embodiment, the carbon materials comprise a pore volume (e.g., mesopore volume) ranging from 1 cc/g to 7 cc/g. In other embodiments, the porosity (e.g., mesoporosity) of the sample can be greater than 50% or greater than 60%, or greater than 70%, or greater than 80%, or greater than 90%, or greater than 95%. In other embodiments, the carbon material comprises a BET specific surface area of at least 100, at least 500 m²/g, at least 1000 m²/g, at least 1500 m²/g, at least 2000 m²/g, at least 2400 m²/g, at least 2500 m²/g, at least 2750 m²/g or at least 3000 m²/g.

In some embodiments, the mean particle diameter for the carbon materials ranges from 1 to 1000 microns. In other embodiments the mean particle diameter for the carbon material ranges from 1 to 100 microns. Still in other embodiments the mean particle diameter for the carbon material ranges from 5 to 50 microns. Yet in other embodiments, the mean particle diameter for the carbon material ranges from 5 to 15 microns. Still in other embodiments, the mean particle diameter for the carbon material is about 10 microns.

In another embodiment the size of the pores, for example mesopores, is controlled to produce a desired pore structure, e.g., for maximizing available surface. In some embodiments, the pore distribution in the carbon material is controlled by controlling the pore distribution in the gel as discussed below. In further embodiments of the foregoing, the carbon material is a mesoporous carbon.

In some embodiments, the pores of the carbon material comprise a peak pore volume ranging from 2 nm to 10 nm. In other embodiments, the peak pore volume ranges from 10 nm to 20 nm. Yet in other embodiments, the peak pore volume ranges from 20 nm to 30 nm. Still in other embodiments, the peak pore volume ranges from 30 nm to 40 nm. Yet still in other embodiments, the peak pore volume ranges from 40 nm to 50 nm. In other embodiments, the peak pore volume ranges from 50 nm to 100 nm.

In other embodiments, the carbon materials are mesoporous and comprise monodisperse mesopores. As used herein, the term “monodisperse” when used in reference to a pore size refers generally to a span (further defined as (Dv90-Dv10)/Dv, 50 where Dv10, Dv50 and Dv90 refer to the pore size at 10%, 50% and 90% of the distribution by volume of about 3 or less, typically about 2 or less, often about 1.5 or less.

In other embodiments, the method provides carbon materials having at least 50% of the total pore volume residing in pores with a diameter ranging from 50 Å to 5000 Å. In some instances, the carbon materials comprise at least 50% of the total pore volume residing in pores with a diameter ranging from 50 Å to 500 Å. Still in other instances, the carbon materials comprise at least 50% of the total pore volume residing in pores with a diameter ranging from 500 Å to 1000 Å. Yet in other instances, the carbon materials comprise at least 50% of the total pore volume residing in pores with a diameter ranging from 1000 Å to 5000 Å.

In some embodiments the pore structure of the carbon materials comprises from 10% to 80% micropores. In other embodiments, the pore structure of the carbon materials comprises from 30% to 70% micropores. In other embodiments, the pore structure of the carbon materials comprises from 40% to 60% micropores. In other embodiments, the pore structure of the carbon materials comprises from 40% to 50% micropores. In other embodiments, the pore structure of the carbon materials comprises from 43% to 47% micropores. In certain embodiments, the pore structure of the carbon materials comprises about 45% micropores.

In some other embodiments, the pore structure of the carbon materials comprises from 10% to 80% mesopores. In other embodiments, the pore structure of the carbon materials comprises from 30% to 70% mesopores. In other embodiments, the pore structure of the carbon materials comprises from 40% to 60% mesopores. In other embodiments, the pore structure of the carbon materials comprises from 50% to 60% mesopores. In other embodiments, the pore structure of the carbon materials comprises from 53% to 57% mesopores. In other embodiments, the pore structure of the carbon materials comprises about 55% mesopores.

In some embodiments the pore structure of the carbon materials comprises from 10% to 80% micropores and from 10% to 80% mesopores. In other embodiments, the pore structure of the carbon materials comprises from 30% to 70% micropores and from 30% to 70% mesopores. In other embodiments, the pore structure of the carbon materials comprises from 40% to 60% micropores and from 40% to 60% mesopores. In other embodiments, the pore structure of the carbon materials comprises from 40% to 50% micropores and from 50% to 60% mesopores. In other embodiments, the pore structure of the carbon materials comprises from 43% to 47% micropores and from 53% to 57% mesopores. In other embodiments, the pore structure of the carbon materials comprises about 45% micropores and about 55% mesopores.

In other variations, the carbon materials do not have a substantial volume of pores greater than 20 nm. For example, in certain embodiments the carbon materials comprise less than 25%, less than 20%, less than 15%, less than 10%, less than 5%, less than 2.5% or even less than 1% of the total pore volume in pores greater than 20 nm.

In yet other embodiments, the carbon materials prepared according to the present methods comprise a pore volume residing in pores of less than 20 angstroms of at least 0.2 cc/g and a pore volume residing in pores of between 20 and 300 angstroms of at least 0.8 cc/g. In yet other embodiments, the carbon materials comprise a pore volume residing in pores of less than 20 angstroms of at least 0.5 cc/g and a pore volume residing in pores of between 20 and 300 angstroms of at least 0.5 cc/g. In yet other embodiments, the carbon materials comprise a pore volume residing in pores of less than 20 angstroms of at least 0.6 cc/g and a pore volume residing in pores of between 20 and 300 angstroms of at least 2.4 cc/g. In yet other embodiments, the carbon materials comprise a pore volume residing in pores of less than 20 angstroms of at least 1.5 cc/g and a pore volume residing in pores of between 20 and 300 angstroms of at least 1.5 cc/g.

In some embodiments, the mean particle diameter for the carbon materials ranges from 1 to 1000 microns. In other embodiments the mean particle diameter for the carbon materials ranges from 1 to 100 microns. Still in other embodiments the mean particle diameter for the carbon materials ranges from 1 to 50 microns. Yet in other embodiments, the mean particle diameter for the carbon materials ranges from 5 to 15 microns or from 1 to 5 microns. Still in other embodiments, the mean particle diameter for the carbon materials is about 10 microns. Still in other embodiments, the mean particle diameter for the carbon materials is less than 4, is less than 3, is less than 2, is less than 1 microns.

In some embodiments, the carbon materials exhibit a mean particle diameter ranging from 1 nm to 10 nm. In other embodiments, the mean particle diameter ranges from 10 nm to 20 nm. Yet in other embodiments, the mean particle diameter ranges from 20 nm to 30 nm. Still in other embodiments, the mean particle diameter ranges from 30 nm to 40 nm. Yet still in other embodiments, the mean particle diameter ranges from 40 nm to 50 nm. In other embodiments, the mean particle diameter ranges from 50 nm to 100 nm.

The pH of the carbon materials (e.g., particles) can vary. For example, in some embodiments the pH of the carbon materials is basic. For example, in some embodiments the pH of the carbon materials is greater than 7, greater than 8 or greater than 9. In other embodiments, the pH of the carbon materials is acidic. For example, in certain embodiments the pH of the carbon materials is less than 7, less than 6 or less than 5. In still other embodiments, the pH of the carbon materials may be determined by suspending the carbon materials in water and measuring the resulting pH.

The carbon materials prepared by embodiments of the present methods may be combined to form a blend. Such blends may comprise a plurality of the carbon materials (e.g., particles) and a plurality of lead particles, wherein the capacitance of the carbon materials varies. In some embodiments, the capacitance of the carbon materials measured at a rate of 1 mA is greater than 600 F/g, greater than 550 F/g, greater than 500 F/g, greater than 450 F/g, greater than 400 F/g, greater than 350F/g, greater than 300 F/g, greater than 250 F/g, greater than 200 F/g or greater than 100 F/g. In other embodiments, the capacitance of the carbon materials measured at a rate of 1 mA is less than 300 F/g or less than 250 F/g. In certain embodiments of the foregoing, the capacitance is measured in a sulfuric acid electrolyte. For example, in some embodiments the capacitance is measured based on the discharge data of a galvanostatic charge/discharge profile to 0.9V and 0V at a symmetric current density ranging from 0.1 A/g carbon to 10 A/g carbon.

In certain embodiments, the water absorbing properties (i.e., total amount of water a plurality of carbon particles can absorb) of the carbon materials are predictive of the carbon material's electrochemical performance when incorporated into a carbon-lead blend. The water can be absorbed into the pore volume in the carbon materials and/or within the space between individual carbon particles. The more water absorption, the greater the surface area is exposed to water molecules, thus increasing the available lead-sulfate nucleation sites at the liquid-solid interface. The water accessible pores also allow for the transport of electrolyte into the center of a lead pasted plate for additional material utilization.

Accordingly, in some embodiments, the carbon materials are prepared as activated carbon particles and have a water absorption of greater than 0.2 g H₂O/cc (cc=pore volume in the carbon particle), greater than 0.4 g H₂O/cc, greater than 0.6 g H₂O/cc, greater than 0.8 g H₂O/cc, greater than 1.0 g H₂O/cc, greater than 1.25 g H₂O/cc, greater than 1.5 g H₂O/cc, greater than 1.75 g H₂O/cc, greater than 2.0 g H₂O/cc, greater than 2.25 g H₂O/cc, greater than 2.5 g H₂O/cc or even greater than 2.75 g H₂O/cc. In other embodiments the carbon materials are prepared as unactivated particles and have a water absorption of greater than 0.2 g H₂O/cc, greater than 0.4 g H₂O/cc, greater than 0.6 g H₂O/cc, greater than 0.8 g H₂O/cc, greater than 1.0 g H₂O/cc, greater than 1.25 g H₂O/cc, greater than 1.5 g H₂O/cc, greater than 1.75 g H₂O/cc, greater than 2.0 g H₂O/cc, greater than 2.25 g H₂O/cc, greater than 2.5 g H₂O/cc or even greater than 2.75 g H₂O/cc. Methods for determining water absorption of exemplary carbon particles are known in the art.

The water absorption of the carbon materials can also be measured in terms of an R factor, wherein R is the maximum grams of water absorbed per gram of carbon. In some embodiments, the R factor is greater than 2.0, greater than 1.8, greater than 1.6, greater than 1.4, greater than 1.2, greater than 1.0, greater than 0.8, or greater than 0.6. In other embodiments, the R value ranges from 1.2 to 1.6, and in still other embodiments the R value is less than 1.2.

The R factor of carbon material can also be determined based upon the carbon materials' ability to absorb water when exposed to a humid environment for extended periods of time (e.g., 2 weeks). For example, in some embodiments the R factor is expressed in terms of relative humidity. In this regard, in some embodiments the carbon materials comprise an R factor ranging from about 0.1 to about 1.0 at relative humidity ranging from 10% to 100%. In some embodiments, the R factor is less than 0.1, less than 0.2, less than 0.3, less than 0.4, less than 0.5, less than 0.6, less than 0.7 or even less than 0.8 at relative humidity ranging from 10% to 100%. In embodiments of the foregoing, the carbon materials comprise a total pore volume between about 0.1 cc/g and 2.0 cc/g, between about 0.2 cc/g and 1.8 cc/g, between about 0.4 cc/g and 1.4 cc/g, between about 0.6 cc/g and 1.2 cc/g. In other embodiments of the foregoing, the relative humidity ranges from about 10% to about 20%, from about 20% to about 30%, from about 30% to about 40%, from about 40% to about 50%., from about 50% to about 60%, from about 60%, to about 70%, from about 70% to about 80%, from about 80% to about 90% or from about 90% to about 99% or even 100%. The above R factors may be determined by exposing the carbon materials to the specified humidity at room temperature for two weeks.

It should be appreciated that combinations of various parameters described herein form other embodiments. For example, in one particular embodiment the carbons comprise a pore volume (e.g., mesopore volume) of at least about 2 cc/g and a specific surface area of at least 2000 m²/g. In this manner, a variety of embodiments are encompassed within the scope of the present invention.

### C. Characterization of Cured Polymer Compositions and Carbon Materials

The properties of the final carbon material, the cured polymer composition, the polymer composition, and reaction mixture may be measured using techniques known in the art. For example, structural properties of the carbon material can be measured using Nitrogen sorption at 77K, a method known to those of skill in the art. The final performance and characteristics of the finished carbon material is important, but the intermediate products (i.e., the reaction mixture, the polymer composition and the cured polymer composition), can also be evaluated, particularly from a quality control standpoint, as known to those of skill in the art. The Micromeretics ASAP 2020 is used to perform detailed micropore and mesopore analysis, which reveals a pore size distribution from 0.35 nm to 50 nm in some embodiments. The system produces a nitrogen isotherm starting at a pressure of 10⁻⁷ atm, which enables high resolution pore size distributions in the sub 1 nm range. The software generated reports utilize a Density Functional Theory (DFT) method to calculate properties such as pore size distributions, surface area distributions, total surface area, total pore volume, and pore volume within certain pore size ranges.

The impurity content of the carbon materials can be determined by any number of analytical techniques known to those of skill in the art. One particular analytical method useful within the context of the present disclosure is proton induced x-ray emission (PIXE). This technique is capable of measuring the concentration of elements having atomic numbers ranging from 11 to 92 at low ppm levels. Accordingly, in one embodiment the concentration of impurities present in the carbon materials is determined by PIXE analysis.

Another useful analytical method is total reflection x-ray fluorescence (TXRF). This technique is capable of measuring the concentration of elements having atomic numbers ranging from 11 to 92 at low ppm levels. Accordingly, in one embodiment the concentration of impurities present in the carbon materials is determined by TXRF analysis.

Techniques and equipment for measuring other parameters (e.g., temperature and time) of embodiments of the present method are well known and will be readily apparent to those skilled in the art. In addition, where applicable, certain aspects of the methods disclosed herein are automated (e.g., temperature programs, including hold times and ramp rates).

### D. Devices Comprising the Carbon Materials

1. EDLCs

The disclosed methods provide carbon materials that can be used as electrode material in any number of electrical energy storage and distribution devices. One such device is an ultracapacitor. Ultracapacitors comprising carbon materials are described in detail in co-owned U.S. Pat. No. 7,835,136 which is hereby incorporated in its entirety. Certain embodiments of the present method provide carbon materials or related compositions having properties described in co-owned U.S. Pat. Nos. 8,293,818; 7,816,413; 8,404,384; 8,916,296; 8,654,507; 9,269,502; 9,409,777; and PCT Pub. No. WO 2007/061761, WO 2017/066703 which are hereby incorporated in its entirety.

EDLCs use electrodes immersed in an electrolyte solution as their energy storage element. Typically, a porous separator immersed in and impregnated with the electrolyte ensures that the electrodes do not come in contact with each other, preventing electronic current flow directly between the electrodes. At the same time, the porous separator allows ionic currents to flow through the electrolyte between the electrodes in both directions thus forming double layers of charges at the interfaces between the electrodes and the electrolyte.

When electric potential is applied between a pair of electrodes of an EDLC, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the EDLCS through orientation and alignment of molecules of the electrolytic solution under influence of the electric field induced by the potential. This mode of energy storage, however, is secondary.

EDLCs comprising the carbon material produced from the disclosed methods can be employed in various electronic devices where high power is desired. Furthermore, the cost of producing such electronic devices is drastically reduced based on the improved methods for preparing carbon materials disclosed herein.

Accordingly, in one embodiment an electrode comprising the carbon materials is provided. In another embodiment, the electrode comprises activated carbon material. In a further embodiment, an ultracapacitor comprising an electrode comprising the carbon materials is provided. In a further embodiment of the foregoing, the ultrapure carbon material comprises an optimized balance of micropores and mesopores and described above.

The disclosed methods for producing carbon materials find utility in any manufacture of a number of electronic devices, for example wireless consumer and commercial devices such as digital still cameras, notebook PCs, medical devices, location tracking devices, automotive devices, compact flash devices, mobiles phones, PCMCIA cards, handheld devices, and digital music players. Ultracapacitors are also employed in heavy equipment such as: excavators and other earth moving equipment, forklifts, garbage trucks, cranes for ports and construction and transportation systems such as buses, automobiles and trains.

Accordingly, in certain embodiments the present disclosure provides method for preparing an electrical energy storage device comprising any of the foregoing methods and carbon materials provided therefrom, for example a carbon material comprising a pore structure, the pore structure comprising micropores, mesopores and a total pore volume, wherein from 20% to 80% of the total pore volume resides in micropores and from 20% to 80% of the total pore volume resides in mesopores and less than 10% of the total pore volume resides in pores greater than 20 nm.

In some embodiments, a method for producing an electric double layer capacitor (EDLC) device is provided, wherein the EDLC comprising:

a) a positive electrode and a negative electrode wherein each of the positive and the negative electrodes comprise the carbon material;

b) an inert porous separator; and

c) an electrolyte;

wherein the positive electrode and the negative electrode are separated by the inert porous separator.

One embodiment provides a method for preparing an ultracapacitor device comprising a gravimetric power of at least 5 W/g, at least 10 W/g, at least 15 W/g, at least 20 W/g, at least 25 W/g, at least 30 W/g, at least 35 W/g, at least 50 W/g. In another embodiment, a method for preparing an ultracapacitor device comprises a volumetric power of at least 2 W/g, at least 4 W/cc, at least 5 W/cc, at least 10 W/cc, at least 15 W/cc or at least 20 W/cc is provided. In another embodiment, the ultracapacitor device comprises a gravimetric energy of at least 2.5 Wh/kg, at least 5.0 Wh/kg, at least 7.5 Wh/kg, at least 10 Wh/kg, at least 12.5 Wh/kg, at least 15.0 Wh/kg, at least 17.5. Wh/kg, at least 20.0 Wh/kg, at least 22.5 wh/kg, or at least 25.0 Wh/kg. In another embodiment, an ultracapacitor device comprises a volumetric energy of at least 1.5 Wh/liter, at least 3.0 Wh/liter, at least 5.0 Wh/liter, at least 7.5 Wh/liter, at least 10.0 Wh/liter, at least 12.5 Wh/liter, at least 15 Wh/liter, at least 17.5 Wh/liter or at least 20.0 Wh/liter.

In some embodiments of the foregoing, the gravimetric power, volumetric power, gravimetric energy and volumetric energy of an ultracapacitor device are measured by constant current discharge from 2.7 V to 1.89 V employing a 1.0 M solution of tetraethylammonium-tetrafluroroborate in acetonitrile (1.0 M TEATFB in AN) electrolyte and a 0.5 second time constant.

In one embodiment, an ultracapacitor device comprises a gravimetric power of at least 10 W/g, a volumetric power of at least 5 W/cc, a gravimetric capacitance of at least 100 F/g (@0.5 A/g) and a volumetric capacitance of at least 10 F/cc (@0.5 A/g). In one embodiment, the aforementioned ultracapacitor device is a coin cell double layer ultracapacitor comprising the carbon material, a conductivity enhancer, a binder, an electrolyte solvent, and an electrolyte salt. In further embodiments, the aforementioned conductivity enhancer is a carbon black and/or other conductivity enhancer known in the art. In further embodiments, the aforementioned binder is Teflon and or other binder known in the art. In further aforementioned embodiments, the electrolyte solvent is acetonitrile or propylene carbonate, or other electrolyte solvent(s) known in the art. In further aforementioned embodiments, the electrolyte salt is tetraethylaminotetrafluoroborate or triethylmethyl aminotetrafluoroborate or other electrolyte salt known in the art, or liquid electrolyte known in the art.

In one embodiment, an ultracapacitor device comprises a gravimetric power of at least 15 W/g, a volumetric power of at least 10 W/cc, a gravimetric capacitance of at least 110 F/g (@0.5 A/g) and a volumetric capacitance of at least 15 F/cc (@0.5 A/g). In one embodiment, the aforementioned ultracapacitor device is a coin cell double layer ultracapacitor comprising the carbon material, a conductivity enhancer, a binder, an electrolyte solvent, and an electrolyte salt. In further embodiments, the aforementioned conductivity enhancer is a carbon black and/or other conductivity enhancer known in the art. In further embodiments, the aforementioned binder is Teflon and or other binder known in the art. In further aforementioned embodiments, the electrolyte solvent is acetonitrile or propylene carbonate, or other electrolyte solvent(s) known in the art. In further aforementioned embodiments, the electrolyte salt is tetraethylaminotetrafluroborate or triethylmethyl aminotetrafluoroborate or other electrolyte salt known in the art, or liquid electrolyte known in the art.

In one embodiment, an ultracapacitor device comprises a gravimetric capacitance of at least 90 F/g, at least 95 F/g, at least 100 F/g, at least 105 F/g, at least 110 F/g, at least 115 F/g, at least 120 F/g, at least 125 F/g, or at least 130 F/g. In another embodiment, an ultracapacitor device comprises a volumetric capacitance of at least 5 F/cc, at least 10 F/cc, at least 15 F/cc, at least 20 F/cc, or at least 25 F/cc. In some embodiments of the foregoing, the gravimetric capacitance and volumetric capacitance are measured by constant current discharge from 2.7 V to 0.1 V with a 5-second time constant and employing a 1.8 M solution of tetraethylammonium-tetrafluoroborate in acetonitrile (1.8 M TEATFB in AN) electrolyte and a current density of 0.5 A/g, 1.0 A/g, 4.0 A/g or 8.0 A/g.

In still other embodiments, the EDLC device comprises a gravimetric capacitance of at least of at least 13 F/cc as measured by constant current discharge from 2.7 V to 0.1 V and with at least 0.24 Hz frequency response and employing a 1.8 M solution of tetraethylammonium-tetrafluoroborate in acetonitrile electrolyte and a current density of 0.5 A/g. Other embodiments include an EDLC device, wherein the EDLC device comprises a gravimetric capacitance of at least of at least 17 F/cc as measured by constant current discharge from 2.7 V to 0.1 V and with at least 0.24 Hz frequency response and employing a 1.8 M solution of tetraethylammonium-tetrafluoroborate in acetonitrile electrolyte and a current density of 0.5 A/g.

As noted above, embodiments of the present methods can include modifying carbon material for incorporation into ultracapacitor devices. In some embodiments, the carbon material is milled to an average particle size of about 10 microns using a jet-mill according to the art. While not wishing to be bound by theory, it is believed that this fine particle size enhances particle-to-particle conductivity, as well as enabling the production of very thin sheet electrodes. The jet-mill essentially grinds the carbon against itself by spinning it inside a disc shaped chamber propelled by high-pressure nitrogen. As the larger particles are fed in, the centrifugal force pushes them to the outside of the chamber; as they grind against each other, the particles migrate towards the center where they eventually exit the grinding chamber once they have reached the appropriate dimensions.

In further embodiments, after jet-milling the carbon material, it is blended with a fibrous Teflon binder (3% by weight) to hold the particles together in a sheet. The carbon material/Teflon mixture is kneaded until a uniform consistency is reached. Then the mixture is rolled into sheets using a high-pressure roller-former that results in a final thickness of 50 microns. These electrodes are punched into discs and heated to 195° C. under a dry argon atmosphere to remove water and/or other airborne contaminants. The electrodes are weighed and their dimensions measured using calipers.

The carbon electrodes of the EDLCs are wetted with an appropriate electrolyte solution. Examples of solvents for use in electrolyte solutions for use in the devices of the present application include but are not limited to propylene carbonate, ethylene carbonate, butylene carbonate, dimethyl carbonate, methyl ethyl carbonate, diethyl carbonate, sulfolane, methylsulfolane and acetonitrile. Such solvents are generally mixed with solute, including, tetralkylammonium salts such as TEATFB (tetraethylammonium tetrafluoroborate); TEMATFB (tri-ethyl, methylammonium tetrafluoroborate); EMITFB (1-ethyl-3-methylimidazolium tetrafluoroborate), tetramethylammonium or triethylammonium based salts. Further the electrolyte can be a water-based acid or base electrolyte such as mild sulfuric acid or potassium hydroxide.

In some embodiments, the electrodes are wetted with a 1.0 M solution of tetraethylammonium-tetrafluoroborate in acetonitrile (1.0 M TEATFB in AN) electrolyte. In other embodiments, the electrodes are wetted with a 1.0 M solution of tetraethylammonium-tetrafluoroborate in propylene carbonate (1.0 M TEATFB in PC) electrolyte. These are common electrolytes used in both research and industry and are considered standards for assessing device performance. In other embodiments, the symmetric carbon-carbon (C-C) capacitors are assembled under an inert atmosphere, for example, in an Argon glove box, and a NKK porous membrane 30 micron thick serves as the separator. Once assembled, the samples may be soaked in the electrolyte for about 20 minutes or more depending on the porosity of the sample.

In some embodiments, the capacitance and power output are measured using cyclic voltammetry (CV), chronopotentiometry (CP) and impedance spectroscopy at various voltages (ranging from 1.0-2.5 V maximum voltage) and current levels (from 1-10 mA) on a Biologic VMP3 electrochemical workstation. In this embodiment, the capacitance may be calculated from the discharge curve of the potentiogram using the formula:

$$C = \frac{I \times Δ t}{Δ V} \qquad Equation 1$$

where I is the current (A) and ΔV is the voltage drop, Δt is the time difference. Because in this embodiment the test capacitor is a symmetric carbon-carbon (C—C) electrode, the specific capacitance is determined from:

Cₛ=2C/mₑ Equation 2

where mₑ is the mass of a single electrode. The specific energy and power may be determined using:

$$\begin{matrix}{E}_{s} = \frac{1}{4} \frac{{CV}_{max}^{2}}{{m}_{e}} & Equation 3 \\ {P}_{s} = {E}_{s} / 4 ESR & Equation 4\end{matrix}$$

where C is the measured capacitance Vₘₐₓ is the maximum test voltage and ESR is the equivalent series resistance obtained from the voltage drop at the beginning of the discharge. ESR can alternately be derived from impedance spectroscopy.

2. Batteries

The disclosed methods for providing carbon materials also find utility in manufacture of electrodes in any number of types of batteries. One such battery is the metal air battery, for example lithium air batteries. Lithium air batteries generally comprise an electrolyte interposed between positive electrode and negative electrodes. The positive electrode generally comprises a lithium compound such as lithium oxide or lithium peroxide and serves to oxidize or reduce oxygen. The negative electrode generally comprises a carbonaceous substance which absorbs and releases lithium ions. As with supercapacitors, methods of preparing batteries such as lithium air batteries that include embodiments of the methods disclosed herein are expected to be superior to batteries comprising other known carbon materials. Accordingly, one embodiment provides a method for preparing metal air battery, for example a lithium air battery.

Any number of other batteries, for example, zinc-carbon batteries, lithium/carbon batteries, lead acid batteries and the like are also expected to perform better with the method. One skilled in the art will recognize other specific types of carbon containing batteries which will benefit from the disclosed methods.

For example, embodiments of the present method may produce carbon materials that are particularly useful in lead acid batteries. Specifically, embodiments of the present method can produce low-gassing carbon materials (e.g., particles) for use in lead acid and related battery systems. These carbon materials provide certain electrochemical enhancements, including, but not limited to, increased charge acceptance and improved cycle life, while also providing very low gas generation compared to previously disclosed carbon materials for this purpose. The low-gassing carbon can be provided as a powder comprised of low-gassing carbon particles, and this powder can be blended with lead particles to create a blend of low-gassing carbon and lead particles.

Accordingly, in another embodiment the present invention provides a method for preparing a battery, in particular a zinc/carbon, a lithium/carbon batteries or a lead acid battery comprising the method as disclosed herein.

One embodiment is directed to a method for preparing an electrical energy storage device, for example, a lead/acid battery; some embodiments provide a method for preparing a lead/acid battery comprising:

a) at least one positive electrode comprising a first active material in electrical contact with a first current collector;

b) at least one negative electrode comprising a second active material in electrical contact with a second current collector; and

c) an electrolyte;

wherein the positive electrode and the negative electrode are separated by an inert porous separator, and wherein at least one of the first or second active materials comprises the carbon material.

In other embodiments, the electrical energy storage device comprises one or more lead-based positive electrodes and one or more carbon-based negative electrodes, and the carbon-based electrode comprises a carbon-lead blend. In other embodiments of the disclosed device, both positive and negative electrode components optionally comprise carbon, for example, carbon materials prepared according to embodiments disclosed herein.

In further embodiments of the foregoing, the positive and/or negative electrodes further comprise one or more other elements in addition to lead and carbon material which act to enhance the performance of the active materials. Such other elements include, but are not limited to, lead, tin, antimony, bismuth, arsenic, tungsten, silver, zinc, cadmium, indium, sulfur, silicon and combinations thereof as well as oxides of the same and compounds comprising the same.

Blends of carbon materials and lead find utility in electrodes for use in lead acid batteries. Accordingly, one embodiment provides a hybrid lead-carbon-acid electrical energy storage device comprising at least one cell, wherein the at least one cell comprises a plurality of carbon material-lead-based positive electrodes and one or more carbon material-lead-based negative electrodes. The device further comprises separators between the cells, an acid electrolyte (e.g., aqueous sulfuric acid), and a casing to contain the device.

In some embodiments of the hybrid lead-carbon-acid energy storage device, each carbon-based negative electrode comprises a highly conductive current collector; a carbon material-lead blend adhered to and in electrical contact with at least one surface of the current collector, and a tab element extending above the top edge of the negative or positive electrode. For example, each carbon material-lead-based positive electrode may comprise a lead-based current collector and a lead dioxide-based active material paste adhered to, and in electrical contact with, the surfaces thereof, and a tab element extending above the top edge of the positive electrode. Generally, the lead or lead oxide in a blend serves as the energy storing active material for the cathode.

In other embodiments of the hybrid lead-carbon-acid energy storage device, the front and back surfaces of a lead-based current collector each comprise a matrix of raised and lowered portions with respect to the mean plane of the lead-based current collector, and further comprises slots formed between the raised and lowered portions thereof. In this embodiment, the aggregate thickness of the lead-based current collector is greater than the thickness of the lead-based material forming the current collector.

A negative electrode may comprise a conductive current collector; a carbon material-lead blend; and a tab element extending from a side, for example from above a top edge, of the negative electrode. Negative electrode tab elements may be electrically secured to one another by a cast-on strap, which may comprise a connector structure. The active material may be in the form of a sheet that is adhered to, and in electrical contact, with the current collector matrix. In order for the blend to be adhered to and in electrical contact with the current collector matrix, the blend may be mixed with a suitable binder substance such as PTFE or ultra-high molecular weight polyethylene (e.g., having a molecular weight numbering in the millions, usually between about 2 and about 6 million). In some embodiments, the binder material does not exhibit thermoplastic properties or exhibits minimal thermoplastic properties.

In certain embodiments, each battery cell comprises four positive electrodes which are lead-based and comprise lead dioxide active material. Each positive electrode comprises a highly conductive current collector comprising porous carbon material (e.g., a carbon-lead blend) adhered to each face thereof and lead dioxide contained within the carbon. Also, in this embodiment, the battery cell comprises three negative electrodes, each of which comprises a highly conductive current collector comprising porous carbon material adhered to each face thereof where this porous carbon material comprises lead within the carbon.

In other embodiments, each cell comprises a plurality of positive electrodes and a plurality of negative electrodes that are placed in alternating order. Between each adjacent pair of positive electrodes and the negative electrodes, there is placed a separator. Each of the positive electrodes is constructed so as to have a tab extending above the top edge of each respective electrode; and each of the negative electrodes has a tab extending above the top edge of each of the respective negative electrodes. In certain variations, the separators are made from a suitable separator material that is intended for use with an acid electrolyte, and that the separators may be made from a woven material such as a non-woven or felted material, or a combination thereof. In other embodiments, the material of the current collector is sheet lead, which may be cast or rolled and punched or machined.

Each cell may comprise alternating positive and negative plates, and an electrolyte may be disposed in a volume between the positive and negative plates. Additionally, the electrolyte can occupy some or all of the pore space in the materials included in the positive and negative plates. In one embodiment, the electrolyte includes an aqueous electrolytic solution within which the positive and negative plates may be immersed. The electrolytic solution composition may be chosen to correspond with particular battery chemistry. In lead acid batteries, for example, the electrolyte may include a solution of sulfuric acid and distilled water. Other acids, however, may be used to form the electrolytic solutions of the disclosed batteries.

In another embodiment, the electrolyte may include a silica gel. This silica gel electrolyte can be added to the battery such that the gel at least partially fills a volume between the positive and negative plate or plates of cell.

In some other variations, the positive and negative plates of each cell may include a current collector packed or coated with a chemically active material. Chemical reactions in the active material disposed on the current collectors of the battery enable storage and release of electrical energy. The composition of this active material, and not the current collector material, determines whether a particular current collector functions either as a positive or a negative plate.

A composition of a chemically active material also depends on the chemistry of the device. For example, lead acid batteries may include a chemically active material comprising, for example, an oxide or salt of lead. In certain embodiments, the chemically active material may comprise lead dioxide (PbO₂). The chemically active material may also comprise various additives including, for example, varying percentages of free lead, structural fibers, conductive materials, carbon, and extenders to accommodate volume changes over the life of the battery. In certain embodiments, the constituents of the chemically active material for lead acid batteries may be mixed with sulfuric acid and water to form a paste, slurry, or any other type of coating material.

A chemically active material in the form of a paste or slurry, for example, may be applied to the current collectors of the positive and negative plates. A chemically active material may be applied to the current collectors by dipping, painting, or via any other suitable coating technique.

In certain embodiments, positive and negative plates of a battery are formed by first depositing a chemically active material on the corresponding current collectors to make the plates. While not necessary in all applications, in certain embodiments, the chemically active material deposited on current collectors may be subjected to curing and/or drying processes. For example, a curing process may include exposing the chemically active materials to elevated temperature and/or humidity to encourage a change in the chemical and/or physical properties of the chemically active material.

After assembling the positive and negative plates to form cells, the battery may be subjected to a charging (i.e., formation) process. During this charging process, a composition of chemically active materials may change to a state that provides an electrochemical potential between the positive and negative plates of the cells. For example, in a lead acid battery, the PbO active material of the positive plate may be electrically driven to lead dioxide (PbO₂), and the active material of the negative plate may be converted to sponge lead. Conversely, during subsequent discharge of a lead acid battery, the chemically active materials of both the positive and negative plates convert toward lead sulfate.

Blends comprising carbon materials prepared by embodiments of the present disclosure include a network of pores, which can provide a large amount of surface area for each current collector. For example, in certain embodiments of the above described devices the carbon materials are mesoporous, and in other embodiments the carbon materials are microporous. Further, a carbon layer may be fabricated to exhibit any combination of physical properties described above.

A substrate (i.e., support) for the active material may include several different material and physical configurations. For example, in certain embodiments, the substrate may comprise an electrically conductive material, glass, or a polymer. In certain embodiments, the substrate may comprise lead or polycarbonate. The substrate may be formed as a single sheet of material. Alternatively, the substrate may comprise an open structure, such as a grid pattern having cross members and struts.

A substrate may also comprise a tab for establishing an electrical connection to a current collector. Alternatively, especially in embodiments where substrate includes a polymer or material with low electrical conductivity, a carbon material layer may be configured to include a tab of material for establishing an electrical connection with a current collector. In such an embodiment, the carbon material used to form a tab and the carbon material layer may be infused with a metal such as lead, silver, or any other suitable metal for aiding in or providing good mechanical and electrical contact to the carbon material layer.

Blends comprising carbon material prepared by embodiments of the present disclosure may be physically attached to a substrate such that the substrate can provide support for the blend. In one embodiment, the blend may be laminated to the substrate. For example, the blend and substrate may be subjected to any suitable laminating process, which may comprise the application of heat and/or pressure, such that the blend becomes physically attached to the substrate. In certain embodiments, heat and/or pressure sensitive laminating films or adhesives may be used to aid in the lamination process.

In other embodiments, the blend may be physically attached to the substrate via a system of mechanical fasteners. This system of fasteners may comprise any suitable type of fasteners capable of fastening a carbon material layer to a support. For example, a blend may be joined to a support using staples, wire or plastic loop fasteners, rivets, swaged fasteners, screws, etc. Alternatively, a blend can be sewn to a support using wire thread, or other types of thread. In some of the embodiments, a blend may further comprise a binder (e.g., Teflon and the like) to facilitate attachment of the blend to the substrate.

Another embodiment provides a method for preparing a metal-air battery. For example a metal-air battery comprising:

a) an air cathode comprising the disclosed mesoporous carbon materials comprising a bi-functional catalyst;

b) a metal anode; and

c) an electrolyte.

In another embodiment, the present disclosure provides a metal-air battery comprising:

a) an air cathode comprising the disclosed mesoporous carbon materials comprising a metal, wherein the metal comprises lead, tin, antimony, bismuth, arsenic, tungsten, silver, zinc, cadmium, indium or combinations thereof;

b) a metal anode; and

c) an electrolyte.

In one particular embodiment of the foregoing battery, the metal comprises silver.

Active materials within the scope of the present disclosure include materials capable of storing and/or conducting electricity. The active material can be any active material known in the art and useful in lead acid batteries, for example the active material may comprise lead, lead (II) oxide, lead (IV) oxide, or combinations thereof and may be in the form of a paste.

In one embodiment, the present disclosure provides a metal-air battery comprising:

a) an air cathode comprising the disclosed mesoporous carbon materials comprising a bi-functional catalyst;

b) a metal anode;

c) a secondary carbon anode; and

d) an electrolyte.

In the above embodiment, the secondary carbon anode acts as an ultracapacitor or electric double layer capacitor (EDLC) anode. In certain embodiments, the carbons used in this secondary anode are microporous and provide high capacitance. In particular embodiments the carbons are ultrapure or comprise an optimized blend of micropores and mesopores.

Another embodiment of any of the above devices, the carbon material comprises the same micropore to mesopore distribution but at a lower surface area range. This embodiment comprises preparing the carbon material by synthesizing the same base high purity polymer composition and/or cured polymer composition that yields the same optimized micropore to mesopore volume distribution with low surface functionality upon pyrolysis (but no activation). The result of lower surface area optimized pore structure in a battery application like lead acid batteries is a maximization of an electrode formulation with a highly conductive network. It is also theorized that high mesopore volume may be an excellent structure to allow high ion mobility in many other energy storage systems such as lead acid, lithium ion, etc.

In some other embodiments of the above metal-air batteries, the metal anode comprises lithium, zinc, sodium, potassium, rubidium, cesium, francium, beryllium, magnesium, calcium, strontium barium, radium, aluminum, silicon or a combination thereof. In other embodiments, the electrolyte comprises propylene carbonate, ethylene carbonate, butylene carbonate, dimethyl carbonate, methyl ethyl carbonate, diethyl carbonate, sulfolane, methylsulfolane, acetonitrile or mixtures thereof in combination with one or more solutes, wherein the solute is a lithium salt, LiPF₆, LiBF₄, LiClO₄ tetralkylammonium salt, TEA TFB (tetraethylammonium tetrafluoroborate), MTEATFB (methyltriethylammonium tetrafluoroborate), EMITFB (1-ethyl-3-methylimidazolium tetrafluoroborate), tetraethylammonium or a triethylammonium based salt.

In yet other embodiments of the foregoing batteries, the bi-functional catalyst comprises iron, nickel, cobalt, manganese, copper, ruthenium, rhodium, palladium, osmium, iridium, gold, halfnium, platinum, titanium, rhenium, tantalum, thallium, vanadium, niobium, scandium, chromium, gallium, zirconium, molybdenum or combinations thereof. For example, in some specific embodiments, the bi-functional catalyst comprises nickel. In other embodiments, the bi-functional catalyst comprises iron, and in other embodiments, the bi-functional catalyst comprises manganese.

In other embodiments, the bi-functional catalyst comprises a carbide compound. For example, in some aspects the carbide compound comprises lithium carbide, magnesium carbide, sodium carbide, calcium carbide, boron carbide, silicon carbide, titanium carbide, zirconium carbide, hafnium carbide, vanadium carbide, niobium carbide, tantalum carbide, chromium carbide, molybdenum carbide, tungsten carbide, iron carbide, manganese carbide, cobalt carbide, nickel carbide or a combination thereof. In certain embodiments, the carbide compound comprises tungsten carbide.

The cathode can be engineered to create an environment in which the electrolyte can be controlled based on the wetting characteristics of the surface of the mesoporous carbon. For example, a mesoporous carbon can be produced where the outer surface of the mesoporous carbon tends to repel the electrolyte to allow for gas diffusion but the inner pore surfaces attract electrolyte to encourage good ion diffusion within the pores. In some embodiments, the inner surfaces of pores of the mesoporous carbon are wetted by the electrolyte, while the external surface of the mesoporous carbon is not significantly wetted by the electrolyte. Still in other embodiments, the inner surfaces of pores of the mesoporous carbon are not wetted by the electrolyte, while the outer surface of the mesoporous carbon is wetted by the electrolyte. In some embodiments there is a mixture of particles where some particles are not wetted by the electrolyte and act as gas diffusion channels and other particles are preferentially wetted by the electrolyte and act as ion diffusion channels.

While the electrolyte can be any electrolyte known to one skilled in the art, in some instances the electrolyte comprises propylene carbonate. In other embodiments, the electrolyte comprises dimethyl carbonate. Still in other embodiments, the electrolyte comprises ethylene carbonate. Yet in other embodiments, the electrolyte comprises diethyl carbonate. In other embodiments, the electrolyte comprises an ionic liquid. A wide variety of ionic liquids are known to one skilled in the art including, but not limited to, imidazolium salts, such as ethylmethylimidazolium hexafluorophosphate (EMIPF6) and 1,2-dimethyl-3-propyl imidazolium [(DMPIX)Im]. See, for example, McEwen et al., “Nonaqueous Electrolytes and Novel Packaging Concepts for Electrochemical Capacitors,” The 7th International Seminar on Double Layer Capacitors and Similar Energy Storage Devices, Deerfield Beach, Fla. (Dec. 8-10, 1997).

For a rechargeable Li-air batteries, typically a bi-functional catalyst (or in certain embodiments, another metal) is incorporated to assist with oxygen evolution and oxygen reduction. The mesoporous carbon processing can be modified to produce a desired catalyst structure on the inner pore surfaces of the mesoporous carbon.

Mesoporous carbons of the disclosure can be used to aid in the fast charge-discharge capability of the lithium electrode. Mesoporous carbons can be used as electrodes for electrolytic double layer capacitors. Mesoporous carbon of the invention can be added as a separate component in electrical contact with the lithium electrode. In some embodiments, the double layer capacitance of the air electrode is matched at least partially by this second carbon anode. In other embodiments, a double layer is established on the mesoporous carbon. Such configuration allows rapid charge and discharge and can also be pulsed rapidly. It is believed that such pulsing minimizes the negative effects of rapid charge-discharge on battery life. The mesoporous carbon need not be in physical contact with the lithium or on the same side of the separator to contribute the fast discharge capability of the lithium-air battery. In other embodiments of the foregoing, the separate component in electrical contact (e.g., electrode) is a microporous carbon.

### EXAMPLES

The carbon materials disclosed in the following Examples were prepared according to the methods disclosed herein. Chemicals were obtained from commercial sources at reagent grade purity or better and were used as received from the supplier without further purification.

### Example 1

### Preparation of Carbon Material

Exemplary carbon material was synthesized using a polymer prepared from resorcinol and formaldehyde in a water/acetic acid solvent in the presence of ammonium acetate catalyst. The reagents were added to the reaction mixture in the amounts indicated in Table 1 below.

TABLE 1
Reagents used to prepare exemplary carbon material

| Reagent | Amount (wt. %) |
|---|---|
| water | 23.8% |
| resorcinol | 30.3% |
| ammonium acetate | 0.28%-0.42% |
| acetic acid | 5.5% |
| formaldehyde (37 wt. % in water) | 40.1% |

Water, acetic acid (glacial), resorcinol and ammonium acetate were mixed in a kettle reactor and heated to 30° C. To the resultant mixture, the formaldehyde solution was added. The temperature of the resulting reaction mixture was maintained at between 39-50° C. for 0 to 6 hours. The reaction mixture was then cooled to 20-30° C. and transferred to 250 mL-1 L polypropylene bottles via decantation.

The refractive index (RI) of the reaction mixture was measured following the transfer and ranged from 1.4255 to 1.4369. It was determined that the RI of the reaction mixture varied as a function of the period of time when the combining was complete (e.g., from 0 to 6 hours) when temperature is held to be constant (e.g., 39-40° C.). The refractive index for each sample is given in Table 2 below:

TABLE 2
Refractive index based on variable reaction time

| Reaction Time | Refractive |
|---|---|
| (hours) | Index |
| 0 | 1.42224 |
| 1 | 1.42446 |
| 2 | 1.42722 |
| 3 | 1.42973 |
| 4 | 1.4321 |
| 5 | 1.43451 |
| 6 | 1.43692 |

The decanted reaction mixture was either placed in a fume hood or secured in an insulated box fitted with a thermocouple. As the polymer composition formed during this holding step, the heat generated by the exothermic co-polymerization reaction caused a temperature increase over the following 0.1-10 hours. The extent of the temperature increase, average rate of temperature increase, and maximum rate of temperature increase was correlated to the RI measurement at decant as shown in Table 3 below. The degree of heating also varied as a function of the surface area to volume ratio of the reaction vessel receiving the decanted reaction mixture.

TABLE 3
Refractive index compared to maximum hold temperature,
average holding ramp rate, and maximum holding
ramp rate for exemplary carbon materials

| | Maximum | Average | Maximum |
|---|---|---|---|
| Refractive | Holding | Holding | Holding |
| Index | Temperature | Ramp Rate | Ramp Rate |
| at Decant | (° C.) | (° C./hour) | (° C./hour) |
| 1.4285 | 110 | 29.5 | 266 |
| 1.42718 | 115 | 31.2 | 343 |
| 1.42564 | 125 | 34.7 | 350 |
| 1.42459 | 110 | 29.8 | 390 |
| 1.43692 | 55 | 4.5 | 8 |
| 1.43539 | 60 | 5.6 | 10 |
| 1.4332 | 77 | 9.6 | 34 |
| 1.43049 | 87 | 12.6 | 75 |
| 1.43454 | 62 | 5.0 | 14 |
| 1.434 | 65 | 5.4 | 17 |
| 1.43272 | 71 | 6.7 | 26 |
| 1.4324 | 73 | 6.7 | 30 |
| 1.43488 | 62 | 4.9 | 16 |
| 1.43474 | 62 | 4.7 | 13 |
| 1.43337 | 64 | 4.9 | 16 |
| 1.43301 | 67 | 5.5 | 21 |
| 1.43655 | 67.5 | 5.3 | 15 |
| 1.43655 | 56 | 3.6 | 8 |
| 1.43655 | 36.5 | 1.1 | 1 |
| 1.4349 | 63 | 5.5 | 15 |
| 1.43505 | 50 | 2.8 | 7 |
| 1.43438 | 53.5 | 2.8 | 7 |
| 1.43491 | 45.5 | 2.4 | 4 |
| 1.43418 | 52.5 | 3.1 | 8 |
| 1.43448 | 51.5 | 2.8 | 6 |
| 1.43411 | 51.5 | 2.7 | 6 |
| 1.4301 | 75.5 | 7.2 | 35 |
| 1.43292 | 63.5 | 4.2 | 14 |
| 1.43402 | 57.5 | 3.5 | 10 |
| 1.43611 | 46.5 | 2.4 | 4 |
| 1.4255 | 100 | 9.9 | 146 |
| 1.42719 | 92 | 8.9 | 90 |
| 1.42848 | 84 | 7.4 | 60 |
| 1.43016 | 77 | 6.2 | 37 |
| 1.42841 | 85.5 | 5.9 | 60 |
| 1.42795 | 87.5 | 8.9 | 75 |
| 1.42643 | 96 | 10.0 | 130 |
| 1.42686 | 92 | 9.5 | 103 |
| 1.43444 | 27 | 1.0 | 1 |
| 1.4285 | 110 | 29.5 | 266 |
| 1.42718 | 115 | 31.2 | 343 |
| 1.42564 | 125 | 34.7 | 350 |

After approximately 24 hours in the holding environment (e.g., insulated box), the polymer composition was removed and placed in an oven to cure. The oven was setup to ramp from 30° C. to 95° C. over 24-72 hours and hold at 95° C. for an additional 24 hours. The resulting cured polymer compositions were fractured and removed from the polypropylene bottles and placed in a tube furnace to pyrolyze under nitrogen atmosphere.

During pyrolysis of the cured polymer composition, nitrogen was set to flow through the tube furnace and the furnace was set to heat from 20° C. to 900° C. over 45 minutes and hold at 900° C. for an additional 60 minutes. During pyrolysis, the cured polymer composition was dried and pyrolyzed thereby removing moisture, oxygen, and hydrogen to afford the pure carbon material.

The resulting carbon material was tested to determine mesopore volume, pore size distribution, and surface area by gas sorption. The resulting mesopore volume and size distribution were functions of the maximum temperature reached during the holding step and the temperature ramp rate. The final pore volume can be compared to the maximum holding temperature, as shown by the data in Table 4 below:

TABLE 4
Mesopore volume compared to the maximum hold temperature,
average holding ramp rate, and maximum holding
ramp rate for exemplary carbon materials

| Average | Maximum | | |
|---|---|---|---|
| Holding | Holding | Max Hold | |
| Ramp Rate | Ramp Rate | Temperature | Pore Volume |
| (° C./hour) | (° C./hour) | (° C.) | (cm³/g) |
| 29.5 | 266 | 110 | 1.0747 |
| 31.2 | 343 | 115 | 1.0613 |
| 34.7 | 350 | 125 | 1.0849 |
| 29.8 | 390 | 110 | 1.1152 |
| 4.5 | 8 | 55 | 0.5809 |
| 5.6 | 10 | 60 | 0.6295 |
| 9.6 | 34 | 77 | 0.8517 |
| 12.6 | 75 | 87 | 0.9675 |
| 5.0 | 14 | 62 | 0.7624 |
| 5.4 | 17 | 65 | 0.7129 |
| 6.7 | 26 | 71 | 0.7501 |
| 6.7 | 30 | 73 | 0.7868 |
| 4.9 | 16 | 62 | 0.6827 |
| 4.7 | 13 | 62 | 0.5904 |
| 4.9 | 16 | 64 | 0.6397 |
| 5.5 | 21 | 67 | 0.7164 |
| 5.3 | 15 | 67.5 | 0.6521 |
| 3.6 | 8 | 56 | 0.5812 |
| 1.1 | 1 | 36.5 | 0.4353 |
| 5.5 | 15 | 63 | 0.6802 |
| 2.8 | 7 | 50 | 0.5583 |
| 2.8 | 7 | 53.5 | 0.5507 |
| 2.4 | 4 | 45.5 | 0.5202 |
| 3.1 | 8 | 52.5 | 0.5551 |
| 2.8 | 6 | 51.5 | 0.5123 |
| 2.7 | 6 | 51.5 | 0.5234 |
| 7.2 | 35 | 75.5 | 0.8362 |
| 4.2 | 14 | 63.5 | 0.6609 |
| 3.5 | 10 | 57.5 | 0.5775 |
| 2.4 | 4 | 46.5 | 0.4908 |
| 9.9 | 146 | 100 | 1.0531 |
| 8.9 | 90 | 92 | 0.9943 |
| 7.4 | 60 | 84 | 0.9723 |
| 6.2 | 37 | 77 | 0.8627 |
| 5.9 | 60 | 85.5 | 0.9911 |
| 8.9 | 75 | 87.5 | 1.0057 |
| 10.0 | 130 | 96 | 1.0545 |
| 9.5 | 103 | 92 | 0.9931 |
| 1.0 | 1 | 25 | 0.2845 |

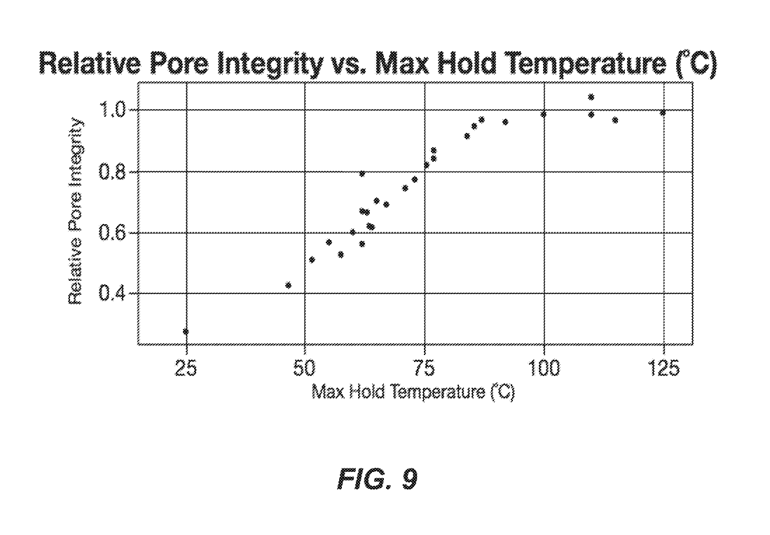

Additionally, the relative pore integrity was compared for the cured polymer compositions obtained using certain embodiments of the methods disclosed herein. The data in Table 5 show a comparison of the maximum hold temperature to the relative pore integrity of the polymer in the cured polymer composition. As the data show, embodiments of the disclosed methods and compositions unexpectedly retain desirable total pore volume without any conventional drying step. Additionally, the desirable polymer compositions can produce relative pore integrity ranging from about 0.40 to about 1.00 or more. Results are also depicted in FIG. 9.

TABLE 5
Relative pore integrity compared to maximum hold time

| Max Hold Temperature (° C.) | Relative Pore Integrity |
|---|---|
| 25 | 0.27 |
| 110 | 0.98 |
| 115 | 0.96 |
| 125 | 0.99 |
| 110 | 1.04 |
| 55 | 0.57 |
| 60 | 0.60 |
| 77 | 0.87 |
| 87 | 0.97 |
| 73 | 0.13 |
| 81 | 0.14 |
| 83 | 0.12 |
| 62 | 0.79 |
| 65 | 0.70 |
| 71 | 0.74 |
| 73 | 0.77 |
| 62 | 0.67 |
| 62 | 0.56 |
| 64 | 0.62 |
| 67 | 0.69 |
| 85 | 0.92 |
| 82 | 0.92 |
| 85 | 0.80 |
| 86 | 0.72 |
| 63 | 0.66 |
| 51.5 | 0.51 |
| 75.5 | 0.82 |
| 63.5 | 0.62 |
| 57.5 | 0.53 |
| 46.5 | 0.42 |
| 100 | 0.98 |
| 92 | 0.96 |
| 84 | 0.91 |
| 77 | 0.84 |
| 60.5 | 0.61 |
| 56.5 | 0.46 |
| 60.5 | 0.50 |
| 62.5 | 0.45 |
| 85.5 | 0.95 |

### Example 2

### Mesopore Volume Variability of Carbon Material as a Function of Hold Time—Trial 1

Four sample preparations of exemplary carbon materials were synthesized according to the procedure described in Example 1 and the following parameters. The reagents were added in the amounts indicated in Table 6, below.

TABLE 6
Reagents used to prepare exemplary carbon material samples

| Reagent | Amount (wt. %) |
|---|---|
| water | 4.5% |
| resorcinol | 30% |
| ammonium acetate | 0.26% |
| acetic acid | 5.4% |
| formaldehyde | 59.9% |
| (25 wt. % in water, 0.5% methanol) | |

All reagents except formaldehyde were combined and heated to 40° C. The formaldehyde solution was pumped into the reactor over 145 minutes while maintaining a temperature between 39-40° C. The resultant reaction mixtures were cooled to 22° C. before decanting. The 4 sample preparations were held between 20° C. and 25° C. for 0, 3, 6, and 12 hours.

Following the variable hold time, samples were cured in an oven set to an initial temperature of 25° C. followed by a ramp to 95° C. at ramp rate of 1° C./hour and a 95° C. hold for an additional 24 hours. The samples were cooled, fractured and placed in a tube furnace to dry and pyrolyze under nitrogen atmosphere.

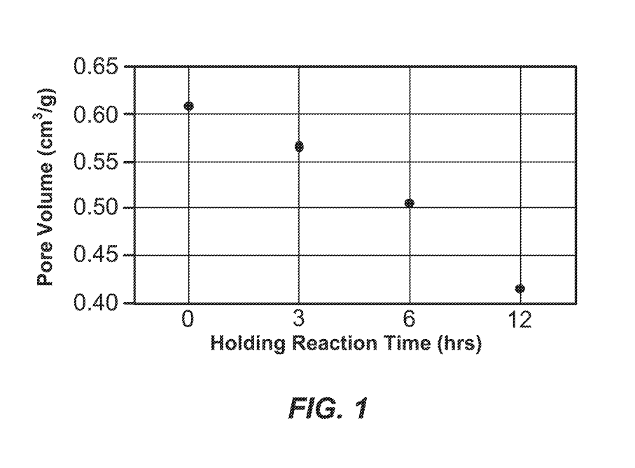

Pyrolysis of the samples was carried out under nitrogen flow starting at 20° C. and ramping to 900° C. over 45 minutes and holding at 900° C. for an additional 60 minutes. During pyrolysis, the cured polymer composition was dried and pyrolyzed thereby removing moisture, oxygen, and hydrogen to afford the pure carbon material. The resulting mesopore volume for each sample was tested by gas sorption. The results are shown in Table 7, below as well as FIG. 1:

TABLE 7
Mesopore volume for samples subjected to different hold times

| | | Mesopore Volume of |
|---|---|---|
| | Holding Time | Final Carbon Material |
| Sample | (hours) | (cm³/g) |
| 1 | 0 | 0.61 |
| 2 | 3 | 0.56 |
| 3 | 6 | 0.50 |
| 4 | 12 | 0.41 |

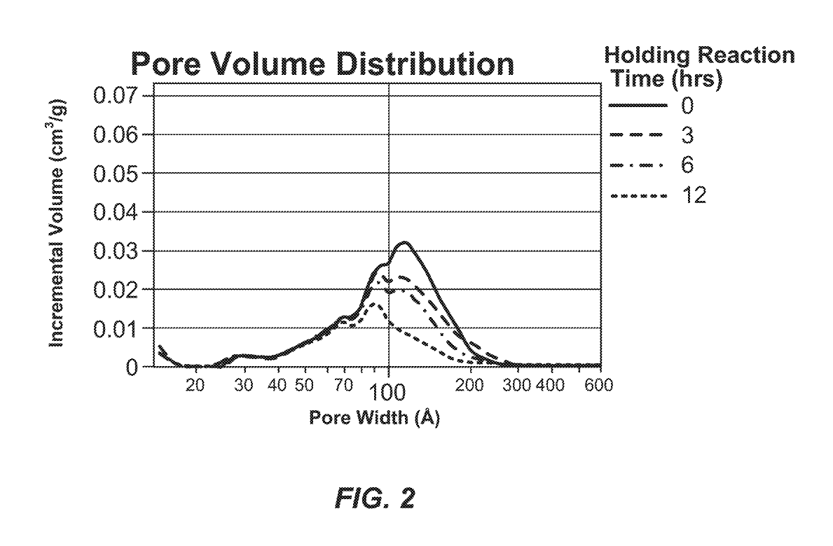

As shown by the results above, samples with longer hold times had a lower mesopore volume with the Sample 1 (0 hour hold time) having a relatively high mesopore volume of 0.61 cm³/g. Pore volume distributions are shown in FIG. 2.

### Example 3

### Mesopore Volume Variability of Carbon Material as a Function of Hold Time—Trial 2

Four sample preparations of exemplary carbon materials were synthesized according to the procedure described in Examples 1 and 2 and the following parameters. The reagents were added in the amounts indicated in Table 8, below.

TABLE 8
Reagents used to prepare exemplary carbon material samples

| Reagent | Amount (wt. %) |
|---|---|
| water | 24.0% |
| resorcinol | 30.2% |
| ammonium acetate | 0.26% |
| acetic acid | 5.5% |
| formaldehyde | 40.0% |
| (37 wt. % in water, 15% methanol) | |

All reagents except formaldehyde were combined and heated to 50° C. The formaldehyde solution was pumped into the reactor over 145 minutes while maintaining a temperature between 49-50° C. The resultant reaction mixtures were cooled to 25° C. before decanting. The 4 sample preparations were held between 20° C. and 25° C. for 0, 1.7, 3, and 5 days.

Following the variable hold time, samples were cured in an oven set to 90° C. and held for 48 hours. The samples were then cooled, fractured and placed in a tube furnace to dry and pyrolyze under nitrogen atmosphere.

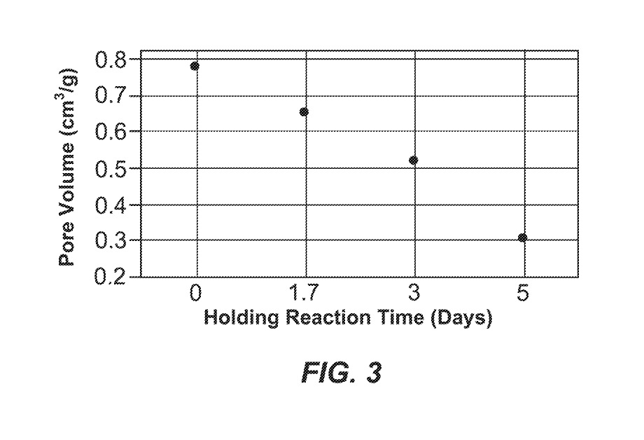

Pyrolysis of the samples was carried out under nitrogen flow starting at 20° C. and ramping to 900° C. over 45 minutes and holding at 900° C. for an additional 60 minutes. During pyrolysis, the cured polymer composition was dried and pyrolyzed thereby removing moisture, oxygen, and hydrogen to afford the pure carbon material. The resulting mesopore volume for each sample was tested by gas sorption. The results are shown in Table 9, below as well as FIG. 3:

TABLE 9
Mesopore volume for samples subjected to different hold times

| | | Mesopore Volume of |
|---|---|---|
| | Holding Time | Final Carbon Material |
| Sample | (days) | (cm³/g) |
| 5 | 0 | 0.78 |
| 6 | 1.7 | 0.653 |
| 7 | 3 | 0.52 |
| 8 | 5 | 0.305 |

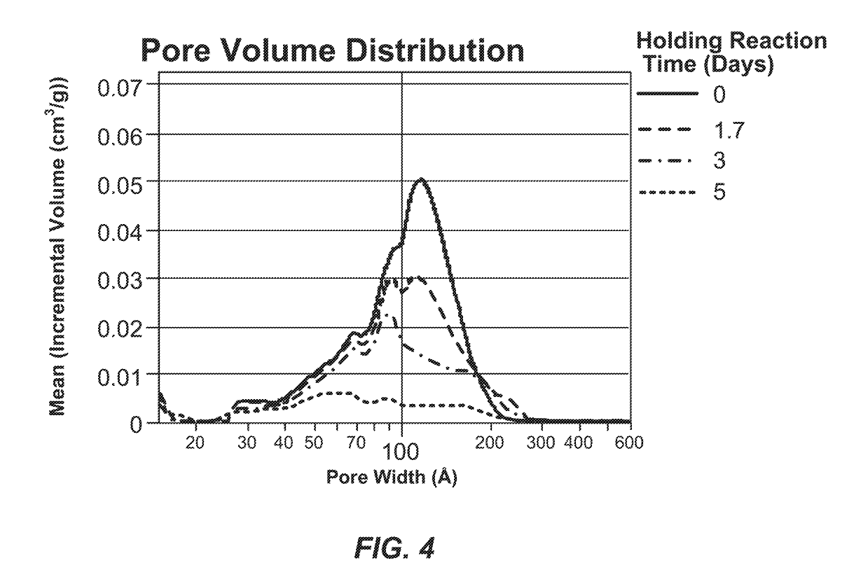

As shown by the results above, samples with longer hold times had a lower mesopore volume with the Sample 5 and 6 (0 and 1.7 day hold time, respectively) having relatively high mesopore volumes of 0.78 cm³/g and 0.653 cm³/g, respectively. The pore volume distribution for each exemplary carbon material is shown in FIG. 4.

### Example 4

### Carbon Materials Prepared with Variable Cure Temperature Ramp Rate

Four sample preparations of exemplary carbon materials were synthesized according to the procedure described in Examples 1-3 and the following parameters. The reagents were added in the amounts indicated in Table 10, below.

TABLE 10
Reagents used to prepare exemplary carbon material samples

| Reagent | Amount (wt. %) |
|---|---|
| water | 24.0% |
| resorcinol | 30.2% |
| ammonium acetate | 0.26% |
| acetic acid | 5.5% |
| formaldehyde | 40.0% |
| (37 wt. % in water, 15% methanol) | |

All reagents except formaldehyde were combined and heated to 50° C. The formaldehyde solution was pumped into the reactor over 145 minutes while maintaining a temperature between 49-50° C. The resulting mixture remained in the reactor for an additional 95 minutes after the completion of the formaldehyde addition. The resultant reaction mixtures were cooled to 25° C. before decanting and holding samples and maintaining a temperature between 20° C. and 25° C. for 1 day.

Following the holding step, samples were placed in an oven to cure. The oven was set at an initial temperature of 25° C. and ramped to 95° C. at ramp rates of 1, 3, 10 and 110° C./hour. Upon reaching 95° C., each sample was held at 95° C. for an additional 24 hours. The samples were then cooled, fractured and placed in a tube furnace to dry and pyrolyze under nitrogen atmosphere.

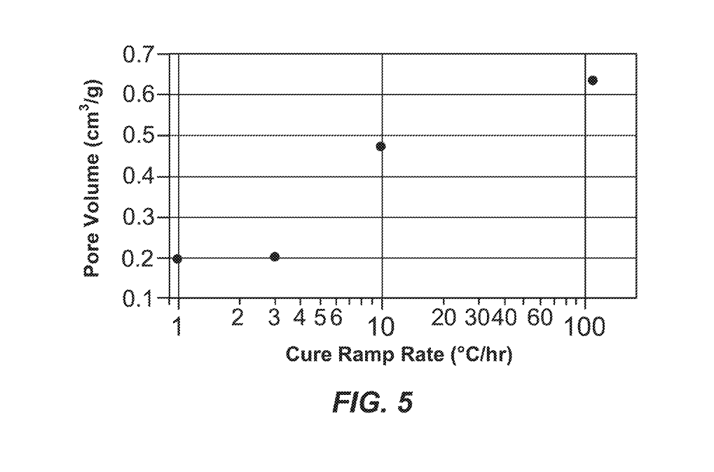

Pyrolysis of the samples was carried out under nitrogen flow starting at 20° C. and ramping to 900° C. over 45 minutes and holding at 900° C. for an additional 60 minutes. During pyrolysis, the cured polymer composition was dried and pyrolyzed thereby removing moisture, oxygen, and hydrogen to afford the pure carbon material. The resulting mesopore volume for each sample was tested by gas sorption. The results are shown in Table 11, below as well as FIG. 5:

TABLE 11
Mesopore volume for samples subjected to different hold times

| | | Mesopore Volume of |
|---|---|---|
| | Ramp Rate | Final Carbon Material |
| Sample | (° C./hour) | (cm³/g) |
| 9 | 1 | 0.1951 |
| 10 | 3 | 0.2002 |
| 11 | 10 | 0.4682 |
| 12 | 110 | 0.6318 |

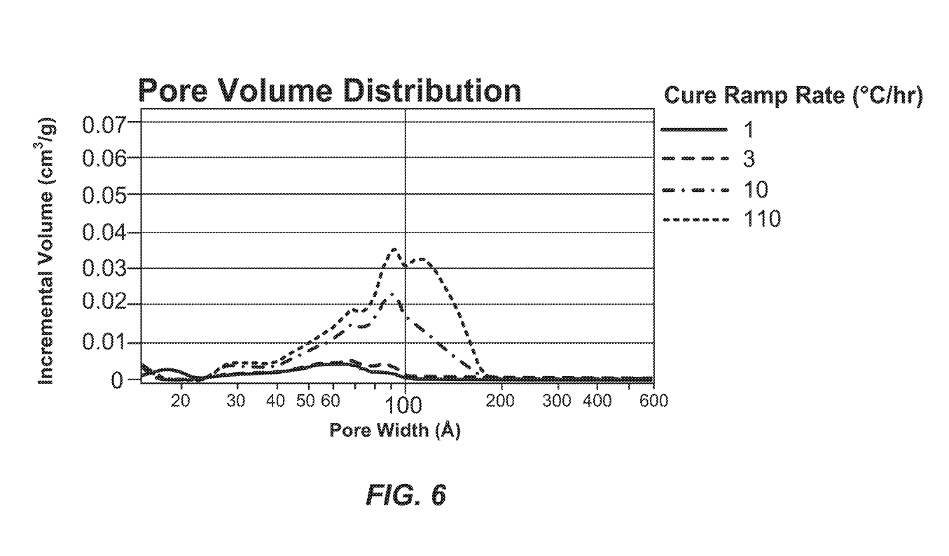

As shown by the results above, samples with slower ramp rates had a lower mesopore volume with Sample 11 (110° C./hour ramp rate) having a relatively high mesopore volume of 0.6318 cm³/g. At and below a ramp rate of 3° C./hour (i.e., Samples 9 and 10), very little porosity was left in the 20Å-200Å range. The pore volume distributions for each exemplary carbon material are shown in FIG. 6.

### Example 5

### Relative Pore Integrity Comparison

Samples were prepared according to Example 3 above, with modifications described below. Samples 5 and 8 were collected following the holding step and pyrolysis. Sample 5 preparations were divided into two samples, Samples 5A and 5B, respectively; Sample 8 was divided in the same manner to yield Samples 8A and 8B.

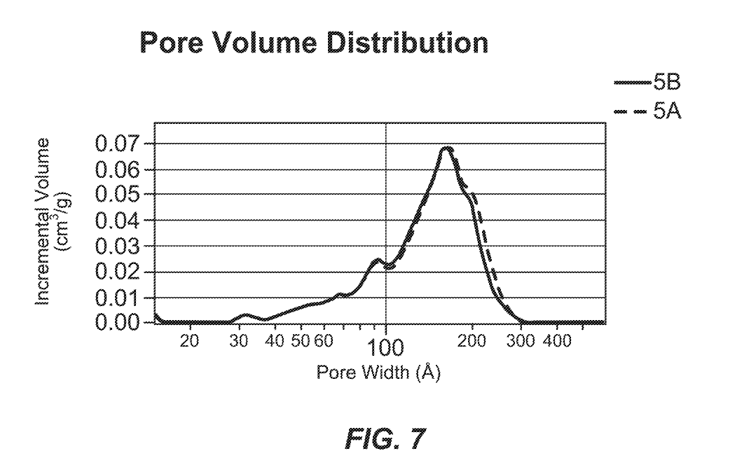

Before pyrolysis of the samples, Sample 5A was freeze dried to remove solvent from the cured polymer composition and Sample 5B was not. Both samples were then pyrolyzed as described above. The carbon material resulting from Sample 5A had a total pore volume of 0.81 cm³/g while the carbon material resulting from Sample 5B had a total pore volume of 0.78 cm³/g. That is, Sample 5B had a relative pore integrity of 0.96. In addition, the pore volume distribution of Sample 5B does not show any significant difference in pore volume distribution compared to Sample 5A (i.e., obtained freeze drying). The sample parameters and mesopore volume results are shown in Table 12 below, and the pore volume distributions are shown in FIG. 7:

TABLE 12
Sample parameters for polymer compositions
and relative pore integrity

| | Solvent Content | | |
|---|---|---|---|
| | Into Pyrolysis | Total Pore | |
| | (wt. % of cured polymer | Volume | Relative Pore |
| Sample | composition) | (cm³/g) | Integrity |
| 5A | 0 | 0.81 | — |
| 5B | 59 | 0.78 | 0.96 |

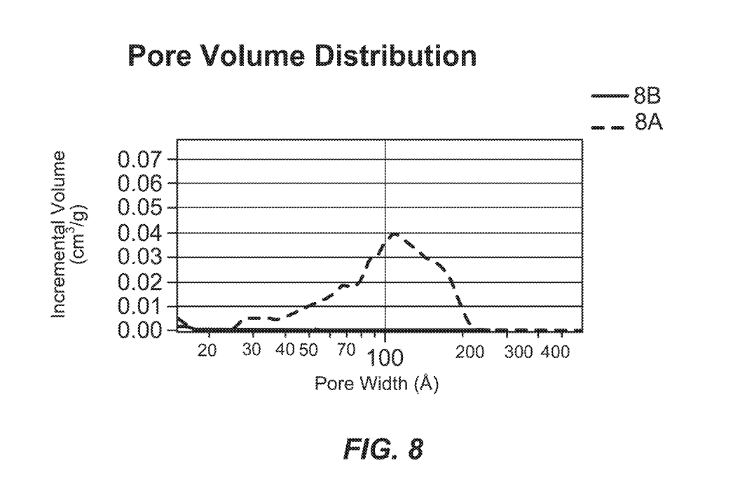

Sample 8A was freeze dried to remove solvent from the cured polymer composition and Sample 8B was not dried. Both samples were then pyrolyzed as described above. The carbon material resulting from Sample 8A had a total pore volume of 0.56 cm³/g while the carbon material resulting from Sample 5B had a total pore volume of 0.022 cm³/g. That is, Sample 8A showed a relative pore integrity of 0.04. The sample parameters and mesopore volume results are shown in Table 13 below, and the pore volume distributions in FIG. 8:

TABLE 13
Sample parameters for polymer compositions
and relative pore integrity

| | Solvent Content | | |
|---|---|---|---|
| | Into Pyrolysis | Total Pore | |
| | (wt. % of cured polymer | Volume | Relative Pore |
| Sample | composition) | (cm³/g) | Integrity |
| 8A | 0 | 0.56 | — |
| 8B | 51 | 0.022 | 0.04 |

### Example 6

### Production of Activated Carbon

Pyrolyzed carbon material prepared according to Examples 1-4 is activated a batch rotary kiln at 900° C. under a CO₂ for 660 minutes. The surface area of the activated carbon is examined by nitrogen surface analysis using a surface area and porosity analyzer. The specific surface area is measured using the BET approach and is typically reported as m²/g, the total pore volume is reported as cc/g or cm³/g and the tap density is reported as g/cc.

Pore size distribution for activated carbon materials are measured on a micromeritics ASAP2020, a micropore-capable analyzer with a higher resolution (lower pore size volume detection) than the Tristar 3020 that is used to measure the pore size distribution for the pyrolyzed carbon materials.

A DFT cumulative volume plot for activated carbon material can be used to determined pore volume residing in micropores and pore volume resides in mesopores. Carbon materials comprising different properties (e.g., surface area, pore structure, etc.) can be prepared by altering the activation conditions (e.g., temperature, time, etc.) described above.

### Example 7

### Micronization of Activated Carbon Via Jet Milling

Activated carbon prepared according to Example 5 is jet milled using a Jet Pulverizer Micron Master 2 inch diameter jet mill. The conditions comprise about 0.7 lbs of activated carbon per hour, nitrogen gas flow about 20 scf per min and about 100 psi pressure. The average particle size after jet milling is about 8 to 10 microns.

### Example 8

### Purity Analysis of Activated Carbon

Carbon samples prepared according to the general procedures herein are examined for their impurity content via total reflection x-ray fluorescence (TXRF). TXRF is an industry-standard, highly sensitive and accurate measurement for simultaneous elemental analysis by excitation of the atoms in a sample to produce characteristic X-rays which are detected and their intensities identified and quantified. TXRF is capable of detection of all elements with atomic numbers ranging from 11 to 92 (i.e., from sodium to uranium).

### Example 9

### Electrochemical Properties of Carbon Materials

Carbon samples are analyzed for their electrochemical performance, specifically as an electrode material in EDLC coin cell devices. Specific details regarding fabrication of electrodes, EDLCs and their testing are described below.

Capacitor electrodes comprise 99 parts by weight carbon material particles (average particle size 5-15 microns) and 1 part by weight Teflon. The carbon and Teflon are masticated in a mortar and pestle until the Teflon is well distributed and the composite has some physical integrity. After mixing, the composite is rolled out into a flat sheet, approximately 50 microns thick. Electrode disks, approximately 1.59 cm in diameter, are punched out of the sheet. The electrodes are placed in a vacuum oven attached to a dry box and heated for 12 hours at 195° C. This removes water adsorbed from the atmosphere during electrode preparation. After drying, the electrodes are allowed to cool to room temperature, the atmosphere in the oven is filled with argon and the electrodes are moved into the dry box where the capacitors are made.

A carbon electrode is placed into a cavity formed by a 1 inch (2.54 cm) diameter carbon-coated aluminum foil disk and a 50 micron thick polyethylene gasket ring which has been heat sealed to the aluminum. A second electrode is then prepared in the same way. Two drops of electrolyte comprising 1.8 M tetraethylene ammonium tetrafluoroborate in acetonitrile are added to each electrode. Each electrode is covered with a 0.825 inch diameter porous polypropylene separator. The two electrode halves are sandwiched together with the separators facing each other and the entire structure is hot pressed together.

When complete, the capacitor is ready for electrical testing with a potentiostat/function generator/frequency response analyzer. Capacitance is measured by a constant current discharge method, comprising applying a current pulse for a known duration and measuring the resulting voltage profile. By choosing a given time and ending voltage, the capacitance is calculated from the following C=It/ΔV, where C=capacitance, I=current, t=time to reached the desired voltage and ΔV=the voltage difference between the initial and final voltages. The specific capacitance based on the weight and volume of the two carbon electrodes is obtained by dividing the capacitance by the weight and volume respectively.

### Example 10

### Properties and Performance of Capacitor Electrodes Comprising the Carbon Materials

Carbon material prepared according to the general procedures described above is evaluated for its properties and performance as an electrode in a symmetric electrochemical capacitor with a carbonate-based organic electrolyte. A comprehensive set of property and performance measurements is performed on test capacitors fabricated with this material.

The sample is very granular and includes relatively large particles. As a result, the capacitor's electrodes formed for the evaluation are porous and have very low density (0.29 g/cm³). The disclosed carbon materials prepared according to embodiments of the methods disclosed herein may compare very favorably to the commercial devices on a weight basis, primarily because of the relatively high “turn-on” frequency. It is anticipated that the volumetric performance of the carbon materials can be improved by reducing the particle size by grinding or other processing.

The sample preparation includes drying at 60° C. and mixing the carbon material with a Teflon binder at about 3.0% by weight. This mixture is thoroughly blended and formed into 0.003″-thick-electrodes. The sample may appear to have a significant fraction of larger particles which led to a porous and low density electrode. In some instances, 0.002″ thick electrodes are used for evaluation but sometimes the sample cannot be formed into this thin a sheet with the integrity required for subsequent handling, and thus, the thicker electrodes are prepared. The sheet material is punched using a steel die to make discs 0.625″ in diameter. Four electrode discs of each material are weighed to an accuracy of 0.1 mg. The electrodes are dried under vacuum conditions (mechanical roughing pump) at 195° C. for 14 hours as the last preparation step.

After cooling, the vacuum container containing the electrodes (still under vacuum) is transferred into the drybox. All subsequent assembly work is performed in the drybox. The electrode discs are soaked in the organic electrolyte for 10 minutes then assembled into cells. The electrolyte is an equal volume mixture of propylene carbonate (PC) and dimethylcarbonate (DMC) that contained 1.0 M of tetraethylammoniumtetrafluoroborate (TEATFB) salt.

Two layers of an open cell foam type separator material are used to prepare the test cells. The double separator is 0.004″ thick before it is compressed in the test cell. Initially test cells are fabricated using the normal single layer of separator but these cells had high leakage currents, presumably because of particulates in the electrodes piercing the thin separator. The conductive faceplates of the test cell are aluminum metal with a special surface treatment to prevent oxidation (as used in the lithium-ion battery industry). The thermoplastic edge seal material is selected for electrolyte compatibility and low moisture permeability and applied using an impulse heat sealer located directly within the drybox.

Two substantially identical test cells are fabricated. The assembled cells are removed from the drybox for testing. Metal plates are clamped against each conductive face-plate and used as current collectors. The electrodes are each about 0.003″ thick, and the separator about 0.004″ thick (a double layer of about 0.002″ thick material). Electrodes had a diameter of about 0.625″. Capacitor cells are conditioned at 1.0 V for ten minutes, measured for properties, then conditioned at 2.0 V for 10 minutes and measured for properties.

The following test equipment is used for testing the capacitor cells:
1. Frequency Response Analyzer (FRA), Solartron model 1250 Potentiostat/Galvanostat, PAR 273
2. Digital Multimeter, Keithley Model 197
3. Capacitance test box S/N 005, 500 ohm setting
4. RCL Meter, Philips PM6303
5. Power Supply, Hewlett-Packard Model E3610A
6. Balance, Mettler H10
7. Micrometer, Brown/Sharp
8. Leakage current apparatus
9. Battery/capacitor tester, Arbin Model EVTS

All measurements are performed at room temperature. The test capacitors are conditioned at 1.0 V then shorted and the following measurements are made: 1 kHz equivalent series resistance (ESR) using the RCL meter, charging capacitance at 1.0 V with a 500 ohm series resistance using the capacitance test box, leakage current at 0.5 and 1.0 V after 30 minutes using the leakage current apparatus, and electrochemical impedance spectroscopy (EIS) measurements using the electrochemical interface and FRA at 1.0 V bias voltage. Then the test capacitors are conditioned at 2.0 V then shorted and the following measurements are made: 1 kHz equivalent series resistance (ESR) using the RCL meter, charging capacitance at 2.0 V with a 500 ohm series resistance, leakage current at 1.5 and 2.0 V after 30 minutes using the leakage current apparatus, and EIS measurements at 2.0 V bias voltage. Finally charge/discharge measurements are made using the Arbin. These measurements include constant current charge/discharge cycles between 0.1 and 2.0 V at currents of 1, 5, and 15 mA and constant current charge/constant power discharges between 2.0 V and 0.5 V at power levels from 0.01 W to 0.2 W.

### Example 11

### Phenol-Resorcinol-Formaldehyde Mesoporous Carbon Material

A 5 g batch of polymer composition was prepared by charging all components as set forth in Table 14 below except for the formaldehyde solution into a 20 cm³ test tube and heating the mixture to 37° C. and stirring to prepare a pre-polymer solution. The formaldehyde solution was then added to the test tube in one dose after the pre-polymer solution components were all dissolved. The solution was held at 37° C. for 3 hours, cooled to 20° C. over 30 minutes, held at 20° C. for 20 minutes, ramped to 95° C. over 6 hours, and held at 95° C. for 12 hours. The cured polymer composition was then removed from the test tube and pyrolyzed in a tube furnace.

TABLE 14
Reagents used to prepare phenol-resorcinol-
formaldehyde mesoporous carbon material

| Reagent | Amount (wt. %) |
|---|---|
| DI Water | 11.6% |
| Resorcinol | 22.1% |
| Phenol | 14.0% |
| Ammonium Acetate | 0.114% |
| Glacial Acetic Acid | 1.13% |
| Formaldehyde | 51.1% |
| (37 wt % in DI H₂O, 0.16% | |
| methanol) | |

Nitrogen was set to flow through the tube furnace and the furnace was set to heat from 20° C. to 900° C. over 45 minutes, and then to hold at 900° C. for 60 minutes. During this step the cured polymer composition is dried and then pyrolyzed, removing moisture, oxygen, and hydrogen from the cured polymer composition and leaving only carbon.

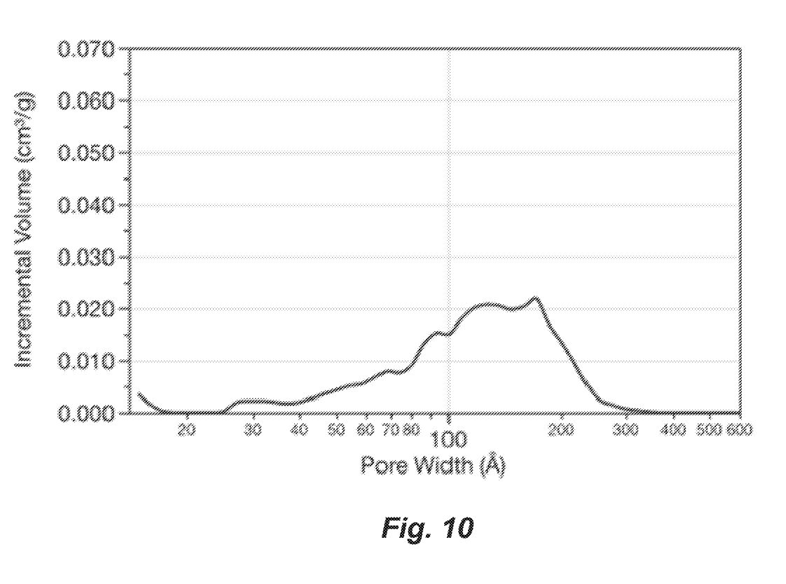

The specific pore volume was determined to be 0.552 cm³/g and the surface area was 638 m²/g. The result for the pore size distribution was determined by nitrogen sorption and is shown in FIG. 10.

### Example 12

### Activated Mesoporous Carbon Material

A 7200 kg batch of polymer composition was prepared by charging all components except for the formaldehyde solution into a 10 m³ kettle and heating to 37° C. while stirring. The formaldehyde solution was pumped into the reactor over 120 minutes while the temperature of the reactor was maintained at a temperature between 36° C.-38° C. by running chilled water through cooling coils on the kettle. The resultant solution was held in the kettle for an additional 5 hours after completion of the formaldehyde addition and before cooling.

The solution was cooled to 20° C. before decanting into 200 L drums. The drums were held at room temperature for 2.5 days before entering the cure oven and self-heated (i.e., via an exothermic reaction) to 75° C. to 80° C.

The drums were moved into a cure oven set to 95° C. for 48 hours. After curing the cured polymer composition was fractured, removed from the drums, and fed through a rotary tube furnace to pyrolyze under nitrogen.

TABLE 15
Reagents used to form activated mesoporous carbon material

| Reagent | Amount (wt. %) |
|---|---|
| DI Water | 23.8% |
| Resorcinol | 30.3% |
| Ammonium Acetate | 0.42% |
| Glacial Acetic Acid | 5.5% |
| Formaldehyde | 40.1% |
| (37 wt % in DI H₂O, 0.16% | |
| methanol) | |

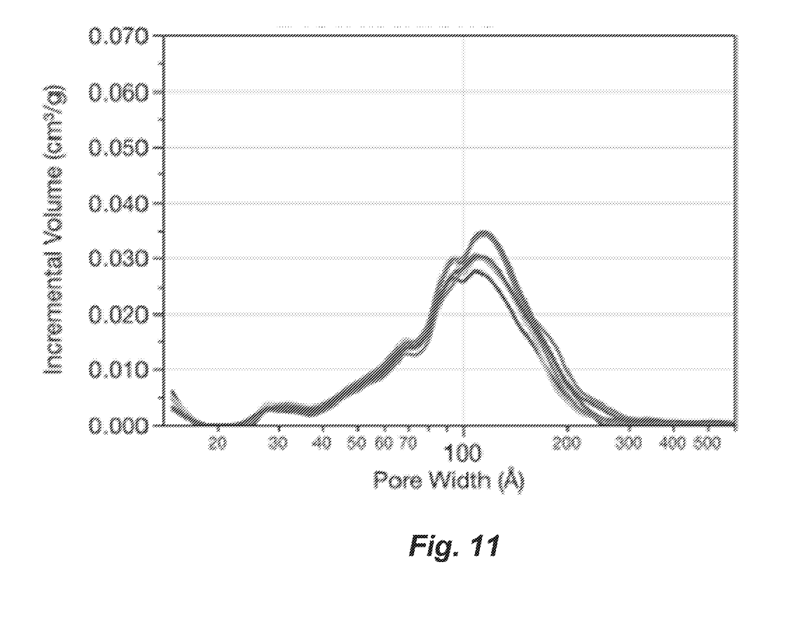

The specific pore volume was determined to be 0.632 cm³/g (σ=0.17; 6 measurements) with a surface area of 665 m²/g (σ=21; 6 measurements). A pore size distribution of the carbon material was determined by nitrogen sorption, the results of which are displayed in FIG. 11.

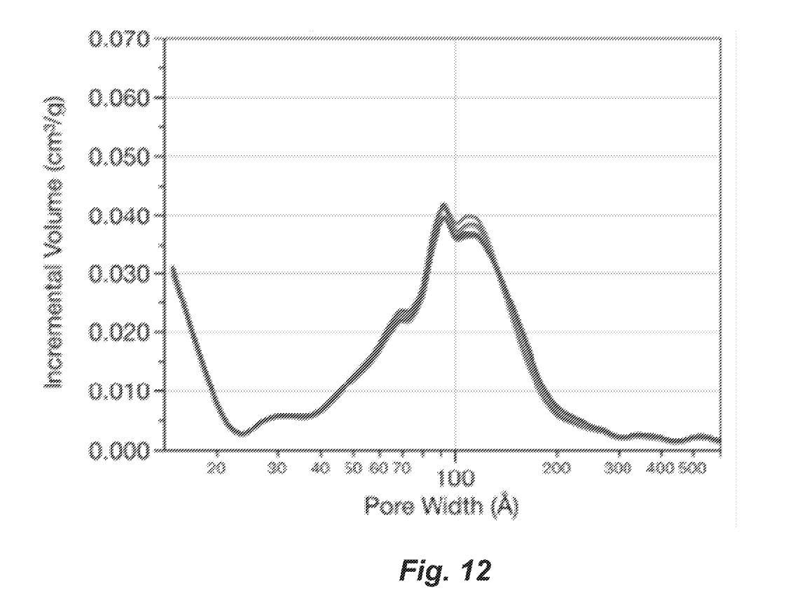

The carbon material was then activated in a CO₂ fluidized bed at 890° C. for 30 hours. The specific pore volume of the activated carbon material was determined to be 1.17 cm³/g (σ=0.10; 6 measurements) with a surface area of 1644 m²/g (σ=11; 6 measurements). A pore size distribution of the carbon material was determined by nitrogen sorption, the results of which are displayed in FIG. 12.

### Example 13

### Activated Mesoporous Carbon Material

All components (shown in Table 16, below) were mixed in a kettle and heated to 35° C.; the temperature was held at 35° C. for 155 minutes.

TABLE 16
Reagents used to prepare phenol-resorcinol-
formaldehyde mesoporous carbon material

| Reagent | Amount (wt. %) |
|---|---|
| DI Water | 23.8% |
| Resorcinol | 30.3% |
| Ammonium Acetate | 0.42% |
| Glacial Acetic Acid | 5.5% |
| Formaldehyde | 40.1% |
| (37 wt % in DI H₂O, 0% | |
| methanol) | |

The reaction mixture was decanted at 35° C. into a 250 mL polypropylene bottle for the holding. The refractive index (RI) of the reaction mixture at decant was 1.42718. The polypropylene bottle with reaction mixture was put into an insulated box and the temperature of the reaction mixture was monitored with a thermocouple sandwiched between the insulation and the bottle. The temperature of the reaction mixture increased over the course of 3 hours to 115° C. in the insulated box during the conversion of the reaction mixture to the polymer composition.

After approximately 24 hours in the insulated box, the sample was fractured, removed from the polypropylene bottle, and separated into two samples, 13a and 13b. Sample 13a was put in a tube furnace to pyrolyze under nitrogen while Sample 14b was put into a freeze dryer and dried before putting it into a tube furnace.

The specific pore volume, pore size distribution, and surface area of these carbons were tested by gas sorption. The carbon material from Sample 13b had a pore volume of 1.11cm³/g. Carbon material from Sample 13a, which was derived from a cured polymer composition having a solvent content of 59 wt % based on the total weight of the cured polymer composition, had a pore volume of 1.07cm³/g (i.e., a 96% retention of pore volume).

TABLE 17
Sample parameters for Sample 13a and 13b

| | Solvent Content | Pore Volume | % Pore | BET SSA |
|---|---|---|---|---|
| Sample | into Kiln | (cm³/g) | Retention | (m²/g) |
| 13a | 59% | 1.07 | 96% | 723 |
| 13b | 0% | 1.11 | — | 740 |

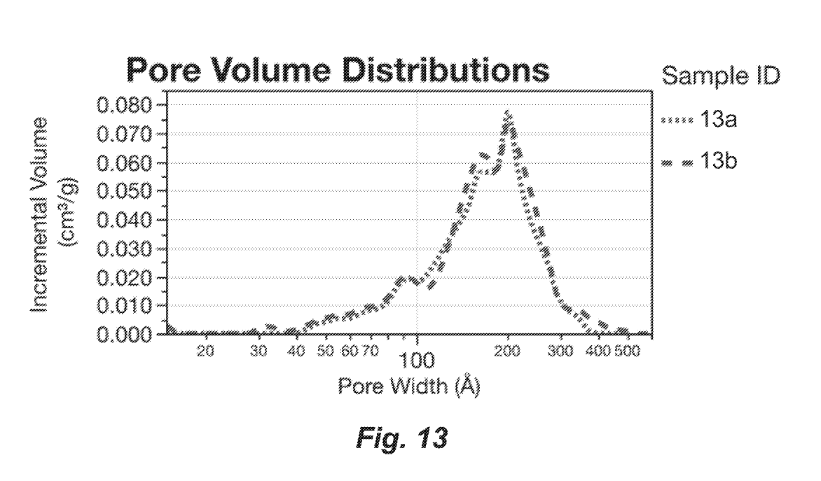

FIG. 13 illustrates that there are no significant shifts in pore size distribution when comparing samples that have been freeze dried with samples that have not been freeze dried.

### Example 14

### High and Low Pore Volume Polymers without Freeze Drying

De-ionized water, resorcinol, ammonium acetate, glacial acetic acid and formaldehyde (37 wt % in DI water, 0% methanol) were mixed in the amounts listed in Table 18, below:

TABLE 18
Components and amounts used to prepare Sample 14a and 14b

| Reagent | Amount (wt. %) |
|---|---|
| DI Water | 23.8% |
| Resorcinol | 30.3% |
| Ammonium Acetate | 0.42% |
| Glacial Acetic Acid | 5.5% |
| Formaldehyde | 40.1% |
| (37 wt % in DI H₂O, 0% | |
| methanol) | |

Sample 14a was held at 40° C. for 4 hours and then ramped to 95° C. at a 45° C./hour rate. The sample was then held for 4 hours at 95° C.

Sample 14b was held at 40° C. 4 hours and then ramped to 20° C. over 30 minutes. It was held at 20° C. for 63 hours. The samples were then heated to 95° C. at a 3° C./hour ramp rate.

After completion, the samples were removed from the test tube and fractured. The specific pore volume, pore size distribution, and surface area of these cured polymer compositions were then measured by gas sorption. Sample 14a had a pore volume of 1.18cm³/g. Sample 14b had a pore volume of 0.27cm³/g.

TABLE 19
Physical characteristics of Sample 14a and 14b

| | Ramp Rate | Solvent Content prior | Pore Volume | BET SSA |
|---|---|---|---|---|
| Sample | (° C./hour) | to Analysis | (cm³/g) | (m²/g) |
| 14a | 45 | 59% | 1.18 | 443 |
| 14b | 3 | 59% | 0.27 | 281 |

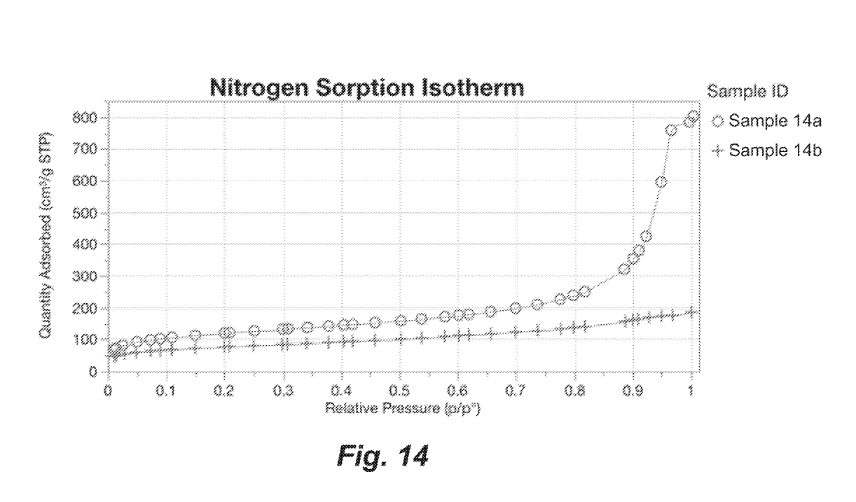

FIG. 14 shows difference in nitrogen sorption between Samples 14a and 14b.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
a) combining a solvent, a catalyst, a first monomer and a second monomer to yield a reaction mixture;
b) increasing the temperature of the reaction mixture at a holding ramp rate and holding the reaction mixture at a holding temperature sufficient to co-polymerize the first and second monomer to yield a polymer composition; and
c) optionally heating the polymer composition at a curing temperature, thereby forming a cured polymer composition comprising the solvent and a polymer formed from co-polymerizing the first and second monomer, wherein the solvent concentration in the cured polymer composition is at least 5 wt %, based on total weight of the cured polymer composition.

2. The method of claim 1, wherein the method further comprises pyrolyzing the cured polymer composition at a pyrolysis temperature thereby substantially removing the solvent and pyrolyzing the polymer to yield a carbon material.

3-10. (canceled)

11. A method comprising:
a) combining a solvent, a catalyst, a first monomer and a second monomer to yield a reaction mixture, and maintaining the reaction mixture at a reaction temperature for a reaction time;
b) increasing the temperature of the reaction mixture at a holding ramp rate and holding the reaction mixture at a holding temperature sufficient to co-polymerize the first and second monomer to yield a polymer composition; and
c) optionally heating the polymer composition up to a curing temperature, thereby forming a cured polymer composition comprising the solvent and a polymer formed from co-polymerizing the first and second monomer.

12-18. (canceled)

19. A method comprising:
a) combining a solvent, a catalyst, a first monomer and a second monomer to yield a reaction mixture;
b) increasing the temperature of the reaction mixture at a holding ramp rate and holding the reaction mixture for a holding time at a holding temperature sufficient to co-polymerize the first and second monomer to yield a polymer composition;
c) optionally heating the polymer composition at a curing temperature, thereby forming a cured polymer composition comprising the solvent and a polymer formed from co-polymerizing the first and second monomer.

20-27. (canceled)

28. A method comprising:
a) combining a solvent, a catalyst, a first monomer and a second monomer to yield a reaction mixture;
b) optionally holding the reaction mixture at a holding temperature sufficient to co-polymerize the first and second monomer to yield a polymer composition; and
c) heating the polymer composition by increasing an initial temperature at a curing ramp rate of at least 0.5° C./hour up to a curing temperature, thereby forming a cured polymer composition comprising the solvent and a polymer formed from co-polymerizing the first and second monomer.

29-30. (canceled)

31. A method comprising:
a) combining a solvent, a catalyst, a first monomer and a second monomer to yield a reaction mixture;
b) transferring the reaction mixture to a reaction vessel having a volume greater than 10 L and a surface area to volume aspect ratio greater than about 3 m²/m³;
c) increasing the temperature of the reaction mixture at a holding ramp rate and holding the reaction mixture for a holding time at a holding temperature sufficient to co-polymerize the first and second monomer to yield a polymer composition; and
d) optionally heating the polymer composition at a curing temperature, thereby forming a cured polymer composition comprising the solvent and a polymer formed from co-polymerizing the first and second monomer.

32-50. (canceled)

51. The method of claim 1, wherein the first monomer is a phenolic compound.

52-56. (canceled)

57. The method of claim 1, wherein the second monomer is formaldehyde.

58-59. (canceled)

60. The method of claim 1, wherein the solvent comprises water and a miscible acid.

61. (canceled)

62. The method of claim 1, wherein the curing temperature ranges from about 70° C. to about 200° C.

63-83. (canceled)

84. The method of claim 2, wherein the carbon material comprises a total pore volume of at least 0.01 cc/g.

85-88. (canceled)

89. The method of claim 2, wherein the carbon material comprises a BET specific surface area of at least 5 m²/g.

90-93. (canceled)

94. The method of claim 2, wherein the carbon material comprises a BET specific surface area of at least 1500 m²/g.

95. The method of claim 2, wherein the carbon materials have a pore structure comprising micropores, mesopores and a total pore volume, and wherein from 40% to 90% of the total pore volume resides in micropores, from 10% to 60% of the total pore volume resides in mesopores and less than 10% of the total pore volume resides in pores greater than 20 nm.

96. The method of claim 2, wherein the carbon materials comprise a total impurity content of less than 500 ppm of elements having atomic numbers ranging from 11 to 92 as measured by total reflection x-ray fluorescence.

97-99. (canceled)

100. The method of claim 1, wherein the polymer comprises a total pore volume of at least 0.01 cc/g.

101-104. (canceled)

105. The method of claim 1, wherein the polymer comprises a BET specific surface area of at least 5 m²/g.

106-112. (canceled)

113. The method of claim 1, wherein the polymer has a pore structure comprising micropores, mesopores and a total pore volume, and wherein from 40% to 90% of the total pore volume resides in micropores, from 10% to 60% of the total pore volume resides in mesopores and less than 10% of the total pore volume resides in pores greater than 20 nm.

114. The method of claim 1, wherein the polymer comprises a total impurity content of less than 500 ppm of elements having atomic numbers ranging from 11 to 92 as measured by total reflection x-ray fluorescence.

115. (canceled)

116. The method of claim 1, wherein the polymer comprises a total pore volume of at least 0.30 cc/g.

117-118. (canceled)

119. The method of claim 2, wherein the pyrolysis temperature is greater than about 250° C.

120-122. (canceled)

123. A cured polymer composition, wherein the polymer is prepared according to claim 1.

124. A polymer composition comprising:
a solvent concentration greater than about 10 wt. % of the polymer composition; and
a polymer having a relative pore integrity greater than 0.4.

125-158. (canceled)
